(19) United States
(12) Patent Application Publication
(10) Pub. No.: US 2003/0110132 A1
(43) Pub. Date: Jun. 12, 2003

(54) Content data, and its recording medium, recording method, recording apparatus, copying method, reproducing method, reproducing apparatus and output method

(76) Inventor: Yoichiro Sako, Tokyo (JP)

Correspondence Address: Jay H Maioli, Cooper & Dunham, 1185 Avenue of the Americas, New York, NY, 10036, US

(21) Appl. No.: 10/169,233

(22) PCT Filed: Oct. 30, 2001
(86) PCT No.: PCT/JP01/09524

(51) Int. Cl. G06F 17/60

(52) U.S. Cl. 705/51

(57) ABSTRACT

A content data, and a recording medium, recording method, recorder, copying method, playing method, player and outputting method, for the content data, are provided. To a supplied content data, there is added an additional data including data as to limitation of content data copying or playing and data as to a period for which conditions of copying or playing the content data are set. The content data having the additional data added thereto is recorded. When copying or playing the content data, the additional data including the data at to the limitation of content data copying or playing and data as to the period is extracted, and the copying or playing is controlled based on the additional data.

### TECHNICAL FIELD

The present invention generally relates to the content data technology, and more particularly to a method of transmitting various content data such as audio, video and text, method of recording or playing content data, and an apparatus for recording or playing content data.

### BACKGROUND ART

To distribute various content data such as audio, video, text, etc., various measured have been proposed to prevent the content data from illegally being copied and protect a provider or distributor of the content data from illegitimately being caused by such an illegal copying to lose profits which the provider or distributor would otherwise make.

For example, a so-called CD (compact disc) having audio data such as a musical piece recorded therein is put on the market by the manufacturer of the CD under the conditions that any CD renter shall never rent the CD for a rental-inhibited period determined under an agreement made between the CD manufacturer and renter.

For content distribution via a communication network such as EMD (electronic music distribution) network or the like, it has been proposed to set a period for which use of the content data is allowed, and change or extend the allowed usage period for the content data by communicating with a billing center and paying an imposed charge.

The above extension of the allowed usage period for a content data by paying an appropriate charge will be convenient to the users since only a user wanting to use the content data for a longer period should pay an appropriate charge, and also to the content data provider since the latter can positively collect a charge per use of the content data by the user.

The rental-inhibited period is set based simply on the agreement made between the CD manufacturer and renter, namely, on the mutual trusting between the two parties. That is to say, setting of any rental-inhibited period for a CD will not apply to a player used for playing back the CD. Therefore, if the CD is rented to a user during the rental-inhibited period, the user cannot be restricted in any way from playing the rented CD but he or she can freely play the CD in the period.

Also, the aforementioned changing or extension, corresponding to the payment of an appropriate charge via the EMD network, of a period for which use of a content data is allowed, is not possible unless communications can be done between the billing center and user (playing terminal). Further, the changing of the period for which use of a content data is allowed will be a burden to the user's apparatus, or a terminal.

Content data include some ones for which an audition period is set and which can be used free of charge of without payment of an appropriate charge for the audition period. In this case, however, communications between the billing center and playing terminal are required for the billing and changing or extending the period for which the content data can be used.

### DISCLOSURE OF THE INVENTION

Accordingly, the present invention has an object to overcome the above-mentioned drawbacks of the prior art by providing a data transmitting method by which it is possible to prevent any illegal use of a content data and bill the user for use of the content data, more positively and simply, at an apparatus of a user of the content data as intended by a provider of the content data; a method of limiting recording or playing of a content data; a content data recording or playing apparatus; a recording medium having recorded therein a content data to be transmitted and data including requirements for recording or playing the content data; and a content data.

The above object can be attained by providing a recording medium having recorded therein, according to the present invention, a content data and additional data added to the content data and including data about conditions of copying or playing the content data. The additional data include data which limits copying of the content data.

Further, the additional data includes data which limits playing of the content data. The play limiting data includes at least data indicating a period for which copying of the content data is inhibited.

Also the above object can be attained by providing a recording method including, according to the present invention, steps of adding, to a supplied content data, an additional data including data as to limited recording of the content data and data as to a period for which conditions of recording the content data are set, coding the content data having the additional data added thereto, and recording the coded data to a recording medium.

Also the above object can be attained by providing a recorder including according to the present invention means for adding, to a supplied content data, an additional data including data as to limited recording of the content data and data as to a period for which conditions of recording the content data are set, means for coding an output data from the adding means, and means for recording an output data from the encoding means to a recording medium.

Also the above object can be attained by providing a content data copying or playing method including, according to the present invention, steps of extracting, from a supplied content data, an additional data added to the content data and including data as to limited copying or playing of the content data and data as to a period for which conditions of copying or playing the content data are set, comparing a period set based on the period data in the extracted additional data with a date at which the content data is going to be copied or played, and controlling, when the result of comparison shows that the date at which the content data is going to be copied or played is within a period set based on the period data in the extracted additional data, the content data copying or playing based on the copy- or play-limiting data in the additional data.

Also the above object can be attained by providing a content data copying or playing method including, according to the present invention, steps of extracting, from a supplied content data, an additional data added to the content data and including data as to limited copying or playing of the content data, data as to a first period during which the content data can be copied or played free of charge and data as to a second period during which the content data can be copied or played on a chargeable basis, comparing a date at which the content data is going to be copied or played with data as to the first and second periods, respectively, and inhibiting the content data copying or playing when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

Also the above object can be attained by providing a content data copying or playing method including, according to the present invention, steps of extracting, from a supplied content data, an additional data added to the content data and including data as to limited copying or playing of the content data, data as to a first period during which the content data copying or playing is inhibited and data as to a second period during which the content data can be copied or played on a chargeable basis, comparing a date at which the content data is going to be copied or played with data as to the first and second periods, respectively, and inhibiting the content data copying or playing when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

Also the above object can be attained by providing a content data copying or playing method including, according to the present invention, steps of extracting, from a supplied content data, an additional data added to the content data and including data as to limited copying or playing of the content data, data as to a first period during which copying or playing of the content data is inhibited and data as to a second period during which the content data can be copied or played on a chargeable basis and which partially overlaps the period set based on the data as to the first period, comparing a date at which the content data is going to be copied or played with data as to the first and second periods, respectively, and inhibiting the content data copying or playing when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

Also the above object can be attained by providing a content data copying or playing method including, according to the present invention, steps of extracting, from a supplied content data, an additional data added to the content data and including data as to limited copying or playing of the content data, data as to a first period during which the content data can be copied or played free of charge, data as to a second period during which the content data can be copied or played on a chargeable basis and data as to a third period during which the content data can be copied or played on a chargeable basis, comparing a date at which the content data is going to be copied or played with data as to the first, second and third periods, respectively, and copying or playing the content data when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second or third period, whether billing can be made for the content data copying or playing.

Also the above object can be attained by providing a content data copying method including, according to the present invention, steps of extracting, from a supplied content data, an additional data added to the content data and including data as to limited copying of the content data and data as to a period for which conditions of copying the content data are set, comparing a date at which the content data is going to be copied with a period set based on the period data in the extracted additional data, and inhibiting the content data copying when the result of comparison shows that the date at which the content data is going to be copied is within a period set based on the data as to the period.

Also the above object can be attained by providing a content data recorder including, according to the present invention means for extracting, from a supplied content data, an additional data added to the content data and including data as to limited recording of the content data and data as to a period for which conditions of recording the content data are set, means for coding the supplied content data, means for recording an output from the encoding means, and means including a time-keeping circuit and destined for comparing a period set based on the period data in the additional data extracted by the extracting means with a date supplied from the timekeeping circuit and at which the content data is going to be recorded, and controlling, when the result of comparison shows that the data at which the content data is going to be recorded is within a period set based on the period data in the additional data, the content data recording based on the limited-recording data in the additional data.

Also the above object can be attained by providing a content data player including, according to the present invention means for extracting, from a supplied content data, an additional data added to the content data and including data as to limited playing of the content data and data as to a period for which conditions of playing the content data are set, means for decoding the supplied content data, means for playing an output from the decoding means, means including a time-keeping circuit and destined for comparing a period set based on the period data in the additional data extracted by the extracting means with a date supplied from the time-keeping circuit and at which the content data is going to be played, and controlling, when the result of comparison shows that the data at which the content data is going to be played is within a period set based on the period data in the additional data, the content data playing based on the play-limiting data in the additional data.

Also the above object can be attained by providing a content data including according to the present invention a content data proper, and additional data added to the content data and including data about conditions of copying or playing the content data.

Also the above object can be attained by providing a content data outputting method including, according to the present invention, steps of adding, to a supplied content data, an additional data added to the content data and including data as to limited copying or playing of the content data and data as to a period for which conditions of copying or playing the content data are set, and outputting the content data having the additional data added thereto.

These objects and other objects, features and advantages of the present invention will become more apparent from the following detailed description of the best mode for carrying out the present invention when taken in conjunction with the accompanying drawings.

### BRIEF DESCRIPTION OF THE DRAWINGS

FIG. 1 explains a data transmitting method and recording medium in a first embodiment of the present invention.

FIG. 2 is a block diagram showing how to produce the recording medium according to the present invention, by way of example.

FIG. 3 explains a concrete example of the data transmitting method according to the present invention.

FIG. 4 is a block diagram of a recorder in the first embodiment of the present invention.

FIG. 5 explains information stored in a copy count memory in the recorder according to the present invention shown in FIG. 4.

FIGS. 6 and 7 show together a flow of operations made in recording (limited recording) in the recorder shown in FIG. 4.

FIG. 8 shows a data transmitting method and recording medium included in a second embodiment of the present invention.

FIG. 9 shows a flow of operations made in recording (limited recording) in a recorder in the second embodiment of the present invention.

FIG. 10 explains the data transmitting method and recording medium, which will be when playing is limited in the first embodiment of the present invention.

FIG. 11 explains the data transmitting method and recording medium, which will be when playing is limited in the second embodiment of the present invention.

FIG. 12 is a block diagram of a player, included in the second embodiment of the present invention, to play the content data shown in FIGS. 10 and 11.

FIG. 13 explains a data playing method and recording medium included in a third embodiment of the present invention.

FIG. 14 is a block diagram explaining a variant of the recorder according to the present invention.

FIG. 15 shows a flow of operations made in recording (limited recording) in a recorder in the third embodiment of the present invention.

FIG. 16 is a block diagram of a player in the third embodiment of the present invention.

FIG. 17 explains a data transmitting method and recording medium included in a fourth embodiment of the present invention.

FIGS. 18 and 19 show together a flow of operations made in recording (limited recording) in a recorder in the fourth embodiment of the present invention.

FIG. 20 explains the data transmitting method which will be when data playing is limited in the fourth embodiment of the present invention.

FIG. 21 explains a data transmitting method and recording medium included in a fifth embodiment of the present invention.

FIGS. 22 and 23 show together a flow of operations made in recording (limited recording) in a recorder in the fifth embodiment of the present invention.

FIG. 24 explains the data transmitting method which will be when data playing is limited in the fifth embodiment of the present invention.

FIG. 25 explains a data transmitting method and recording medium included in a sixth embodiment of the present invention.

FIGS. 26 and 27 show together a flow of operations made in recording (limited recording) in a recorder in the sixth embodiment of the present invention.

FIGS. 28 and 29 show together a flow of operations made in playing (limited playing) in a content data player in the sixth embodiment of the present invention.

### BEST MODE FOR CARRYING OUT THE INVENTION

There will be described herebelow embodiments of the data transmitting method, limited-recording method or limited-copying, limited-playing method, recorder, player and recording medium according to the present invention. These embodiments will be illustrated and described concerning a distribution of a content data via a recording medium such as an optical disc or magneto-optical disc and a transmission of a content data via a network such as the Internet.

That is, the embodiments will be described concerning the limited-recording method and recorder according to the present invention being applied to a recorder which records a content data to a recording medium such as an optical disc or the like, the limited-playing method and player according to the present invention being applied to a player which reads a content data from a recording medium such as an optical disc, magneto-optical disc or the like, and concerning the recording medium being applied to a disc-like recording medium such as an optical disc or the like.

The content data referred to herein includes video data such as audio data, still picture, moving picture, etc. or digital data such as text data, computer program, etc. It should be noted that in the embodiments which will be illustrated and described hereunder is audio data, for example.

First Embodiment:

[Data Transmitting Method and Recording Medium Included in the First Embodiment]

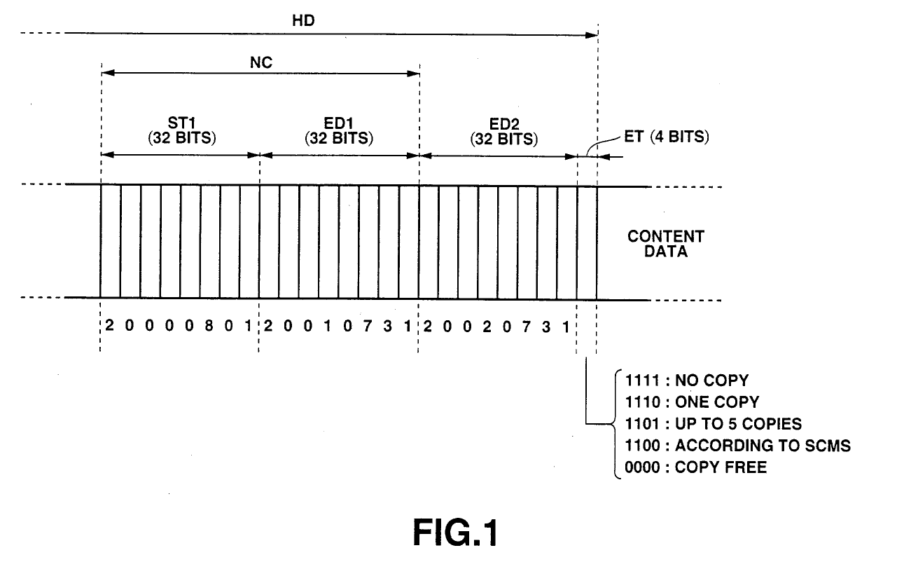

Referring now to FIG. 1, there will be explained the data transmitting method and recording medium in the first embodiment of the present invention. In this embodiment, a content data is transmitted which has added thereto a data as to a period for which a copy-limitation type is applied.

The copy-limitation type indicates “no copy”, limitation of number of times of copying, copy-limiting data, unlimited copying (copy free), etc. The limitation of number of times of copying is such that a number of times of copying (copy count) of a content data to be recorded is limited in a specified recorder. Therefore, under the limitation of number of times of copying, a content data to be recorded can only be copied in a predetermined number in a specified recorder.

The copy-limiting data specifies any of existing copy-limiting methods such as SCMS (serial copy management system), CGMS (copy generation management system) and the like.

In the first embodiment, a content data is supplied in the form of a file. As shown in FIG. 1, the content data supplied in the form a file has provided in a header HD thereof a copy-inhibited or no-copy period area NC in which there is set a period for which copying of the content data is inhibited, end date area ED2 in which there is set an end date of a period for which a copy-limitation type A is applied, and a last copy-limitation type area ET. Also as seen from FIG. 1, the no-copy period area NC consists of a start date area ST1 of 32 bits and an end date area ED1 of 32 bits, in which there are set a start date and end date of the period for which the copying of a content data following the header HD is inhibited, respectively.

In the first embodiment, the copy-limitation type A indicates that the content data can be copied once. The copy-limitation type A-applied period end date area ED2 of 32 bits has set therein an end date of the copy-limitation type A-applied period, that is, a period for which the content data following the header HD is allowed to be copied only once.

The start date area ST1 and end date area ED1 in the no-copy period area NC, and copy-limitation type A-applied period end data area ED2, have the respective dates in BCD (binary coded decimal) code set therein.

According to the first embodiment, the start date area ST1 in the no-copy period area NC has, for example, a date “Aug. 1, 2000 ” set therein, the end date area ED1 in the no-copy period area NC has, for example, a date “Jul. 31, 2001 ” set therein, and the copy-limitation type A-applied period end data area ED2 has, for example, a date “Jul. 31, 2002 ” set therein in the BCD code, as shown in FIG. 1.

Note that for the copy-limitation type A, there is provided only the end date area ED2 because the start date of a period for which copying is limited (limited recording) according to the copy-limitation type A is next to the end date of the no-copy period. That is, in the first embodiment, based on the end date of the no-copy period, the start date of the copy-limitation type A-applied period will be “Aug. 1, 2001 ”, the day next to “Jul. 31, 2001 ” being the end date of the copy-limited period shown in FIG. 1 for example.

In this embodiment, the last copy-limitation type area ET is of 4 bits. In this area, a copy-limitation type to be applied after completion of the copy-limitation type A-applied period. That is, the last copy-limitation type is applied out of the no-copy period and also out of the copy-limitation type A-applied period.

According to the first embodiment, the last copy-limitation types can include, as shown in FIG. 1, five types: “no copy (1111)”, “only one copy (1110)”, “up to 5 times of copying (1101)”, “according to SCMS (1100)” and “copy free (0000)”. It should be noted that each parenthesized train of figures indicates a BCD code indicating the copy-limitation type.

According to the first embodiment, the predetermined area of 64 bits in the header HD is for the no-copy period area NC, the next area of 32 bits is for the copy-limitation type A-applied period end date area ED2, and the further area of 4 bits is for the last copy-limitation type area ET, as above.

In other words, in a predetermined position in the header HD, there is set a period for which a predetermined copy-limiting type is applied, and also in a predetermined position in the header HD, there is set a last copy-limitation type. As will be seen from FIG. 1, the last copy-limitation type area ET is followed by a content data area.

Note that FIG. 1 shows the header HD including only the three areas: the no-copy period area NC, copy-limitation type A-applied period end date area ED2 and last copy-limitation type area ET for the simplicity of illustration and description. However, it should be noted that to the header HD, there are added various types of data including identification information unique to a content data and which identifies the content data, such as ISRC (International Standard Recording Code), and others.

As mentioned above, however, each of the no-copy period area NC, copy-limitation type A-applied period end date area ED2 and last copy-limitation type area ET is pre-positioned within the header HD and also a copy-limitation type specifying a copy-limitation type to be applied for each of the periods is predetermined.

By detecting the above information in the recording according to the present invention, which will be described in detail later, it is possible to inhibit copying when a current date on which a content data is recorded is within the copy-limitation type A-applied period, to limit the copying according to the copy-limitation type A when the current date is within the copy-limitation type A-applied period, and to limit the copying according to the last copy-limitation type when the current date is later than the copy-limitation type A-applied period.

Note that in the first embodiment, for example, when the no-copy period and copy-limitation type A-applied period are not used, namely, when copying of a content data is not limited, for example a predetermined value like “99999999” is set in the copy-limitation type A-applied period area ED in the no-copy period area NC to indicate that copying is not limited.

Only the no-copy period or copy-limitation type A-applied period is provided in some cases. For example, when it is desired to set only a no-copy period, only the no-copy period area NC is used and a predetermined value like “99999999” is set in the copy-limitation type A-applied period end date area ED2.

When only the copy-limitation type A-applied period end date area ED2 is provided, only the copy-limitation type A-applied period end date area ED2 should be used while a predetermined value like “99999999” should be set in the start date area ST1 and end date area ED1 in the no-copy period area NC. In this case, a copy-limitation type A-applied period is provided before the end date of the copy-limitation type A-applied period since there is no copy-limitation type A-applied period start date area.

Note that there may be provided a start date area in which a start date of the copy-limitation type A-applied period is set, and there may not be provided any no-copy period start date area.

[Apparatus Implementing the Data Transmitting Method and Recording Medium Included in the First Embodiment of the Present Invention]

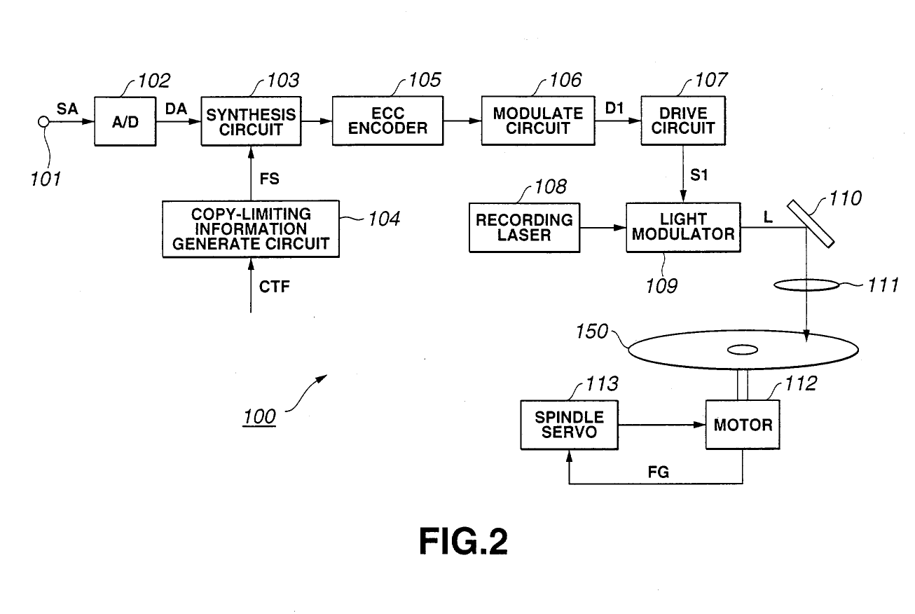

Next, there will be illustrated and described herebelow a recorder intended for implementing a recording medium having recorded therein a content data having added thereto the header HD including the recording-inhibited or no-record period area NC, copy-limitation type A-applied period end date area ED2 and last copy-limitation type area ET, having been explained with reference to FIG. 1. In this first embodiment, an optical disc such as a so-called CD (compact disc) is used as the recording medium by way of example. Referring now to FIG. 2, there is illustrated a recorder included in the first embodiment of the present invention to produce the recording medium according to the present invention. In FIG. 2, the recorder is generally indicated with a reference 100.

The recorder 100 is to implement the first embodiment of the data transmitting method according to the present invention, and produce an optical disc as the recording medium in the first embodiment of the present invention. In the optical disc production by the recorder 100, first an exposed glass master 150 is developed, and then a mother disc is formed by metallizing and electroforming. A stamper is formed from the mother disc. A disc substrate is injection-molded from the stamper set on an injection molder. The injection-molded disc substrate is coated with a reflective layer and subjected to other processes to produce an optical disc.

The glass master 150 is exposed in the recorder 100 is composed of, for example, a flat glass substrate and a photoresist later applied to the glass substrate. The glass master 150 is placed on a disc mount (not shown) rotated by a spindle motor 112 which is controlled by a spindle servo circuit 113 to rotate the glass master 150.

The spindle motor 112 includes a frequency signal generator to generate a frequency signal FG of a frequency corresponding to a velocity of the spindle motor 112. The spindle servo circuit 113 drives the spindle motor 112 so that the frequency signal FG becomes a predetermined one, and the spindle motor 112 thus drive rotates the glass mater 150 at a linear constant velocity (CLV).

The recorder 100 also includes a recording laser 108 formed from a gas laser or the like to emit a laser beam having a predetermined intensity. The recorder 100 further includes a light modulator 109 and a drive circuit 107 which will be described in detail later. The light modulator 109 is formed from electroacoustic optical element and the like to turn on and off the laser beam incident thereupon from the recording laser 108 according to a drive signal S1 supplied from the drive circuit 107. The laser beam L from the light modulator 109 is incident upon a mirror 110.

The mirror 110 deflects the optical path of the laser beam L at a right angle (90 deg.) for example for incidence upon the glass master 150. There is also provided an objective lens 111 which focuses the reflected light from the mirror 110 on the recording layer of the glass master 150, namely, on the photoresist layer applied to the glass master 150.

The mirror 110 and objective lens 111 are sequentially moved by a sled mechanism (not shown) radially of, and synchronously with, the glass master 150. Thus in the recorder 100, the focused position of the laser beam L is sequentially moved from the inner circumference towards the outer circumference of the glass master 150, thereby forming a spiral or concentric track on the glass master 150. There is formed a train of pits corresponding to the modulation (drive) signal S1 supplied from the drive circuit 107.

With the optical disc recorder having the aforementioned recording mechanism, audio data, as a content data, having a header HD added thereto is recorded to the optical disc, and TOC (table of contents) data is recorded in the inner-circumferential area of the optical disc.

[Data Recording in the Recorder Included in the First Embodiment]

Audio signal SA, as a content data, supplied via an input terminal 101 from a predetermined music source is supplied to an analog/digital (A/D) conversion circuit 102. The A/D conversion circuit 102 converts the audio signal SA to a digital signal to provide a content data (digital audio data) DA and supplies it to a synthesis circuit 103.

On the other hand, the recorder 100 includes a copy-limiting information generation circuit 104 which is supplied with a copy-limiting information generation control signal CTF corresponding to a command input from a user or operator (not shown) of the recorder 100 and produces copy-limiting information FS. The command input from the user indicates a start date and end date of a period for which copying is inhibited (no-copy period), end date of a period for which the copy-limitation type A is applied (copy-limitation type A-applied period), last copy-limitation type, etc.

According to the copy-limiting information generation control signal CTF corresponding to the command input from the user, the copy-limiting information generation circuit 104 generates no-copy period start and end date data for entry to the no-copy period area NC of the header HD shown in FIG. 1, copy-limitation type A-applied period end date data for entry to the copy-limitation type A-applied period end date area ED2 and copy-limiting information FS formed from last copy-limitation type for entry to the last copy-limitation type area ET, and supplies them to the synthesis circuit 103.

The synthesis circuit 103 adds a header HD to the content data DA supplied from the A/D conversion circuit 102 and sets the copy-limiting information from he copy-limiting information generation circuit 104 to a corresponding area of the header HD, thereby combining the content data DA and copy-limiting information. Thus the synthesis circuit 103 generates a content data having the copy-limiting information added thereto, and supplies it to an ECC (error correction code) encoder 105 also included in the recorder 100.

The ECC encoder 105 is also supplied with the TOC data for recording to the lead-in area as in an existing CD. The ECC encoder 105 generates an error correction code by the CIRC-based error correction method for the TOC data and then adds it to the TOC data. “CIRC” stands for cross interleaved Reed-Solomon code.

Under the control of a command from a system controller (not shown in FIG. 1), the ECC encoder 105 makes ECC coding of the TOC data and supplies it to a recording modulation circuit 106 when recording to the lead-in area of the glass master 150, while making ECC coding of the content data DA having the header HD added thereto and supplies it to the recording modulation circuit 106 when recording to the data area of the glass master 150.

Note that the TOC data includes for example an identification data indicating that the optical disc is an original compact disc produced by means of a stamper, information as to music information to be recorded and data as to a position where the information is to be recorded, etc.

The recording modulation circuit 106 makes a predetermined modulation of data from the ECC encoder 105 to produce recording data D1, and supplies it to the drive circuit 107. The drive circuit 107 is supplied with the recording data D1, and generates, correspondingly to the logical level of the recording data D1, the drive signal S1 which turns on and off the laser beam.

In this embodiment, the laser beam L from the recording laser 108 is turned on and off by the drive signal S1 corresponding to the recording data D1 to form a train of bits of 0.5 μm in width, for example.

Thus, there is produced an optical disc having recorded therein a content data having the form of a file and added to the header HD thereof the data indicating a start date and end date of the no-copy period, data indicating an end date of the copy-limitation type A-applied period and data indicating a last copy-limitation type, as shown in FIG. 1. The content data is distributed or provided via the optical disc.

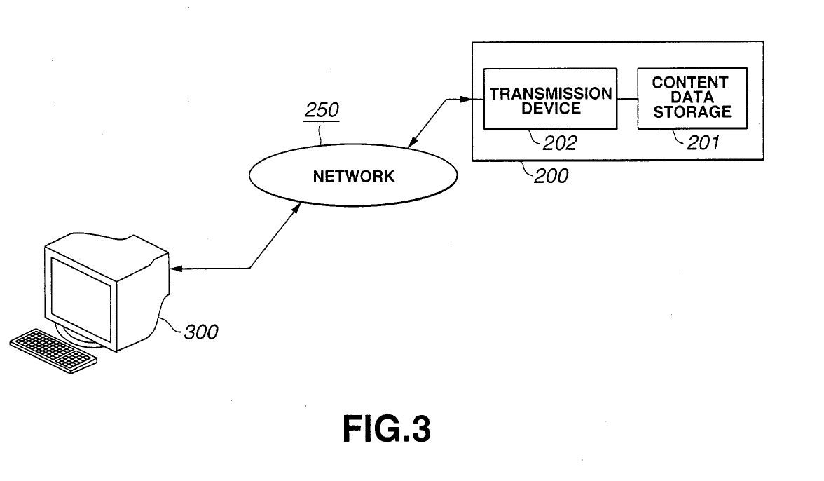

The content data recorded to the optical disc as above can be distributed as it is in the file form to the end users by transmission via a communication network such as the Internet, as shown in FIG. 3 for example.

FIG. 3 explains an environment in which a content data is distributed via the Internet indicated with a reference 250. As shown in FIG. 3, to the Internet 250, there are connected a Web server 200 which provides a so-called Web page and a content data such as audio data and video data, and a user terminal 300 such as a personal computer installed in home and office and provided with a communication function.

Note that the user terminal may not only be any personal computer but a PDA (personal digital assistant) having a communication function, mobile telephone or a notebook type personal computer connected to a mobile telephone.

The Web server 200 includes a content data storage unit 201 composed of a hard disc drive and a transmission device 202 which transmits a content data to the Internet 250. The transmission device 202 has a function to receive a request for sending a content data from the user terminal 300, a content data acquisition function to read, from the content data storage unit 201, a content corresponding to a received sending request.

The transmission device 202 transmits a file-form content data having added thereto a header having the no-copy period area NC, copy-limitation type A-applied period end date area ED2 and last copy-limitation type area ET as shown in FIG. 1 without processing the content data.

In the case of a content data having no header added thereto, however, it can have added thereto, for transmission, a header having the no-copy period area NC, copy-limitation type A-applied period end date area ED2 and last copy-limitation type area ET as shown in FIG. 1.

That is, similarly to the recorder 100 shown in FIG. 2, the transmission device 202 includes a copy-limiting information generation circuit to generate copy-limiting information corresponding to a command input from the user, a synthesis circuit to add the copy-limiting information to the header of a content data, etc.

For transmission of a content data, the Web server 200 can add, to the content data, a period for which a copy-limitation type is applied for the content data, namely, an start date and end date of the no-copy period, end date of the copy-limitation type A-applied period, and also a last copy-limitation type in this embodiment.

By providing the same function as that of the Web server 200 in the broadcasting equipment in a digital satellite broadcast station, it is possible to transmit a content data having copy-limiting information added thereto via the digital satellite broadcasting as well to the end user.

As above, a content data having added to the header thereof copy-limiting information including a start date and end date of a no-copy period, end date of a copy-limitation type A-applied period and last copy-limitation type can be provided via a recording medium such as an optical disc or a communication network such as the Internet, LAN (local area network), a broadcasting medium such as a digital satellite broadcasting, or via any one of various digital interfaces, cable or wireless, to the user.

[Recorder in Which Copy Limitation is Controlled]

Next, there will be described a recorder which is supplied with a content data having added thereto copy-limiting information including a start date and end date of a no-copy period, end date of a copy-limitation type A-applied period and last copy-limitation type, as shown in FIG. 1, and records it to a recording medium. In this embodiment, an optical disc capable of recording data such as CD-R (compact disc-recordable), CD-RW (compact disc-rewritable) is used as the recording medium.

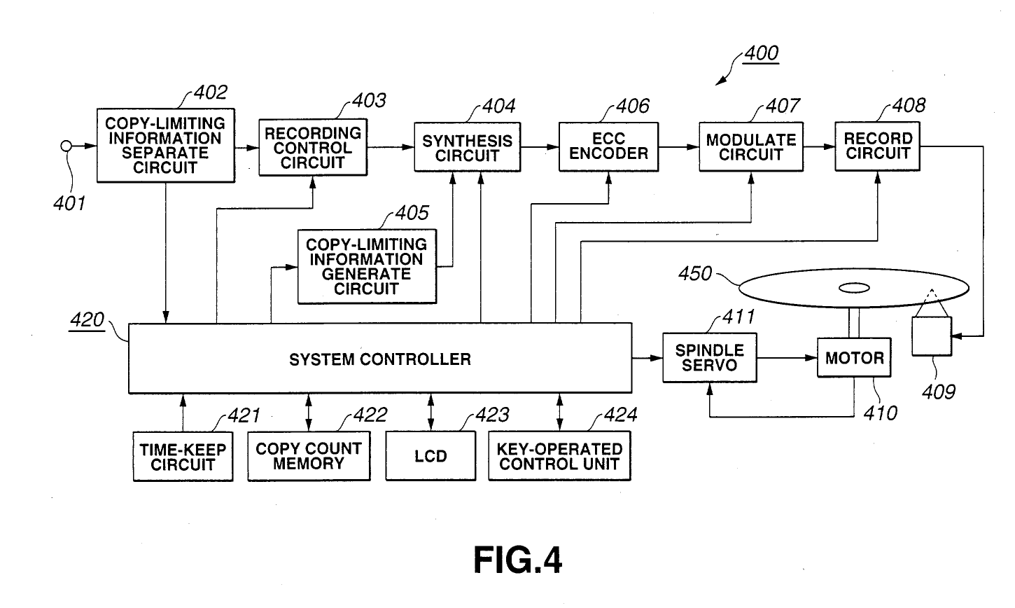

Referring now to FIG. 4, there is schematically illustrated the first embodiment of the recorder according to the present invention in the form of a block diagram. The recorder is generally indicated with a reference 400. A content data having added to the header HD thereof a start date and end date of a no-copy period, end date of a copy-limitation type A-applied period and last copy-limitation type, as shown in FIG. 1, is supplied to the recorder 400 via an input terminal 401, and supplied to a copy-limiting information separation circuit 402.

The content data supplied to the recorder 400 comes from a player which reads a content data from an optical disc having a content data recorded therein, a user terminal such as a personal computer connected to a communication network such as the Internet and which receives a content data via the communication network, or a digital satellite broadcast receiver which provides a content data.

The copy-limiting information separation circuit 402 separates and extracts, from a predetermined position in the header HD of the supplied content data, necessary data such as data indicating a no-copy period, data indicating a period for which the copy-limitation type A is applied, data indicating a last copy-limitation type, content data identification information, etc., and supplies the extracted data to a system controller (will be referred to simply as “controller” hereunder) 420 and the content data to a recording control circuit 403.

Thus the controller 420 is supplied with a start date and end date of the no-copy period, end date of the copy-limitation type A-applied period, last copy-limitation type, content data identification information, etc. about the supplied content data, and thus can manage the data.

Therefore, according to the first embodiment, the controller 420 recognizes that the no-copy period lasts for example from Aug. 1, 2000 until Jul. 31, 2001, the copy-limitation type A-applied period lasts for example from Aug. 1, 2001 until Jul. 31, 2002 and the last copy-limitation type is for example “copy free (0000)” as shown in FIG. 1.

The controller 420 controls each component of the recorder 400 in the first embodiment. It is a microcomputer provided with a CPU, ROM, RAM, etc. (not shown). The controller 420 has a time-keeping circuit 421 connected thereto. When the controller 420 is supplied with a record command from the user via a key-operated control unit 424, it refers to a current day (current date) kept by the time-keeping circuit 421 and detects a current day on which the content data is to be recorded.

Note that in the recorder 400 in this embodiment, the time-keeping circuit 421 provides a current time and has a calender function to keep a current date and current day of the week. The time-keeping circuit 421 is a so-called radio-wave clock which cannot be set or changed in date and time by the user of the recorder 400 but is automatically set correctly in date and time with a radio wave carrying time information.

The controller 420 determines within which the current day is, the no-copy period or copy-imitation type A-applied period. When the current day kept by the time-keeping circuit 421 is within the no-copy period, the controller 420 supplies a control signal to the recording control circuit 403, but not the content data from the copy-limiting information separation circuit 402 to a synthesis circuit 404.

When the current day kept by the time-keeping circuit 421 is within the copy-limitation type A-applied period, the controller 420 uses the identification information of the content data to be recorded by the recorder 400 to the recording medium to refer to data in a copy count memory 422 and determines whether the content data is a one having already been copied by the recorder 400. When the content data is an already copied one, the controller 420 supplies a control signal to the recording control circuit 403, but not the content data from the copy-limiting information separation circuit 402 to the synthesis circuit 404, thereby inhibiting copying of the content data.

When the content data is a one having not yet been copied by the recorder 400, the controller 420 supplies a control signal to the recording control circuit 403, and the content data from the copy-limiting information separation circuit 402 to the synthesis circuit 404.

More specifically, in this embodiment, the copy-limiting type A indicates “only one copy” as having previously been described. One recorder is allowed to make one copy of the content data. To limit the number of times of copying, the copy count memory 422 connected to the controller 420 in this recorder 400 manages the number of times of content data copying made by the recorder 400 to a recording media or media. The user of the recorder 400 can freely add data to, change or delete data in, the copy count memory 422.

As having been described above, the header of the content data has content data identification information. Since the content data identification information is also supplied from the copy-limiting information separation circuit 402 to the controller 420, the recorded content in the copy count memory 422 is changed according to the content data identification information when the content data is recorded by the recorder 400.

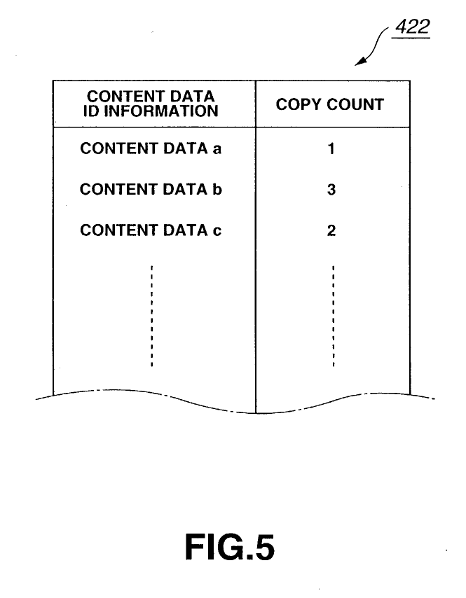

FIG. 5 explains the recorded contents in the copy count memory 422 in the recorder 400. When a content data having not yet been copied by the recorder 400 is copied, identification information (content data a) as to the content data and copy count (once) of the copied content data are additionally recorded in correlation with each other as the content data a indicates in FIG. 5.

Also, when a content data b or c having already been copied is copied by the recorder 400, the number of times of copying correlated with the identification information as to the content data is incremented. In the example shown in FIG. 5, the content data a has only been copied once by the recorder 400, but the content data b has already been copied three times while the content data c has already been copied twice.

When the current day is within the copy-limitation type A-applied period, the controller 420 refers to the recorded data in the copy count memory 422 based on the identification information as to the content data to be copied as having previously been described. When the identification information as to the content data has not yet been recorded (invalid), the controller 420 allows copying of the content data since the content data has not yet been copied by the recorder 400.

When the identification information as to the content data to be copied is existent in the copy count memory 422, the controller 420 inhibits copying of the content data since the content data has already been copied by the recorder 400 but it is not allowed to copy the content data more than twice.

When the current day (date of recording) detected from the time-keeping circuit 421 is not within the no-copy period and copy-limitation type A-applied period, the controller 420 in the recorder 400 controls copying limitation correspondingly to the last copy-limitation type. According to the first embodiment, since the last copy-limitation type is for example “copy free (0000)”, the content can freely be copied after elapse of the copy-limitation type A-applied period.

Therefore, in case a content data is copied in the recorder 400 in the first embodiment, when the current day (day of recording the content data) is within a period defined by data indicating a no-copy period added to the content data, the content data is not provided from the recording control circuit 403 and copying of the content data is thus inhibited.

When the current day is within the copy-limitation type A-applied period added to the content data and the content data has been copied by the recorder 400, no content data is provided from the recording control circuit 403 and copying of the content is thus inhibited.

In other cases, the recording control circuit 403 supplies a header and separated content data from the copy-limiting information separation circuit 402 to the synthesis circuit 404. The synthesis circuit 404 is also supplied with copy-limiting information from a copy-limiting information generation circuit 405. The copy-limiting information generation circuit 405 generates, based on information from the controller 420, copy-limiting information to be added to a content data to be copied and supplies it to the synthesis circuit 404.

According to the first embodiment, to make it impossible to copy a content data recorded in an optical disc 450 to which a content data is to be copied, the controller 420 supplies the copy-limiting information generation circuit 405 with a command to clear the data indicating the no-copy period and data indicating the copy-limitation type A-applied period to all zero and generate data indicating “no copy (1111)” as data indicating a last copy-limitation type.

The copy-limiting information generation circuit 405 clears the data indicating the no-copy period and data indicating the copy-limitation type A-applied period to all zero, generates data indicating “no copy (1111)” as data indicating the last copy-limitation type, and supplies the data to the synthesis circuit 404.

The synthesis circuit 404 sets the copy-limiting information from the copy-limiting information generation circuit 405 to a predetermined position in the header to combine the copy-limiting information from the copy-limiting information generation circuit 405 with the header. The content data having the copy-limiting information in the header thereof thus changed in the synthesis circuit 404 is supplied to an ECC encoder 406.

Similarly to the ECC encoder 105 in the recorder 100 shown in FIG. 2, the ECC encoder 406 generates an error correction code for the content data to be recorded and adds it to the content data. The content data having the error correction code thus added thereto is supplied to a recording modulation circuit 407 where it will be subjected to a predetermined modulation. The content data thus modulated is supplied to an optical pickup 409 via a recording circuit 408.

The optical pickup 409 includes an optical system including a laser source such as a semiconductor laser, beam splitter, objective lens, etc. and an actuator which drives the objective lens in the focusing and tracking directions. It is supplied with a content data (recording signal) from the recording circuit 408, and projects a laser light corresponding to the content data onto the optical disc 450.

At this time, the optical disc 450 is rotated by a spindle motor 410. That is, like the spindle motor 112 of the aforementioned recorder 100, the spindle motor 410 is controlled by a spindle servo circuit 411 to rotate the optical disc 450 at a constant linear velocity. The spindle motor 410 is controlled to start or stop rotating by the spindle servo circuit 411 under a control signal from the controller 420 for example.

Thus, in case the optical disc 450 is a CD-R or the like, it will has a laser light projected onto a recording layer thereof formed from an organic dye thereon, whereby a content data is recorded (copied) to the optical disc 450. When the optical disc 450 is a CD-RW or the like, a content data is recorded (copied) to the optical disc 450 by the phase-change recording method.

[Data Recording in the Recorder Included in the First Embodiment]

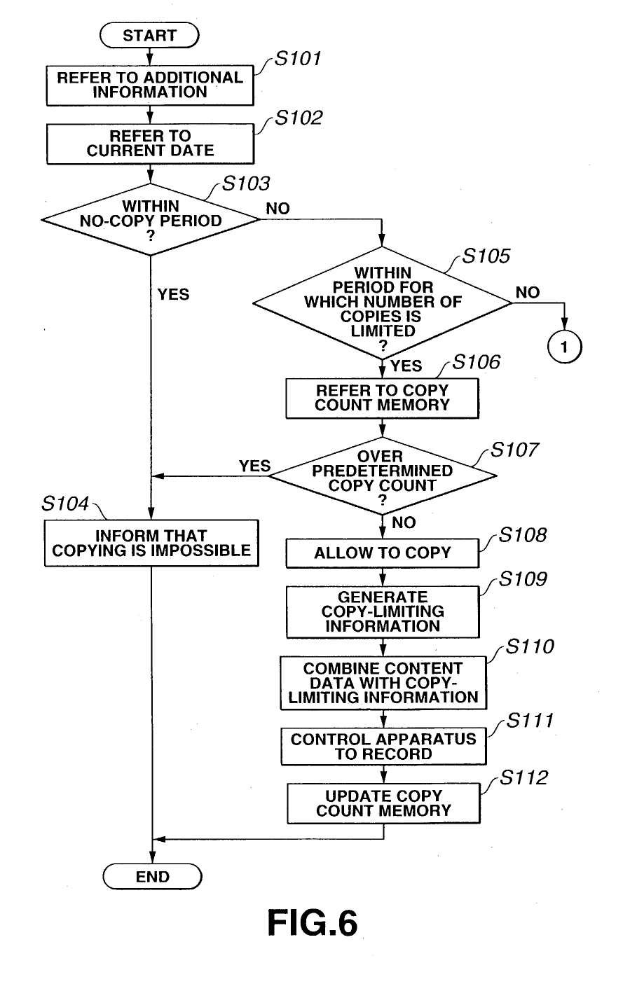

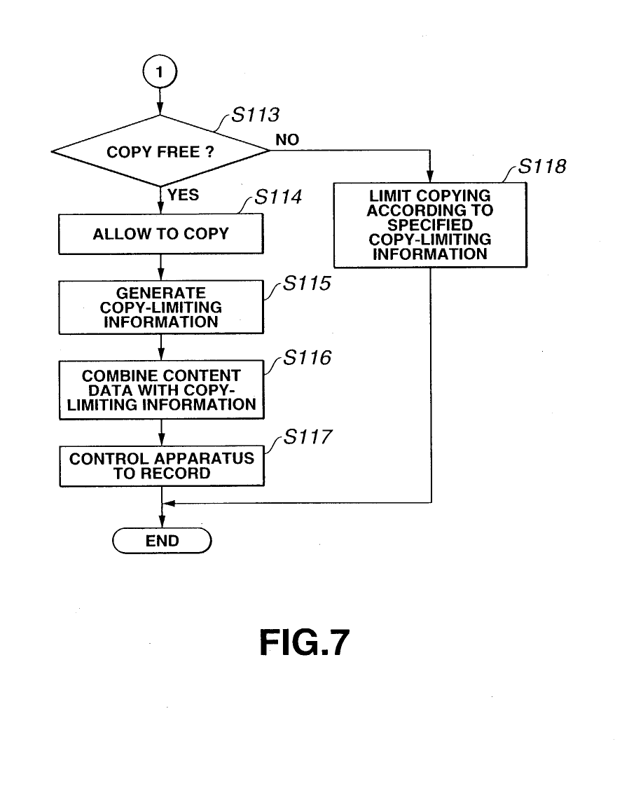

Next, the recording by the recorder 400 constructed as having been described above with reference to FIG. 4 will be described with reference to the flow charts shown in FIGS. 6 and 7. When a command for recording is supplied from the user operating the key-operated control unit 424 of the recorder 400 and a content data is supplied to the recorder 400 via the input terminal 401, the controller 420 of the recorder 400 will follow the procedure as shown in FIGS. 6 and 7 to record the content data.

In step S101, the controller 420 refers to additional data to the content data such as copy-limiting information including the data indicating a no-copy period, data indicating a copy-limitation type A-applied period, last copy-limitation type and also content data identification information, supplied from the copy-limiting information separation circuit 402 as having previously been described. Next in step S102, the controller 420 refers to a current day kept by the time-keeping circuit 421.

Based on the no-copy period data having been referred to in step S101 and the current day having been referred to in step S102, the controller 420 determines in step S103 whether the current day is within the no-copy period. That is, the operation made in step S103 is to determine whether the current day is within a period from a date indicated by a start date data in the start date area of the no-copy period area shown in FIG. 1 until a date indicated by an end date data in the end date area of the no-copy period area.

When the current day is determined in step S103 to be within the no-copy period, the controller 420 goes to step S104 where it will control the recording control circuit 403 not to supply the content data to the synthesis circuit 404 while informing the user, by warning sound or indication, that the content data cannot be copied.

The information made in step S104 is to indicate a message like “The current day is within the no-copy period. No copying is possible” displayed on a display unit 423 formed from an LCD or the like or to emit an alarm sound by controlling a buzzer (not shown) or the like. After informing, in step S104, that the copying is impossible, the controller 420 exits the procedure shown in FIGS. 6 and 7.

Also, when the current day is determined in step S1103 not to be within the no-copy period, the controller 420 goes to step S105 where it will determine, based on the copy-limiting information having been referred to in step S101 and current day having been referred to in step S102, whether the current day is within the copy-limitation type A-applied period (only one copy in this embodiment).

That is, the operation made in step S105 is to determine whether the current day is within a period from a day next to a date indicated by the end date data in the end date area of the no-copy period area shown in FIG. 1 until a date indicated by the end date data in the copy-limitation type A-applied period end date area.

When it is determined in step S105 that the current day is within the period for which a content data is allowed to be copied only once, the controller 420 goes to step S106 where it will refer to the copy count memory 422 based on the content data identification information having been referred to in step S101. Then in step S107, the controller 420 determines whether the copy count regarding the content data to be copied is exceeded.

In this embodiment, a content data is allowed to be copied only once. So, in step S107, the controller 420 will determine, based on the data stored in the copy count memory 422 in the recorder 400, whether the content data to be copied has already been copied.

When it is determined in step S107 that the content data has been copied more than the predetermined number of times of copying, the controller 420 goes to step S104 where it will control the recording control circuit 403 not to supply the content data to the synthesis circuit 404, and inform the that the copying is impossible. Then the controller 420 exits the procedure in the flow charts shown in FIGS. 6 and 7.

When the copy count regarding the content data to be copied is determined in step S107 not to exceed the predetermined number of times of copying, the controller 420 goes to step S108 where it will allow copying of the content data, control the recording control circuit 403 to supply the content data to the synthesis circuit 404. Then in step S109, the controller 420 provides the copy-limiting information generation circuit 405 with information as to copy-limiting information to be generated by the circuit 405, controls the circuit 405 to generate copy-limiting information to be added to the header of the content data to be copied, and supplies the information to the synthesis circuit 404.

In step S110, the controller 420 controls the synthesis circuit 404 to combine the content data to be copied with the copy-limiting information for addition of the copy-limiting information to the content data. Thereafter in step S111, the controller 420 controls each component of the recorder 400 to record the content data having the copy-limiting information added thereto to the optical disc 450.

When copying of the content data is complete, the controller 420 goes to step S112 where it will additionally record identification information for the thus copied content data to the copy count memory 422 in correlation with information indicating that the copy count is one, and terminate the procedure in FIGS. 6 and 7.

When it is determined in step S105 that the current day is not within the period for which a content data is allowed to be copied only once, the controller 420 goes to step S113 in FIG. 7 where it will determine, based on the last copy-limitation type having been referred to in step S101, whether the content data can freely be copied.

When it is determined in step S113 that the content data is allowed to freely be copied, the controller 420 goes to step S114 where it will allow copying of the content data and control the recording control circuit 403 to supply the content data to the synthesis circuit 404. Then in step S115, the controller 420 provides the copy-limiting information generation circuit 405 with information as to copy-limiting information to be generated, controls the circuit 405 to generate the copy-limiting information, and supplies the information to the synthesis circuit 404.

In step S116, the controller 420 controls the synthesis circuit 404 to combine the content data to be copied with the copy-limiting information and add the copy-limiting information to the content data. Thereafter in step S117, the controller 420 controls each component of the recorder 400 to record the content data having the copy-limiting information added thereto to the optical disc 450. When the copying is complete, the controller 420 exits the procedure shown in FIGS. 6 and 7.

When the controller 420 determines in step S113 that the content data is not allowed to freely be copied, it goes to step S118 where it will discriminate the last copy-limitation type to identify what the copy-limitation type is, and control the copy limitation correspondingly to the identified last copy-limitation type. When the copying is impossible or complete, the controller 420 exits the procedure in FIGS. 6 and 7.

Therefore, when the last copy-limitation type indicates that copying is inhibited, the controller 420 inhibits copying. When the last copy-limitation type indicates that a content data can only be copied a limited number of times, the controller 420 makes it possible to copy the content data.

In case the last copy-limitation type indicates that copying should be made according to any other copy limiting method such as SCMS, the controller 420 controls the copy limitation correspondingly to the designated copy limiting method. Therefore, the content data has also information supporting the designated copy limiting method added thereto, and the information is separated and extracted in the copy-limiting information separation circuit 402 for example. Of course, there may be provided a dedicated circuit to extract the information supporting the designated copy limiting method from the content data.

In the recorder 400 according to the first embodiment, the copy-limiting information separation circuit 402 extracts only necessary information such as copy-limiting information, content data identification information, etc., and the copy-limiting information generation circuit 405 and synthesis circuit 404 change only the necessary information such as the copy-limiting information. However, the present invention is not limited to such an arrangement in this embodiment.

Of course, the copy-limiting information separation circuit 402 may be adapted to separate the header part and content data part of a content data transmitted in the form of a file from each other and the copy-limiting information generation circuit 405 and synthesis circuit 404 may be adapted to change the entire header part, for example.

Second Embodiment:

[Data Transmitting Method and Recording Medium Included in the Second Embodiment]

In the aforementioned first embodiment of the present invention, the data indicating a period for which a copy-limitation type is applied is predetermined to indicate a no-copy period and also a copy-limitation type A-applied period as having been described in the foregoing with reference to FIG. 1.

In one case, however, it is desired to inhibit copying of a content data for a predetermined period and allow up to 5 times of copying for a subsequent period so long as the same recorder is used to do it (up to 5 times of copying). In other case, it is desired to allow only one copy for a predetermined period son long as the same recorder is used to do it (only one copying) and inhibit copying for a subsequent period.

As above, depending upon a content data for example, it is desired to freely select a copy-limitation type and a period for which the copy-limitation type is applied. However, if it is possible at the recorder side to extract, from the header of a content data, data as to a period for which a copy-limitation type is applied but it is not possible to discriminate which copy-limitation type the copy-limitation type-applied period is intended for, the copy limitation cannot properly be done in the recorder.

According to the second embodiment, data indicating a copy-limitation type for a period defined by a copy-limitation type-applied period data is added to the copy-limitation type-applied period, and a content data having added thereto the copy-limitation type-applied period data and data indicating a copy-limitation type for a period defined by the copy-limitation type-applied period data is provided via a recording medium or a communication network.

Thus, when a current day (recording day) is within a period defined by a copy-limitation type-applied period added to a content data, it is possible in the recorder to limit copying of the content data by referring to copy-limitation type data added to the copy-limitation type-applied period data and according to a copy-limitation type indicated by the copy-limitation type data. That is, the copy-limitation type-applied period and copy-limitation type can be made different from one content data to be copied to another.

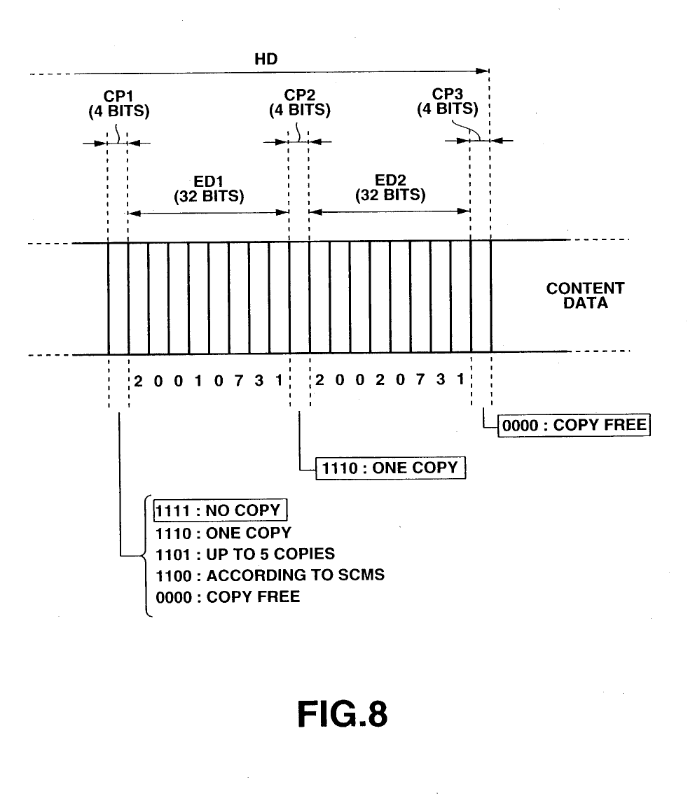

FIG. 8 explains the data transmitting method and recording medium included in the second embodiment of the present invention. According to the second embodiment, in a header HD of a file-form content data provided via a recording medium or a communication network, there are provided a first copy-limitation type area CP1 of 4 bits, first copy-limitation type-applied period end date area ED1 of 32 bits, second copy-limitation type area CP2 of 4 bits, second copy-limitation type-applied period end date area ED2 of 32 bits, and a third copy-limitation type area CP3 of 4 bits, as shown in FIG. 8.

The first copy-limitation type area CP1 has set therein data indicating a copy-limitation type applied in the first copy-limitation type-applied period. Also in this second embodiment, the copy-limitation type may be similar to that in the first embodiment.

That is, the second embodiment uses five copy-limitation types” “no copy (1111)”, “only one copy (1110)”, “up to 5 times of copying (1101)”, “according to SCMS (1100)” and “copy free (0000)” as shown in FIG. 8.

The content data provider selects any one of the above-mentioned five copy-limitation types. The selected copy-limitation type is set in the first copy-limitation type area CP1. In the example shown in FIG. 8, the first copy-limitation type area CP1 has set therein a BCD code “1111” as data indicating a copy-limitation type, namely, data indicating “no copy”.

As shown, end date data indicating an end date of te first copy-limitation type-applied period is set as a BCD code in the first copy-limitation type-applied period end date area ED1. According to the second embodiment, since only the end date data is set in that area ED1, the first copy-limitation type-applied period is before the date indicated by the first copy-limitation type-applied period end date data. That is, in the example shown in FIG. 8, the first copy-limitation type-applied period is before Jul. 31, 2001 for example.

Data indicating a copy-limitation type applied for the second copy-limitation type-applied period is set in the second copy-limitation type area CP2. As in the first copy-limitation type area CP1, any one, selected by the content data provider, of the aforementioned five types of copy-limitation is set in the second copy-limitation type area CP2. In the example shown in FIG. 8, the second copy-limitation type area CP2 has set therein a BCD code “1110” as data indicating a copy-limitation type, namely, data indicating “only one copy”.

End date data indicating an end date of the second copy-limitation type-applied period is set, in the form of a BCD code, in the second copy-limitation type-applied period end date area ED2. According to the second embodiment, the second copy-limitation type-applied period lasts from a day next to a date indicated by the first copy-limitation type-applied period end date data until a date indicated by the second copy-limitation type-applied period end date data. That is, in the example shown in FIG. 8, the second copy-limitation type-applied period lasts from Aug. 1, 2001 until Jul. 31, 2002 for example.

In the third copy-limitation type area CP3, there is set data indicating a copy-limitation type applied after elapse of the second copy-limitation type-applied period. As in the first and second copy-limitation type areas, any one, selected by the content data provider, of the five copy-limitation types is set in this the third copy-limitation type area.

In the example shown in FIG. 8, the third copy-limitation type area CP3 has set therein a BCD code “0000” as data indicating a copy-limitation type, namely, data indicating “copy free”. According to the second embodiment, the copy-limitation type indicated by the data in the third copy-limitation type area CP3 is the last copy-limitation type, and after elapse of the second copy-limitation type-applied period, copying limitation is controlled according to the copy-limitation type indicated by the data in the third copy-limitation type area CP3. As shown in FIG. 8, the third copy-limitation type area CP3 is followed by a content data.

Note that also in the second embodiment, various data other than the copy-limitation information are added to the header HD as in the first embodiment. The other data include identification information unique to a content data, intended for identification of the content data, such as ISRC (International Standard Recording Code).

As mentioned above, also for production of an optical disc as a recording medium having recorded therein a content data having added thereto data indicating the first and second copy-limitation types, data indicating end dates of the first and second copy-limitation type-applied periods, and data indicating the third copy-limitation type, a stamper produced from the mother disc formed by the recorded having been described with reference to FIG. 2 can be used. A mass production can be made of the optical disc, and the optical disc thus produced can be distributed to each of the end users.

As shown in FIG. 3, the content data can be served to the end user by transmission via a communication network such as the Internet. That is, the first and second embodiments are different from each other in data added to a content data but show no large difference between them in the process of providing the content data to the end users.

As shown in FIG. 8, the recorder used to copy a content data having also added thereto data indicating the copy-limitation type applied for each period may be quite the same as the recorder 400 having been described with reference to FIG. 4. However, data indicating a copy-limitation type is additionally included as copy-limiting information which is to be extracted from a content data in the recorder. Thus, the copy limitation can be controlled in the controller of the recorder according to the copy-limitation type for each of the copy-limitation type-applied periods.

Note that the recorder used to copy a content data in the second embodiment is the recorder 400 shown in FIG. 4 and there is illustrated and described recording for copying of a content data having added to the header thereof copy-limitation type-applied period data and data indicating a copy-limitation type as shown in FIG. 8.

[Data Recording in the Recorder Included in the Second Embodiment]

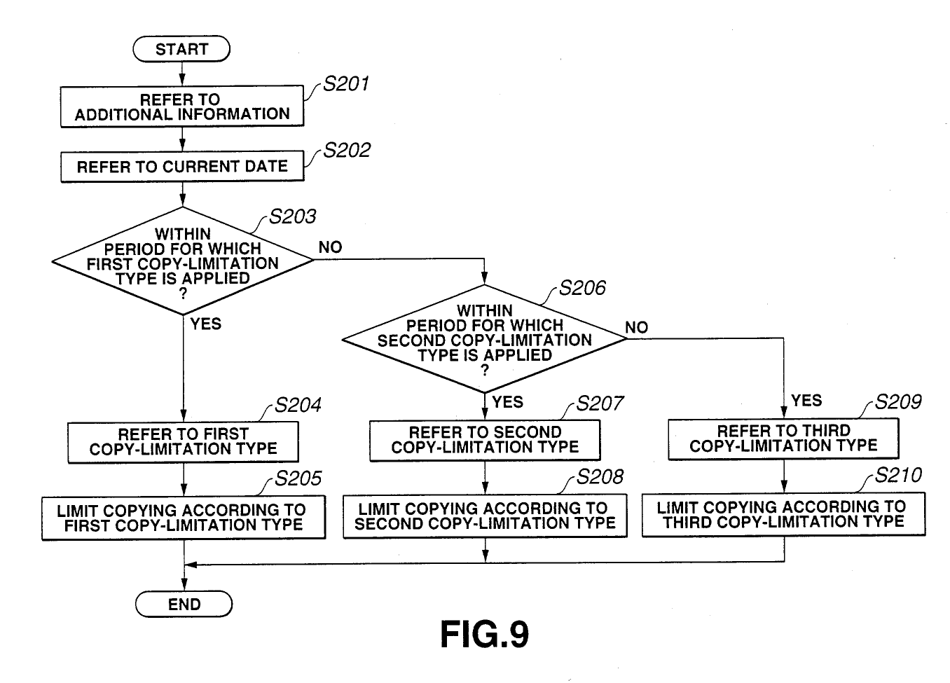

Referring now to FIG. 9, there is shown a flow of recording operations made in the recorder 400 in the second embodiment of the present invention. When a record command is entered by the user operating the key-operated control unit 422 of the recorder 400, and a content data is supplied to the recorder 400 via the input terminal 401, the controller 420 of the recorder 400 will operate as shown in FIG. 9.

In the second embodiment, the copy-limiting information separation circuit 402 of the recorder 400 separates and extracts copy-limiting information including data in the first copy-limitation type area CP1, data in the first copy-limitation type-applied period end date area ED1, data in the second copy-limitation type area CP2, data in the second copy-limitation type-applied period end date area ED2, data in the third copy-limitation type area CP3 and content data identification information as shown in FIG. 8, and supplies the data to the controller 420.

In step S201, the controller 420 refers to the copy-limiting information and content data identification information supplied from the aforementioned copy-limiting information separation circuit 402. Next in step S202, the controller 420 refers to a current day kept by the time-keeping circuit 421.

In step S203, the controller 420 determines, based on the copy-limiting information having been referred to in step S201 and current day having been referred to in step S202, whether the current day is within the first copy-limitation type-applied period. When it is determined in step S203 that the current day is within the first copy-limitation type-applied period, the controller 420 goes to step S204 where it will refer to the data indicating the first copy-limitation type (data from the first copy-limitation type area CP1).

Then in step S205, the controller 420 identifies the first copy-limitation type and controls the copy limitation according to the thus identified first copy-limitation type. Since the first copy-limitation type is “no copy (1111)” in the second embodiment, the controller 420 controls, in step S205, the recording control circuit 403 not to supply the content data to the synthesis circuit 404 and informs the user, via the display unit 423 for example, that copying is impossible. After completion of step S205, the controller 420 exits the procedure in FIG. 9.

When it is determined in step S203 that the current day is not within the first copy-limitation type-applied period, the controller 420 goes to step S206 where it will determine, based on the copy-limiting information having been referred to in step S201 and current day having been referred to in step S202 (as in step S203) whether the current day is within the second copy-limitation type-applied period.

When it is determined in step S206 that the current day is within the second copy-limitation type-applied period, the controller 420 goes to step S207 where it will refers to data indicating the second copy-limitation type (data from th second copy-limitation type area CP2).

Then in step S208, the controller 420 identifies the second copy-limitation type and controls the copy limitation according to the thus identified second copy-limitation type. Since the second copy-limitation type is “only one copy (1110)” in the second embodiment, the controller 420 refers, in step S208, the content data identification information supplied from the copy-limiting information separation circuit 402 and also to the copy count memory 422 based on the content data identification information.

The controller 420 determines whether the copy count of the content data is exceeded. When the copy count is not exceeded, the controller 420 controls the recording control circuit 403 to output the content data to the synthesis circuit 404 for allowing to copy the content data. Also, when the copy count of the content data is exceeded, the controller 420 controls the recording control circuit 403 not to supply the content data to the synthesis circuit 404 and informs the user, by the display unit 423 for example, that the copying is impossible. After completion of step S208, the controller 420 exits the procedure shown in FIG. 9.

When it is determined in step S206 that the current day is after the second copy-limitation type-applied period, the controller 420 goes to step S209 where it will refer to data indicating the third copy-limitation type (data from the third copy-limitation type area CP3).

Then in step S210, the controller 420 identifies the third copy-limitation type and controls the copy limitation according to the thus identified third copy-limitation type. Since the third copy-limitation type is “copy free (0000)” in the second embodiment, the controller 420 controls, in step S210, the recording control circuit 403 to output the content data to the synthesis circuit 404 for allowing to copy the content data.

As above, in the recorder in the second embodiment, when the current day (recording day) is within the first copy-limitation type-applied period, the copy limitation is controlled according to the copy-limitation types indicated by the first copy-limitation type area CP1. When the current day (recording day) is within the second copy-limitation type-applied period, the copy limitation is controlled according to the copy-limitation type indicated by the data in the second copy-limitation type area CP2. When the current day (recording day) is within the second copy-limitation type-applied period, the copy limitation is controlled according to the copy-limitation type indicated by the data in the third copy-limitation type area CP3.

Thus, referring to copy-limitation type data as well as to copy-limitation type-applied period data, it is possible in the recorder in the second embodiment to make copy limitation agreeing with the intension of the content data provider. The copy-limitation type and copy-limitation type-applied period can be made different from one content data to be copied to another, and copying of the content data can be limited according to the intention of the provider or copyrighter of a content.

Note that in the second embodiment, each of the first, second and third copy-limitation types has been described as “no copy”, “only one copy” and “copy free” as shown in FIG. 8. However, the present invention is not limited to these copy-limitation types but various types other than the above may also be used depending upon the intention of the content data provider, and also each copy-limitation type-applied period can be set freely.

In the aforementioned first and second embodiments, as data indicating the copy-limitation type applicable after elapse of the last period, the last copy-limitation type area ET and third copy-limitation type area CP3 are added to the content data as having been described with reference to FIGS. 1 and 8. However, the present invention is not limited to such copy-limitation type data.

For example, when a last copy-limitation type is determined for all content data, it is not necessary to set any data in the last copy-limitation type area ET and third copy-limitation type area CP3. After elapse of the last copy-limitation type-applied period, the copy limitation can be controlled in a predetermined manner, such as inhibition of content data copying, freeing of content data copying or setting of a number of times of content data copying.

In the aforementioned first and second embodiments, two copy-limitation type-applied periods are provided as having been described with reference to FIGS. 1 and 8. However, the present invention is not limited to such periods. One copy-limitation type or more than two copy-limitation types may be provided. In this case, a predetermined copy-limitation type is assigned to each of the periods in the first embodiment, while data indicating a copy-limitation type for each of the periods is added to a content data in the second embodiment.

In case a plurality (such as two, three, four, . . . ) of copy-limitation type-applied periods is provided, a copy-limitation type may be assigned to the first period alone while data indicating a copy-limitation type may be added to each of the second and subsequent periods as in the aforementioned second embodiment.

Alternatively, in case a plurality (such as two, three, four, . . . ) of copy-limitation type-applied periods is provided, data indicating a copy-limitation type may be added to the first period alone while a copy-limitation type may be pre-assigned to each of the second and subsequent periods as in the aforementioned first embodiment.

In case a plurality of copy-limitation type-applied periods is provided as above, a period in which a copy-limitation type pre-assigned correspondingly to a position where it is added and a period to which copy-limitation type data is added may be used together for one content data. It is possible to freely determine a position in the period where the copy-limitation type is pre-assigned and a position in the period where the data indicating the copy-limitation type is added.

In the aforementioned first and second embodiments, data indicating the last copy-limitation type is added to a content data. However, the present invention is not limited to such an arrangement. For example, in case the last copy-limitation type is predetermined to be “copy free” or “no copy” for all the recorders, data indicating a last copy-limitation type may not be added to any content data.

In other words, a last copy-limitation type may be predetermined uniformly for all the recorders. A last copy-limitation type may be preset for each of the recorders. For example, the last copy-limitation type may be made different from one content data to be copied to another based on content data identification information or the like.

[Play-Limitation Control]

The first and second embodiments of the present invention have been described concerning the copy limitation control in the foregoing. Similarly, the content data playing can be limited. That is, by providing a content data having added thereto play-limitation type-applied period data or play-limitation type data and play-limitation type-applied period data, it is possible in a player which plays the content data to control the content data play limitation.

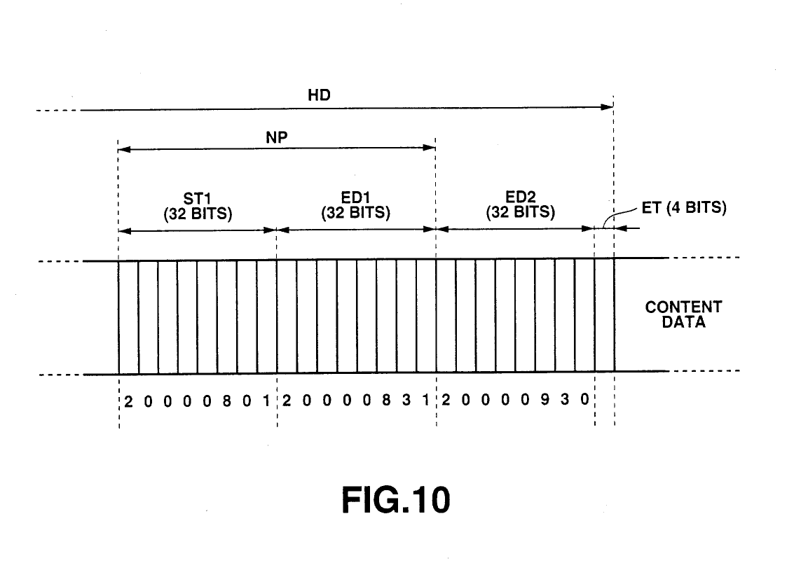

FIG. 10 explains the distribution of a content data having added thereto play-limitation type-applied period data. Similarly to the addition to a content data of a copy-limitation type-applied period data as shown in FIG. 1, play-limitation type-applied period data is added to the header HD of a file-form content data in this example.

As shown in FIG. 10, a play-limitation type-applied period data area in the header HD of a content includes a playing-inhibited or no-play period area NP, play-limitation type A-applied period end date area ED2 and a last play-limitation type area ET similarly to the copy-limitation type shown in FIG. 1.

The playing-inhibited or no-play period area NP includes a start date area ST1 and end date area ED1. The start date area ST1 of the no-play period area NP has set therein a start date of a period for which playing of a content data following the header HD is inhibited, and the end date area ED1 of the no-play period area NP has set therein an end data of the period for which playing of the content data is inhibited. In the example shown in FIG. 10, the content data no-play period starts at Aug. 1, 2000 and ends at Aug. 31, 2000 for example.

The end date area ED2 of the play-limitation type A-applied period has set therein an end date of a period for which playing of a content data following the header HD is limited according to the play-limitation type A. The play-limitation type A limits the number of times of playing for example, and it indicates “up to 5 times of playing (in the same recorder)” for example.

In the example shown in FIG. 10, the period for which the play-limitation type A (limitation to 5 times of playing) is applied lasts from Sep. 1, 2000, a day next to Aug. 31, 2000 within the no-play period, until Sep. 30, 2000.

The last play-limitation type area ET has set therein data indicating the play-limitation type applicable after elapse of the play-limitation type A-applied period. In this example, data indicating “playing free” is set in the area ET. In the example shown in FIG. 10, which play-limitation type is applied to a period is predetermined correspondingly to the added position (position in the header) of the play-limitation type-applied period data.

Thus, data indicating the no-play period, play-limitation type A-applied period and last play-limitation type, respectively, are added to a content data, the content data is recorded to a recording medium such as an optical disc as in the aforementioned copy limitation control. The content data thus recorded in the optical disc can be distributed to the end user. Alternatively, the content data can be distributed to the end users by transmission via a communication network such as the Internet.

The addition, to a content data, of data indicating a period for which a play-limitation type is applied, is intended for assuring sale of the optical disc precisely on a publication day or protecting the content data provider against losing his due profits due to making many copies of a content data within a predetermined period.

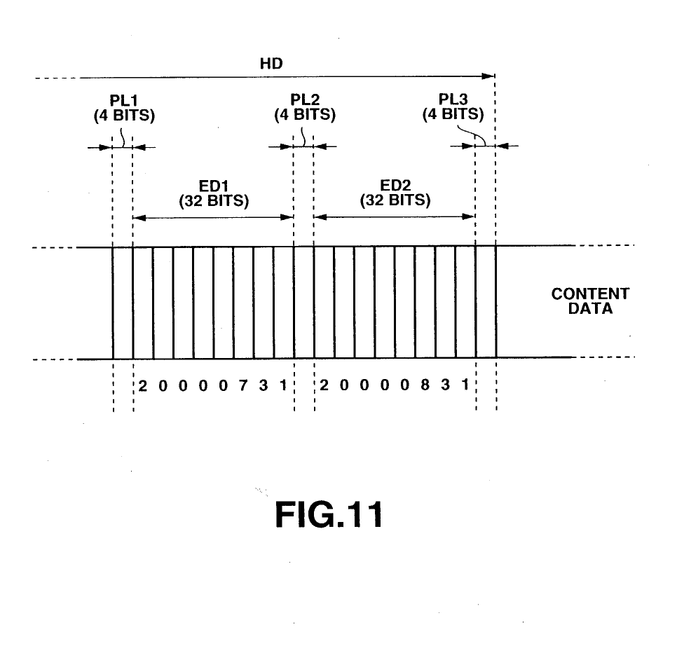

FIG. 11 explains an example of the distribution of a content data having added thereto data indicating a play-limitation type and data indicating a period for which the play-limitation type is applied. Also in this example, the play-limitation type data and play-limitation type-applied period are added to the header HD of a file-form content data.

As shown in FIG. 11, the header HD includes, similarly to the copy-limitation type having been described with reference to FIG. 8, a first play-limitation type area PL1, first play-limitation type-applied period end date area ED1, second play-limitation type area PL2, second play-limitation type-applied period end date area ED2 and a third play-limitation type-applied period end date area PL3.

In the example shown in FIG. 11, the first play-limitation type area PL1 has set therein data indicating a play-limitation type specified by the content data provider. The play-limitation types includes predetermined ones such as “playing inhibited”, “only one playing”, “up to 5 times of playing”, “playing free”, etc.

The first play-limitation type-applied period end date area ED1 has set therein an end date of a period for which the play-limitation type (first play-limitation type) set in the first play-limitation type area PL1 is applied. In the example shown in FIG. 11, the first play-limitation type-applied period end date is Aug. 31, 2000. The period before Aug. 31, 2000 is a period for which the first play-limitation type is applied.

In the example in FIG. 11, the second play-limitation type area PL2 has set therein a predetermined play-limitation type such a “playing inhibited”, “only one playing”, “up to 5 times of playing”, “playing free”, etc. for example.

The second play-limitation type-applied period end date area ED2 has set therein an end date of a period for which the play-limitation type (second play-limitation type) set in the second play-limitation type area PL2 is applied. The second play-limitation type-applied period end date is Sep. 30, 2000 for example. In the example shown in FIG. 11, the second play-limitation type-applied period starts on a day next to Sep. 1, 2000 on which the first play-limitation type-applied period ends and ends on Sep. 30, 2000.

The third play-limitation type-applied period end date area PL3 has set therein a predetermined play-limitation type such a “playing inhibited”, “only one playing”, “up to 5 times of playing”, “playing free”, etc. for example. In the example shown in FIG. 11, data set in the third play-limitation type area PL3 indicates a last play-limitation type.

Also in the example in FIG. 11, data indicating a play-limitation type and data indicating a period for which the play-limitation type is applied are added to a content data. The content data can be recorded to a recording medium such as an optical disc for distribution to the end user, or it can be distributed to the end users by transmission via a communication network such as the Internet. Thus, by adding also data indicating a play-limitation type to a content data, the play-limitation type can flexibly be made different from one content data provider to another or from one content data to another.

[Player in Which Play Limitation is Controlled]

Next, there will be described a content data player which plays a content data having added thereto play-limitation type-applied period data as having been described with reference to FIG. 10 or play-limitation type data and play-limitation type-applied period data as having been described with reference to FIG. 11. It is assumed herein that the content data is recorded in an optical disc.

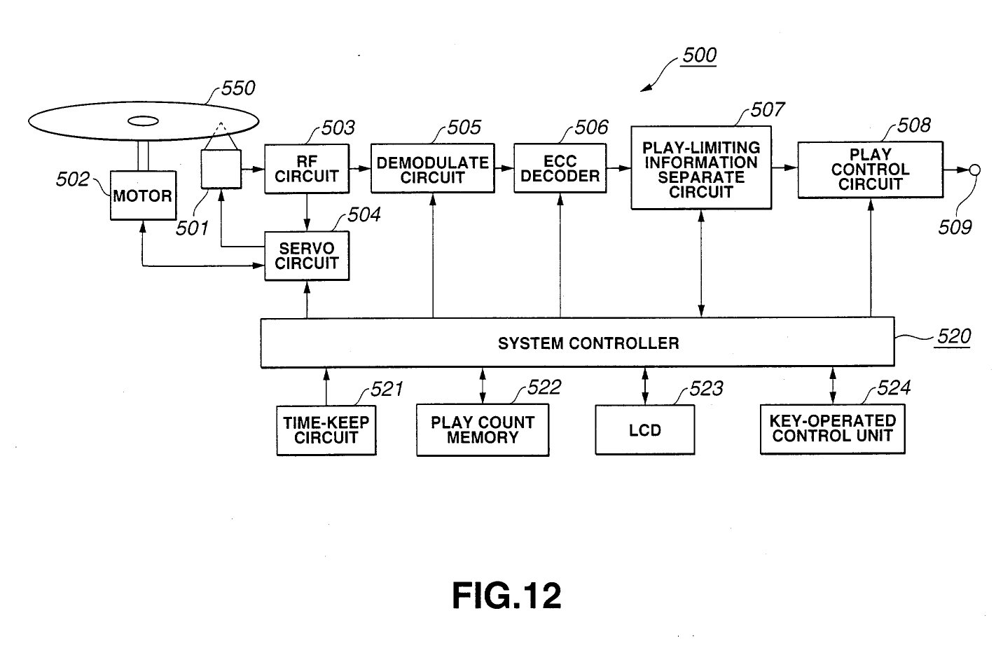

Referring now to FIG. 12, there is illustrated in the form of a block diagram a content data player which reads a content data from an optical disc 550. The content data player is generally indicated with a reference 500. It should be noted that the content data has added thereto play-limitation type-applied period etc. having been described in the foregoing with reference to FIGS. 10 and 11.

When the optical disc 550 is loaded in the player 500, a controller 520 of the latter controls an optical pickup 501 to project laser light to the optical disc 550. The optical pickup 501 detects a reflected light from the optical disc 550. The controller 520 controls a spindle motor 502 to rotate the optical disc 550 at a constant linear velocity (LCV) for example.

The optical pickup 501 includes an optical system including a laser source such as a semiconductor laser, beam splitter, objective lens, etc., actuator which drives the objective lens in the focusing and tracking directions, photodetector, etc. The optical pickup 501 emits laser light from the laser source, detects, by the photodetector, a return light from the optical disc 550, converts the detected reflected light to an electrical signal, and supplies an output signal from the photodetector to an RF circuit 503.

The RF circuit 503 produces a reading RF signal and servo control error signals such as tracking error signal and focus error signal, etc. The servo control error signals thus produced are supplied to a servo circuit 504 while the reading RF signal is supplied to a demodulation circuit 505.

The servo circuit 504 controls, based on the servo error signals from the RF circuit 503, the spindle motor 502 to rotate the optical disc 550 at a constant linear velocity (LCV), and also the optical pickup 501 to scan over the track on the optical disc 550 with the laser light having an appropriate-size beam spot.

The player 500 is also provided with a key-operated control unit 524. When a play command is entered by the user operating the key-operated control unit 524, a system controller (will be referred to simply as “controller”: hereunder) 520 controls each component of the player 500 and starts playing a content data read from the optical disc 550 via the optical pickup 501.

More specifically, the controller 520 moves the optical pickup 501 to a position on the optical disc 550 where a file (content data) which it has been commanded to play is recorded. As having previously been described, the laser light is projected onto the optical disc 550, return light from the optical disc 550 is detected by the photodetector in the optical pickup 501 and converted to an electrical signal by the photodetector, and the thus acquired electrical signal is supplied as an output signal from the photodetector to the RF circuit 503.

As mentioned above, the RF circuit 503 produces, from the signal from the optical pickup 501, an RF signal for playing of the content data including the header, and supplies it the reading RF signal to the demodulation circuit 505. Receiving a control signal for starting demodulation from the controller 520, the demodulation circuit 505 demodulates the content data from the RF circuit 503 and supplies the thus demodulated data to an ECC decoder 506.

The ECC decoder 506 corrects an error of the content data from the demodulation circuit 505, and supplies the error-corrected content data to a play-limiting information separation circuit 507. The play-limiting information separation circuit 507 separates and extracts, from the header HD of the supplied content data, play-limiting information such as play-limitation type-applied period data, identification information unique to the content data such as ISRC for example, and supplies the extracted data to the controller 520.

As shown in FIG. 12, the controller 520 has connected thereto a time-keeping circuit 521 and play count memory 522. Like the time-keeping circuit 421 provided in the recorder 400, the time-keeping circuit 521 has a calender function to keep a current date, current day of the week and current time, which information cannot be changed by the user of the player.

The play count memory 522 manages identification information for the content data played by the player 500 and number of times of playing (play count), which information cannot be changed (addition, alteration or deletion) by the user of the player. That is, the play count memory 522 is equivalent to the copy count memory 422 in the recorder 400. The play count memory 522 manages the play count while the copy count memory 422 manages the copy count, but they function in the same way in management of the number of times of using a content data.

The controller 520 determines whether playing is possible, based on a current day from the time-keeping circuit 521 or a current day from the time-keeping circuit 521 and information from the play count memory 522. When the controller 520 determines that playing is possible, it controls a play control circuit 508 to output the demodulated content data to outside via an output terminal 509.

When the content data is determined not to be playable, the controller 520 controls the play control circuit 508 not to output the demodulated content data to any stages downstream of the play control circuit 508. Thus, the play limitation can be controlled in the player based on the play-limiting information added to the header HD of the content data.

As shown in FIG. 10, when the player 500 plays a content data having play-limitation type-applied period data added to the header HD thereof, it makes playing operations as in the recording procedure followed by the recorder as shown in FIGS. 6 and 7 to control the play limitation.

More specifically, when playing the content data shown in FIG. 10, the controller 520 of the player 500 refers to play-limiting information from the play-limiting information separation circuit 507 such as play-limitation type-applied period data etc. and then to a current day (playing day) kept by the time-keeping circuit 521.

The controller 520 determines, based on the play-limitation type-applied period data and current day, referred to by itself, whether the current day is within the no-play period. When the current day is determined to be within the no-play period, the controller 520 informs the user, by a display unit 523, formed from LCD, provided at the player 500, that playing is impossible, and exits the procedure for playing of the content data.

When the current day is determined not to be within the no-play period, the controller 520 determines whether the current day is within a period for which the play-limitation type A is applied. When the controller 520 determines that the current day is within the play-limitation type A-applied period, it refers to data in the play count memory 522 based on the content data identification information from the play-limiting information separation circuit 507, and determines whether the play count of the content data to be played is exceeded.

When it is determined that the play count is exceeded, the controller 520 controls the play control circuit 508 not to output the demodulated content data, and informs the user, by the display unit 523 or the like, that playing is impossible. Then the controller 520 exits the procedure for playing the content data.

When the play count of the content data to be played is not exceeded, the controller 520 controls the play control circuit 508 to output the demodulated content data. In this case, the controller 520 increments the content data play count in the play count memory 522 and exits the content data playing procedure.

When the current day is after the play-limitation type A-applied period, the controller 520 limits the playing according to the last play-limitation type data. That is, when the last play-limitation type is “playing free”, the content will be played without being limited.

When the last play-limitation type limits the number of times of playing, the controller 520 refers to information from the play count memory 522 and makes it possible to play the content data up to the limited number of times. When the last play-limitation type is “playing inhibited”, the content data will not be played. Thus, the content data play limitation can be controlled.

When playing a content data having added to the header HD thereof data indicating a play-limitation type and play-limitation type-applied period data as shown in FIG. 11, the controller 520 controls the playing operations as in the recording in the recorder shown in FIG. 9 to limit the playing of the content data.

More specifically, when playing a content data shown in FIG. 11, first the controller 520 of the player 500 refers to data indicating a play-limitation type and data as to a period for which the play-limitation type is applied, included in the play-limiting information from the play-limiting information separation circuit 507, and then refers to a current day (playing day) kept by the time-keeping circuit 521.

The controller 520 determines whether the current day is within the first play-limitation type-applied period. When the current day is determined to be within the first play-limitation type-applied period, the controller 520 controls the play limitation according to the first play-limitation type. When the current day is determined not to be within the first play-limitation type-applied period, the controller 520 whether the current day is within the second play-limitation type-applied period. When the current day is determined to be within the second play-limitation type-applied period, the controller 520 controls the play limitation according to the second play-limitation type.

When the current day is determined not to be within the second play-limitation type-applied period, the controller 520 controls the play limitation according to the third play-limitation type, that is, the last play-limitation type.

Thus, the content data play limitation can be controlled as in the content data copy limitation. Namely, the limitation of the content data playing permits to protect the content data provider against loss of his due profits.

In the embodiment for the play-limitation control, a content data recorded in an optical disc is played. However, the present invention is not limited to this control of content data play limitation. For example, in a personal computer or the like which supplies a content data provided via a communication network such as the Internet, the play limitation (output limitation) can be controlled according to the play-limiting information set in the header of the content data as in the aforementioned player 500.

For example, in a receiver or the like called IRD or STB (set top box) which outputs a content data provided via a broadcasting medium such as a digital satellite broadcasting to an external device such as a speaker or monitor receiver, the play limitation (output limitation) can be controlled according to play-limiting information set in the header of the content data as in the aforementioned player 500.

The play-limitation types are not limited to the aforementioned ones but various types other than the above may also be used. For example, there may be provided such play-limitation types as appropriately limit the number of times of playing to “2”, “3”, “4”, . . . , respectively, in addition to the above numbers of times such as “1” and “5”.

Also in the aforementioned play-limitation control, when a last play-limitation type is determined for all content data, it is not necessary to set any data in the last play-limitation type area ET and third play-limitation type area PL3. After elapse of the last play-limitation type-applied period, the play limitation can be controlled in a predetermined manner, such as inhibition of content data playing, freeing of content data playing or setting of a number of times of content data playing.

For the aforementioned play-limitation control, one play-limitation type or more than two play-limitation types may be provided. In this case, a predetermined play-limitation type is assigned to each of the periods in the example shown in FIG. 10, while data indicating a play-limitation type for each of the periods is added to a content data in the example shown in FIG. 11.

In case a plurality (such as two, three, four, . . . ) of play-limitation type-applied periods is provided, a play-limitation type may be assigned to the first period alone while data indicating a play-limitation type may be added to each of the second and subsequent periods.

Alternatively, in case a plurality (such as two, three, four, . . . ) of play-limitation type-applied periods is provided, data indicating a play-limitation type may be added to the first period alone while a play-limitation type may be pre-assigned to each of the second and subsequent periods as in the example shown in FIG. 10.

In case a plurality of play-limitation type-applied periods is provided as above, a period in which a play-limitation type pre-assigned correspondingly to a position where it is added and a period to which play-limitation type data is added may be used together for one content data. It is possible to freely determine a position in the period where the play-limitation type is pre-assigned and a position in the period where the data indicating the play-limitation type is added.

In the examples shown in FIGS. 10 and 11, respectively, data indicating the last play-limitation type is added to a content data. However, the present invention is not limited to such an arrangement. For example, in case the last play-limitation type is predetermined to be “play free” or “no play” for all the players, it is not necessary to add data indicating a last play-limitation type to any content data.

In other words, a last play-limitation type may be predetermined uniformly for all the players. A last play-limitation type may be preset for each of the players. For example, the last play-limitation type may be made different from one content data to be copied to another based on content data identification information or the like.

Both a copy-limitation type-applied period data and play-limitation type-applied period data may be added to the header of a content data, or both data indicating a copy-limitation type and data indicating a period for which the play-limitation type is applied may be added to the header of a content data.

Third Embodiment:

[Data Transmitting Method and Recording Medium Included in the Third Embodiment]

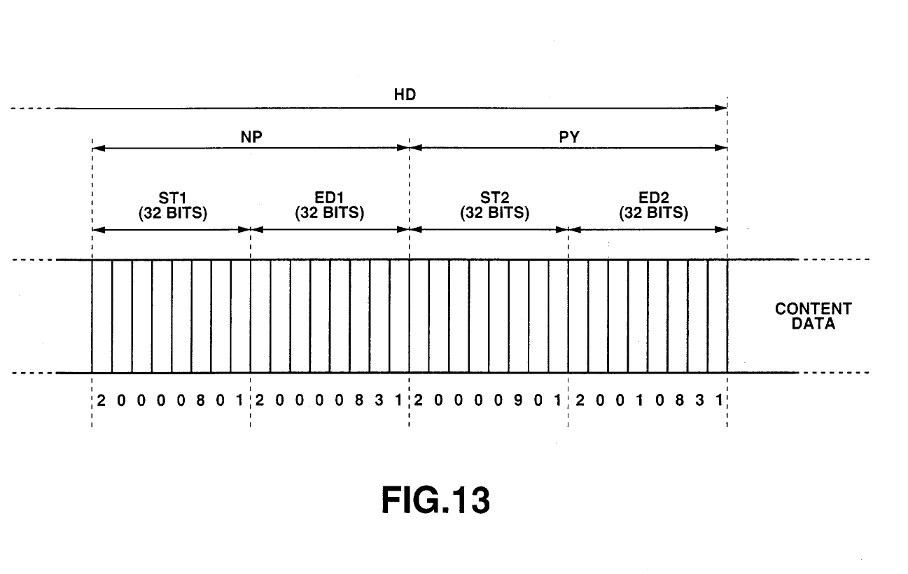

FIG. 13 explains the data transmitting method effected in the third embodiment of the present invention. In the third embodiment, a content data having added thereto data indicating a period for which a billing-limitation type is applied (will be referred to as “billing-limitation type-applied period data) is transmitted.

Note that the billing-limitation type charges the user for use of a content data, instructs the user to pay the charge for copying or playing of the content data, and allows the user to copy or play the content data only when having paid the charge.

More specifically, the billing-limitation types include “copy free with payment of charge (if possible)”, “only one copy with payment of charge (if possible)”, “up to 5 times of copying with payment of charge (if possible)”, etc. Namely, the user is allowed to copy a content data according to a predetermined copy-limitation type only with payment of a charge. When the user has not paid the charge, he is inhibited from copying the content data. Therefore, the billing-limitation type allows the user to copy a content data in principle with payment of the charge.

For playing of a content data, a billing-limitation type may be used as in copying of the content data. Therefore, the billing-limitation types for playing of a content data include “play free with payment of charge (if possible)”, “one play with payment of charge (if possible)”, “up to 5 times of playing with payment of charge (if possible)”, etc. Namely, the user is allowed to play a content data according to a predetermined play-limitation type only with payment of a charge. Without payment of the charge, he is inhibited from playing the content data.

Thus, the billing-limitation type allows the user to copy or play a content data in principle with payment of a charge. In addition to the above, the billing-limitation types include ones indicating no positive billing such as “copy free”, “play free” or the like. However, such a billing-limitation type just means that a copy-limitation type is applied for copying of a content data.

Also in the third embodiment, a content data is provided in the form of a file, and it has provided in the header HD thereof a free-of-charge or no-pay period area NP and a chargeable or paid period area PY, as shown in FIG. 13.

As shown in FIG. 13, the no-pay period NP consists of a start data area ST1 of 32 bits, and an end date area ED1 of 32 bits, in which the content data provider will set a start date and end date of a period for which a content data following the header HD can be copied or otherwise handled free of charge, respectively.

As shown in FIG. 13, the paid or chargeable period PY consists of a start date area ST2 of 32 bits and an end date area ED2 of 32 bits, in which the content data provider will set a start date and end date of a period for which the user can copy or otherwise handle a content data following the header HD with payment of a charge, respectively.

In the third embodiment, it is assumed that the no-pay period is one month long from Aug. 1, 2000 until Aug. 31, 2000, for example, while the chargeable period is one year lone from Sep. 1, 2000 until Aug. 31, 2001, for example.

As shown in FIG. 13, a content data having added to the header HD thereof data indicating a no-pay period and data indicating a chargeable period is recorded to a recording medium such as an optical disc for distribution to the end users as in the aforementioned first and second embodiments, or it is distributed to many end users by transmission via a communication network such as the Internet or via a broadcasting media.

[Recorder in Which Billing Limitation is Controlled]

Next, there will be illustrated and described a recorder which is supplied with a content data having added thereto a start date and end date of a no-pay period and a start date and end date of a chargeable period as shown in FIG. 13, and records the content data to a recording medium. Also in the third embodiment, the recorder is an optical disc recorder, by way of example, which uses, as a recording medium, an optical disc capable of recording data, such as a CD-R (compact disc-recordable), CD-RW (compact disc-rewritable) or the like as in the aforementioned first and second embodiments.

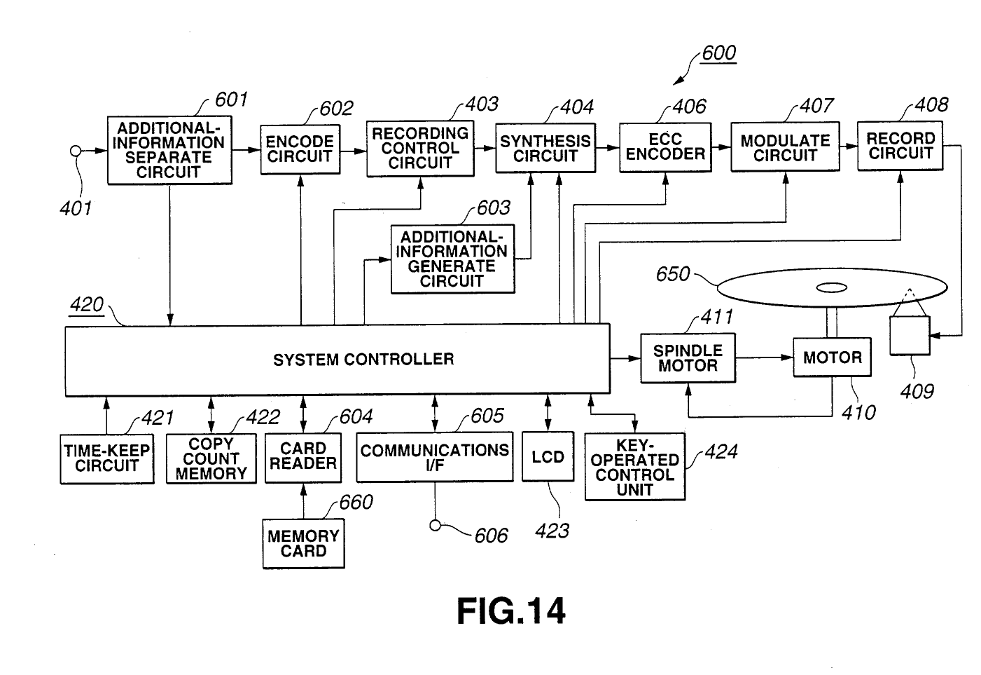

Referring now to FIG. 14, there is illustrated in the form of a block diagram a variant of the recorder included in the first embodiment. The recorder is generally indicated with a reference 600. As shown in FIG. 14, the recorder 600 includes an additional-information separation circuit 601, encryption circuit 602, additional-information generation circuit 603, card reader 604, communications interface (is referred to as “communication I/F” in FIG. 14) 605, and a terminal 606 connected to the communications interface 605.

As will be described in detail later, the additional-information separation circuit 601 separates and extracts billing-limiting information such as no-pay period data, pay period data and other necessary data added to the header HD of a content data. The encryption circuit 602 is provided to encrypt a content data in order to prevent the content data from being illegally used.

The additional-information generation circuit 603 generates no-pay period data and pay period data for added to a content data to be recorded. The card reader 604 is used for billing. It has an insertion slot for a memory card such as a so-called prepaid card or the like having money information as to a prepaid charge. The card reader 604 reads or writes money information from or to the inserted memory card.

The communications interface (will be referred to as “communications I/F” hereunder) 605 and terminal 606 connected to the communications I/F 605 are provided for connection of the recorder 600 to a communication network such as the Internet to receive information as to a charge for example provided via the communication network, for example.

Other components of the recorder 600 are constructed similarly to those in the recorder 400 in the first and second embodiments. For this reason, the similar components to those in the recorder 400 in FIG. 14 are indicated with the same references as those in the recorder 400 in FIG. 14 and will not be described in detail below.

As having been described with reference to FIG. 13, a content data having added to the header HD thereof a no-pay period data and pay period data is entered to the recorder 600 shown in FIG. 14 via the input terminal 401 and supplied to the additional-information separation circuit 601.

Note that a content data supplied to the recorder 600 comes from a content data player which reads a content data from an optical disc having a content data recorded therein, a user terminal such as a personal computer connected to a communication network such as the Internet and which receives a content data via the communication network, or a digital satellite broadcast receiver which provides a content data.

The additional-information separation circuit 601 is provided to separate and extract, from the content data, necessary billing-limiting information such as no-pay period data in the no-pay period area NP, pay period data in the pay period area PY and content data identification information in the header HD of the content data as shown in FIG. 13, and supplies the thus separated data to the controller 420 while supplying the content data to the encryption circuit 602.

The encryption circuit 602 is supplied with an encrypt key from the controller 420 for example and encrypts a content data to be recorded to an optical disc in order to prevent the content data from being illegally used. The encryption circuit 602 supplies the encrypted content data to the recording control circuit 403.

On the other hand, the controller 420 is supplied with the no-pay period data, pay period data, content data identification information, etc. as mentioned above, and it can manage them. When supplied with a record command from the user operating the key-operated control unit 424, the controller 420 refers to a current day kept by the time-keeping circuit 421 to detect a current data on which the content data is to be recorded (recording day).

The controller 420 determines whether the current day is within the no-pay period, pay period or after elapse of the pay period. When the current day is within the no-pay period, the controller 420 supplies a control signal to the recording control circuit 403 to supply the content data from the encryption circuit 602 to the synthesis circuit 404.

At the same time, the controller 420 controls the additional-information generation circuit 603 to generate billing-limiting information such as no-pay period data, pay period data, etc. to be added to the content data to be recorded to the optical disc while controlling the synthesis circuit 404, ECC encoder 406, modulation circuit 407 and recording circuit 408 to record the content data to the optical disc.

Thus, the billing-limiting information generated in the additional-information generation circuit 603 is supplied to the synthesis circuit 404 where it will be set in a predetermined position in the header HD of the content data. The content data having been encrypted and having new billing-limiting information added to the header HD thereof is passed through the ECC encoder 406, modulation circuit 407, recording circuit 408 and optical pickup 409 to an optical disc 650.

When the current day kept by the time-keeping circuit 421 is determined to be within the pay period, the controller 420 reads prepaid-money information in a memory card 660 inserted in the card reader 604 in this embodiment, and determines whether billing is possible, namely, whether the balance on the user's account is sufficient. When the billing is possible, the controller 420 controls each of the circuits provided downstream of the recording control circuit 403 to make it possible to record the content data to the optical disc 650.

However, when the current day kept by the time-keeping circuit 421 is within the pay period but the balance on the user's account is insufficient to pay a charge, or when the memory card 660 itself is not inserted in place in the card reader 604, the controller 420 determines that the billing is impossible and controls the recording control circuit 403 not to output the content data to the synthesis circuit 404. That is, the controller 420 makes it impossible to record the content data to the optical disc 650. In this case, the controller 420 informs the user, by the display unit 423, that the content data cannot be copied.

When the current day or recording day is within the pay period as above, the content data can be copied only when the billing is possible. When the billing is not possible, copying of the content data is inhibited. It should be noted that when the current day is after the pay period, the controller 420 will make a predetermined copy limitation or billing limitation in the third embodiment. In the recorder 600 included in the third embodiment, copying is inhibited uniformly for any cases.

Note that the controller 420 may be adapted to free the copying or make a predetermined copying-limitation control such as limitation of number of times of copying in addition to the copy inhibition when the current day is after the pay period. It should also be noted that for limiting the number of times of copying, the controller 420 determines, based on information in the copy count memory 422, where the copying is possible, as in the recorder 400 in the aforementioned first and second embodiments, and updates the content date copy count in the copy count memory 422 when the content data has been copied.

When the current day is after the pay period, the controller 420 can make a predetermined billing-limitation control. More specifically, the controller 420 may be adapted to allow copying of the content data when the current day is after the pay period and billing of a predetermined money is possible, and to inhibit the copying when the billing of the predetermined money is impossible.

Note that a billed money is predetermined in the recorder 600 for example. Of course, it is also possible to add data indicating a billed money to the header HD of a content data, supply the content data to the recorder 600, and extract, by the additional-information separation circuit 601, the billed money information from the content data in the recorder 600, thereby using the billed money information at the time of billing.

The recorder 600 in the third embodiment is provided with the communications I/F 605 as mentioned above. Data indicating the billed money can be supplied from a server at the content data provider via the communications I/F 605.

Also in the third embodiment, a copy-limitation type or billing-limitation type applicable after elapse of the pay period can be specified by adding last copy-limitation type data or last billing-limitation type data to the header HD of a content data and providing the data together with the content data, as in the first and second embodiments.

[Data Recording in the Recorder Included in the Third Embodiment]

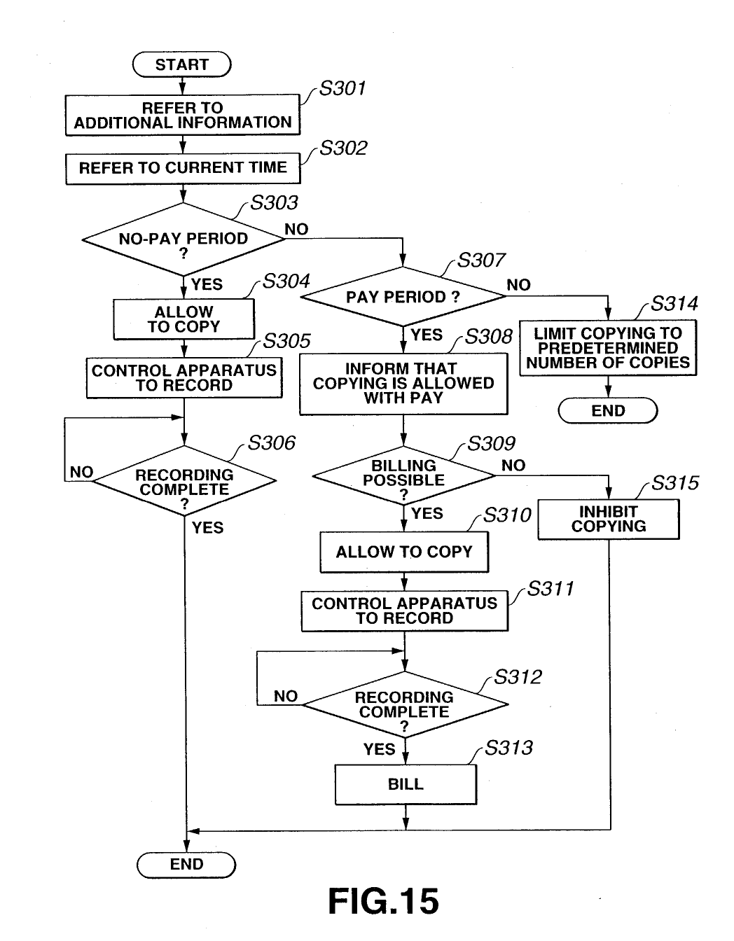

Next, there will be described the recording operations made in the recorder 600 having been described above with reference to FIG. 14. FIG. 15 shows a flow of operations made in recording (limited recording) in the recorder 600. When a record command is entered from the user operating the key-operated control unit 424 provided at the recorder 600 and a content data is supplied to the recorder 600 via the input terminal 401, the controller 420 of the recorder 600 will operate as will be described below with reference to the flow chart shown in FIG. 15.

First in step S301, the controller 420 refers to billing-limiting information, namely, no-pay period data, pay period data and content data identification information, from the additional-information separation circuit 601 as mentioned above. Next in step S302, the controller 420 refers to a current day kept by the timekeeping circuit 421.

In step S303, the controller 420 determines, based on the no-pay period data in the billing-limiting information having been referred to in step S301 and current day having been referred to in step S302, whether the current day is within the no-pay period.

When it is determined in step S303 that the current day is within the no-pay period, the controller 420 goes to step S304 where it will allow copying of the content data, controls the recording control circuit 403 to supply the encrypted content data to the synthesis circuit 404 (namely, control various components of the recorder 600 to make recording operations). Then the controller 420 goes to step S305 where it will cause the recorder 600 to record the content data to the optical disc 650. Thereafter, in step S306, the controller 420 waits until the copying of the content data is complete. When the copying is complete, the controller exits the procedure shown in FIG. 15.

When the current day is determined in step S303 not to be within the no-pay period, the controller 420 goes to step S307 where it will determine, based on the billing-limiting information having been referred to in step S301 and current day having been referred to in step S302, whether the current day is within the pay period.

When it is determined in step S307 that the current day is within the pay period, the controller 420 goes to step S308 where it will inform the user, by the display unit 423 for example, that the content data can be only copied with payment of a charge. In step S308, the controller 420 controls the display unit 423 to display a message like “copying is allowed with payment of appropriate charge. Insert specific prepaid card into card reader”.

In step S309, the controller 420 checks the remainder of the prepaid money recorded in the memory card 660 (prepaid card or the like) inserted in the card reader 604, and determines whether billing is possible. When it is determined in step S309 that the billing is possible, the controller 420 goes to step S310 where it will allow copying, controls the recording control circuit 403 to supply the encrypted content data to the synthesis circuit 404 (namely, controls the components of the recorder 600 to make recording operations). Then in step S311, the controller 420 causes the recorder 600 to record the content data to the optical disc 650.

In step S312, the controller 420 will wait until the recording of the content data is complete. When the recording is complete, the controller 420 goes to step S313 where it will make a billing by subtracting a charge for the copy from the prepaid money (remainder) in the prepaid card (memory card) 660 inserted in the card reader 604, and exit the procedure in FIG. 15.

Note that when the billing cannot successfully be made in step S313, for example, when the prepaid card (memory card) 660 has been removed from the card reader 604, the billing operation in step S313 will not be complete until the billing is successfully complete. No copying of the content data is possible without payment of the charge.

When it is determined in step S309 that the billing is impossible, the controller 420 in the third embodiment will control the recording control circuit 403 not to supply the content data to the synthesis circuit 404, thereby inhibiting copying of the content data in step S315.

In the operation in step S315, the controller 420 informs the user that no copying is possible since billing cannot successfully be done, by controlling the display unit 423 to display a message like “No billing is possible. Insert prepaid card with sufficient remainder of prepaid money”.

When the current day is determined in step S307 not to be within the pay period, the controller 420 in the third embodiment goes to step S314 where it will control the copy limitation in a predetermined manner. Since copying is inhibited after elapse of the pay period in the third embodiment, the controller 420 will control the recording control circuit 403 not to supply the content data to the synthesis circuit 404, thereby inhibiting recording of the content data.

In step S314, the controller 420 informs the user that the content data cannot be copied, by controlling the display unit 423 to display a message like “Period for which coping is possible has passed. No copying is allowed”.

As above, by adding no-pay period and pay period to a content data, copying of the content data is allowed free of charge for the purpose of publicity of the content data for a period of a certain length during initial sales, and also copying of the content data is allowed with payment of an appropriate charge for protecting the content data provider against loss of his due profits and preventing the prevalence of the content data from being interfered with after elapse of the no-pay period.

Note that in the third embodiment, one non-pay period and one pay period are provided as shown in FIG. 13 but the present invention is not limited to this arrangement. For example, for allowing to copy a content data only with payment of a predetermined charge after elapse of a predetermined non-pay period, only no-pay period data is added to the content data. Even with only no-pay period data added to a content data, no-pay and pay periods can be applied by making such a control at the recorder side that a predetermined charge will have to be paid whenever the content data is copied after elapse of the no-pay period.

In case any no-pay period is not provided, only pay period data should be added to a content data. In case only pay period is provided and copying of the content data is allowed without payment of any charge (free of charge) after elapse of the pay period, even with only pay period data added to the content data, pay period and no-pay period can be applied for copying the content data after elapse of the pay period by making such a control at the recorder side that copying of the content data will be allowed free of charge.

In case only pay period is provided and copying of a content is allowed only with payment of a predetermined charge after elapse of the pay period, only data as to the pay period is added to the content data. Two pay periods different in billing conditions from each other can be applied by making such a control at the recorder side that after elapse of the pay period, a predetermined charge will have to be paid whenever the content data is copied. It should be noted that there may be provided a plurality of pay periods different in billing conditions from each other.

In the aforementioned third embodiment, a predetermined copy-limitation control including inhibition of any copying after elapse of a pay period is effected. That is, a copy-limitation type which will be applied after elapse of the last one of the no-pay and pay periods is predetermined, and a copy-limitation control corresponding to the predetermined copy-limitation type is automatically done in the recorder 600. However, the present invention is not limited to such an arrangement.

For example, such an arrangement may be made that data indicating a copy-limitation type (last copy-limitation type) to be applied after elapse of the last one of the no-pay and pay periods will be added to a content data and copy-limitation be controlled based on the last copy-limitation type added to the content data for copying the content data after elapse of the last period, no-pay or pay. In this case, the apparatus may be adapted such that the last copy-limitation type data added to the content data will be extracted in the additional-information separation circuit 601 and used by the controller 420 to limit the copying of the content data.

A last billing-limitation type may be used in place of the last copy-limitation type. By predetermining a last billing-limitation type uniformly for all recorders or adding data indicating the last billing-limitation type to a content data which is to be distributed, copy limitation can be controlled such that after elapse of a period for which the last billing-limitation type is applied, copying of the content data is allowed only with payment of a predetermined charge.

The last billing-limitation type is also applicable to the data transmitting methods according to the aforementioned first and second embodiments. That is, the last copy-limitation type area ET shown in FIG. 1 can be used as a last billing-limitation type area to allow copying of a content data only with payment of a predetermined charge after elapse of a period for which the last billing-limitation type is applied.

[Play-Limitation Control]

The third embodiment has been described concerning the copy-limitation control. However, the play-limitation can be controlled similarly. More specifically, in case the no-pay period and pay period data added to the header HD of a content data as shown in FIG. 13 are used for playing of the content data, playing of the content data can be controlled in the player so that playing of the content data will be allowed free of charge for the no-pay period while it will be allowed only with payment of a predetermined charge for the pay period.

[Player in Which Play Limitation is Controlled]

Next, there will be illustrated and described a player to play a content data having added to the header HD thereof no-pay period data and pay period data for playing of the content data as shown in FIG. 13. It is assumed that the content data is recorded in an optical disc.

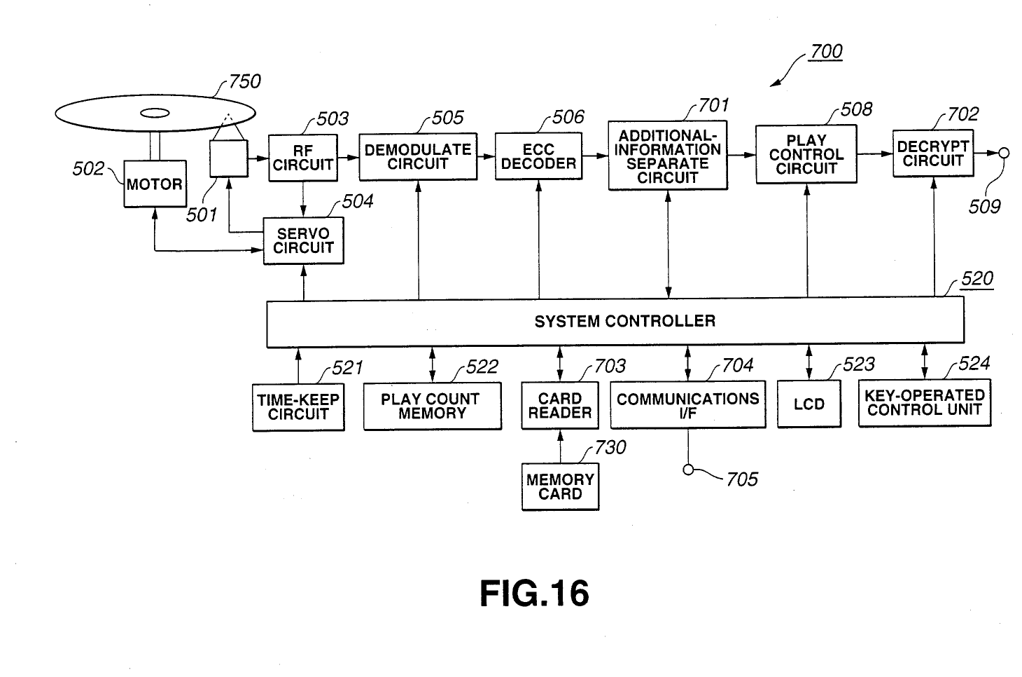

Referring now to FIG. 16, there is illustrated in the form of a block diagram a player to read, from an optical disc, a content data having added thereto no-pay period data and pay period data intended for content data playing as shown in FIG. 13. The player is generally indicated with a reference 700, and the optical disc is indicated with a reference 750. As shown in FIG. 16, the player 700 includes an additional-information separation circuit 701, decryption circuit 702, card reader 703, communications I/F 704 and a terminal 705 connected to the communications I/F 704.

As will be described in detail later, the additional-information separation circuit 701 is provided to separate and extract no-pay period data, pay period data and other necessary data added to the header HD of a content data, decrypt the encrypted content data and restore the content data not yet encrypted.

That is, in the optical disc 750 loaded in the player 700, the content data has added to the header HD of the content data the no-pay period data and pay period data intended for playing of the content data as shown in FIG. 13, and the content data proper has been encrypted to prevent illegal use of thereof. For this reason, the decryption circuit 702 is provided in the player 700 as shown.

Note that to deal with a content data having been encrypted along with the header thereof, the additional-information separation circuit 701 itself includes also a decryption circuit. Also, to deal with a content data having been encrypted together with its header and encrypted after ECC-coded, a decryption circuit is provided upstream of the ECC encoder 506.

The card reader 703 is provided for billing use. It has an insertion slot for receiving a memory card such as a so-called prepaid card having prepaid-money information recorded therein, and reads or writes money information from or to the memory card inserted therein.

The communications I/F 704 and terminal 705 connected to the communications I/F 704 are provided for connection of the player 700 to a communication network such as the Internet. For example, the I/F 704 and terminal 705 permit the player 700 to receive information as to billing, for example, supplied via the communication network.

Other components of the player 700 in FIG. 16 are constructed similarly to the corresponding ones in the players 500 in the first and second embodiments as shown in FIG. 12, and so indicated with the same or similar references as those in FIG. 12. Thus, they will not be explained in detail herebelow.

As in the player 500 shown in FIG. 12, when the user enters a playing or play command by operating the key-operated control unit 524 with the optical disc 750 loaded in the player 700, the player 700 will start reading a content data from the optical disc 750, demodulate the content data read from the optical disc 750 and supply the demodulated data to the additional-information separation circuit 701.

The additional-information separation circuit 701 separates and extracts no-pay period data from the no-pay period area NP in the header HD and pay period data from the pay period area PY, supplies the data to the controller 520 while supplying the content data proper to the play control circuit 508.

The controller 520 controls the play limitation in a generally similar manner to that in the recorder 600 shown in FIG. 15. That is, the controller 520 refers to the no-pay period data and pay period data supplied from the additional-information separation circuit 701, and then to a current day kept by the time-keeping circuit 521, to thereby determine whether the current day is within the no-pay period defined by the no-pay period data.

When it is determined that the current day is within the no-pay period, the controller 520 allows playing of the content data, controls the play control circuit 508 and decryption circuit 702 to supplied the content data from the additional-information separation circuit 701 to the decryption circuit 702 in which it will be decrypted, and outputs the decrypted content data via the output terminal 509.

When the current day is determined not to be within the no-pay period, the controller 520 determined whether the current day is within the pay period. When it is determined that the current day is within the pay period, the controller 520 informs the user that playing of the content data is allowed only with payment of an appropriate charge, and checks the remainder of prepaid money recorded in the memory card 730 inserted in the card reader 703 to determine whether billing is possible.

When the controller 520 determines that the billing is possible, it allows to play the content data, controls the play control circuit 508 and decryption circuit 702 as mentioned above to supply the content data from the additional-information separation circuit 701 to the decryption circuit 702 in which it will be decrypted, and outputs the decrypted content data via the output terminal 509.

When the billing is not possible because the remainder of prepaid money is insufficient or the memory card 730 is not inserted in place in the card reader 703, the controller 520 controls the play control circuit 508 not to supply the content data to the decryption circuit 702, thereby inhibiting playing of the content data.

When it is determined that the current day is not within the pay period, namely, that the current day is after the pay period, the controller 520 will make a predetermined play limitation. In this embodiment, the predetermined play limitation includes inhibition of play, freeing of play, limitation of number of times of playing, etc.

Note that for limiting the number of times of playing, the controller 520 refers to data in the play count memory 522 to check the play count of the content data to be played. The controller 520 allows to play the content data only when it is possible and increments the play count for the content data in the play count memory 522. In this case, identification information for the content data to be played is extracted by the additional-information separation circuit 701 from the header HD of the content data, and supplied to the controller 520. Thus, the content data identification information can be used.

By addition no-pay period and pay period intended for content data playing to a content data as above, the play limitation can be controlled as in the control of copy limitation.

Note that also in the play-limitation control, for allowing to play a content data only with payment of a predetermined charge after elapse of a predetermined no-pay period, only no-pay period data is added to the content data. Even with only no-pay period data added to a content data, no-pay and pay periods can be applied by making such a control at the player side that after elapse of the no-pay period, a predetermined charge will have to be paid whenever the content data is played.

When any no-pay period is provided, only pay period data should be added to a content data. In case only one pay period is provided and playing of the content data is allowed without payment of any charge (free of charge), even with only the pay period data added to the content data, pay period and no-pay period can be applied just by making such a control at the player side that after elapse of the pay period, the user will not be billed whenever the content data is played.

In case one pay period is provided and a predetermined charge should be paid whenever a content data is played, only the pay period data is added to the content data. Two pay periods different in billing conditions from each other can be applied by making such a control at the player side that after elapse of the pay period, a predetermined charge will have to be paid whenever the content data is played. It should be noted that there may be provided a plurality of pay periods different in billing conditions from each other.

Also in the above play-limitation control, a play-limitation type which is to be applied after elapse of the last one of the no-pay and pay periods is predetermined and play limitation is automatically controlled in the player 700 according to the play-limitation type. However, the present invention is not limited to such an arrangement.

In case data indicating a play-limitation type (last play-limitation type) which is to be applied after elapse of the last one of no-pay and pay periods is added to a content data and the content data is played after elapse of the last period, play limitation can also be controlled based on the data indicating the last play-limitation type, added to the content data. In this case, the last play-limitation type data added to the content data should be extracted in the additional-information separation circuit 701, and used by the controller 520 to control the play limitation.

The last play-limitation type may be replaced with a last billing-limitation type. By predetermining a last billing-limitation type uniformly for all players or adding last billing-limitation type data to a content data, the play limitation can be controlled in such a manner that after elapse of the billing-limitation type-applied period, the content data can be played only with payment of a predetermined charge.

The last billing-limitation type is applicable to the transmitting methods as well in the first and second embodiments, respectively. That is, the last play-limitation type area ET shown in FIG. 10 and third play-limitation type area PL3 shown in FIG. 11 can be used as the last billing-limitation type area to allow to play a content data only with payment of a predetermined charge after elapse of the last period.

FIG. 13 shows the start dates and end dates of the no-pay period and pay period, respectively. However, the present invention is not limited to these settings. For example, it is of course that only an end date may be provided. In this case, the first period is a no-pay period in the example shown in FIG. 13. The no-pay period is before the end date, and the period following the end date is a pay period in the example shown in FIG. 13. The pay period will last from a day next to the end date of the no-pay period until the end date of the pay period.

Fourth Embodiment:

[Data Transmitting Method and Recording Medium Included in the Fourth Embodiment]

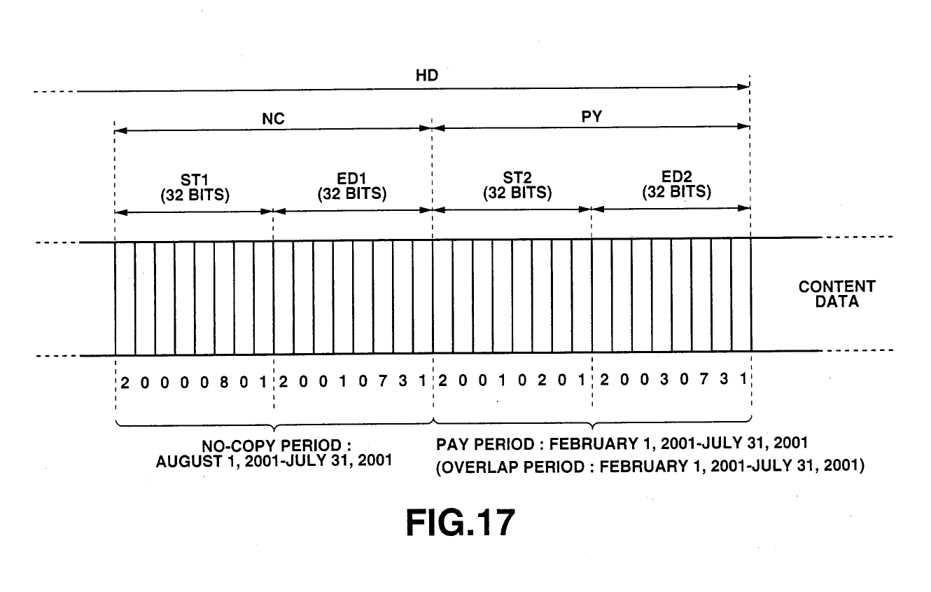

FIG. 17 explains the data transmitting method according to the fourth embodiment of the present invention. According to the fourth embodiment, a content data is distributed by recording it in a recording medium or by transmission via a communication network after adding, to the content data, data indicating a period for which copying of the content data is inhibited, and data indicating a period for which copying of the content data is allowed only with payment of an appropriate charge.

Also in the fourth embodiment, the content is provided in the form of a file and has a copy-inhibited or no-copy period area NC and pay period area PY provided in the header HD thereof as shown in FIG. 17.

As shown in FIG. 17, the no-copy period area NC consists of a start date area ST1 of 32 bits and an end date area ED1 of 32 bits, in which the content data provider will set a start date and end date, respectively, of a period for which copying of a content data proper following the header HD is inhibited (copy-inhibited or no-copy period).

As shown in FIG. 17, the pay period area PY consists of a start date area ST2 of 32 bits and an end date area ED2 of 32 bits, in which the content data provider will set a start date and end date, respectively, of a period for which copying of a content data proper following the header HD is allowed only with payment of an appropriate charge or on a chargeable basis.

In the fourth embodiment, the no-copy period is one year starting on Aug. 1, 2000 and ending on Jul. 31, 2001, and the pay period lasts for two years and five months from Feb. 1, 2001 until Jul. 31, 2003.

Note that as shown in FIG. 17, the no-copy period and pay period overlap each other for five months from Feb. 1, 2001 until Jul. 31, 2001. The overlapping period of five months is a period for which the content is inhibited from being copied but copying of the content is allowed only a predetermined amount of the content, for example, one copy only with payment of an appropriate charge.

Therefore, a content data having added thereto no-copy period data and pay period data as shown in FIG. 17 is “absolutely inhibited from being copied” for a period, for example, from Aug. 31, 1000 until Jan. 31, 2001, “inhibited from being copied in principle” for a period, for example, from Feb. 1, 2001 until Jul. 31, 2001 but allowed to be copied once only with payment of an appropriate charge, and “allowed to be copied with payment of an appropriate charge” for a period, for example, from Aug. 1, 2001 until Jul. 31, 1003.

Note that also in the fourth embodiment, copying of a content data after elapse of the pay period is subjected to a predetermined copy-limitation control. According to the fourth embodiment, copying is allowed to freely be done after elapse of the pay period.

A content data having added to the header HD thereof the copy-inhibited or no-copy period data and pay period data as shown in FIG. 17 is distributed to the end users by providing a recording medium, such as an optical disc, having the content data recorded therein, by transmission via a communication network such as the Internet or by transmission via a broadcasting media, as in the first, second and third embodiments.

[Recorder in Which Copy Limitation and Billing Limitation are Controlled]

Next, there will be described a recorder which is supplied with a content data having added thereto a start date and end date of a no-copy period and a start date and end date of a pay period as shown in FIG. 17 and records the content data to a recording medium. It should be noted that the recorder in the fourth embodiment is constructed similarly to the recorder 600 in the third embodiment shown in FIG. 14 and so the recording procedure in this recorder will be explained below with reference to FIG. 14 as well.

In the recorder 600 according to the fourth embodiment, the additional-information separation circuit 601 separates and extracts, from the header HD of a file-form content data, the no-copy period data in the copy-inhibited or no-copy period area NC, pay period data in the pay period area PY, identification information for the content data, etc. as shown in FIG. 17, and supplies the data to the controller 420.

The information extracted by the additional-information separation circuit 601 of the recorder 600 in the fourth embodiment is different from that extracted by the additional-information separation circuit 601 in the recorder according to the third embodiment, and the controller 420 supplied with the information from the additional-information separation circuit 601 operates in a different manner that in which the controller in the recorder according to the third embodiment operates.

[Data Recording in the Recorder in the Fourth Embodiment]

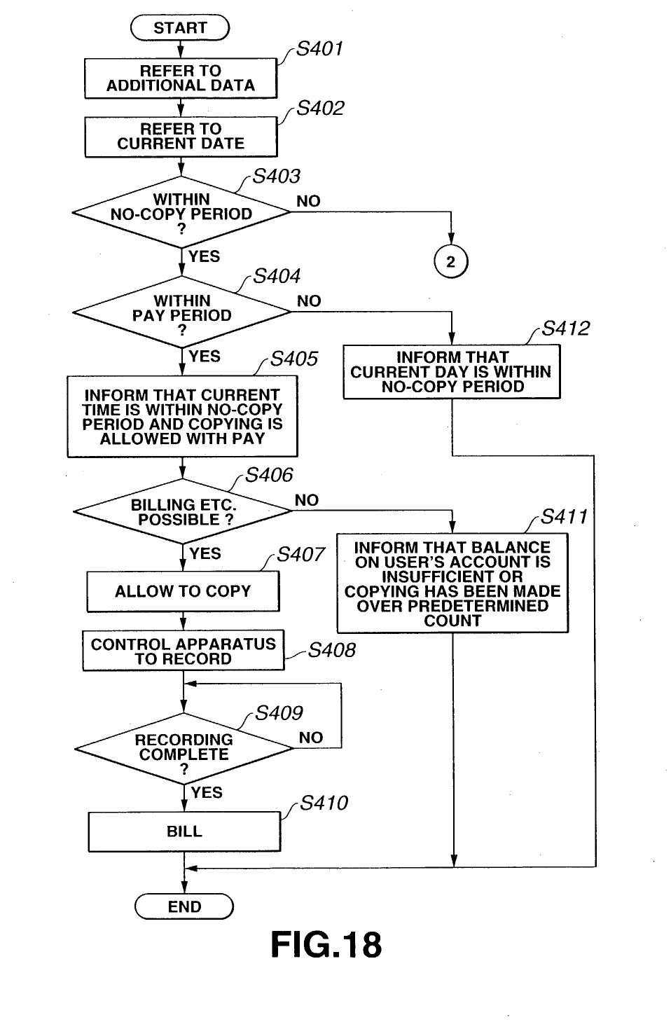

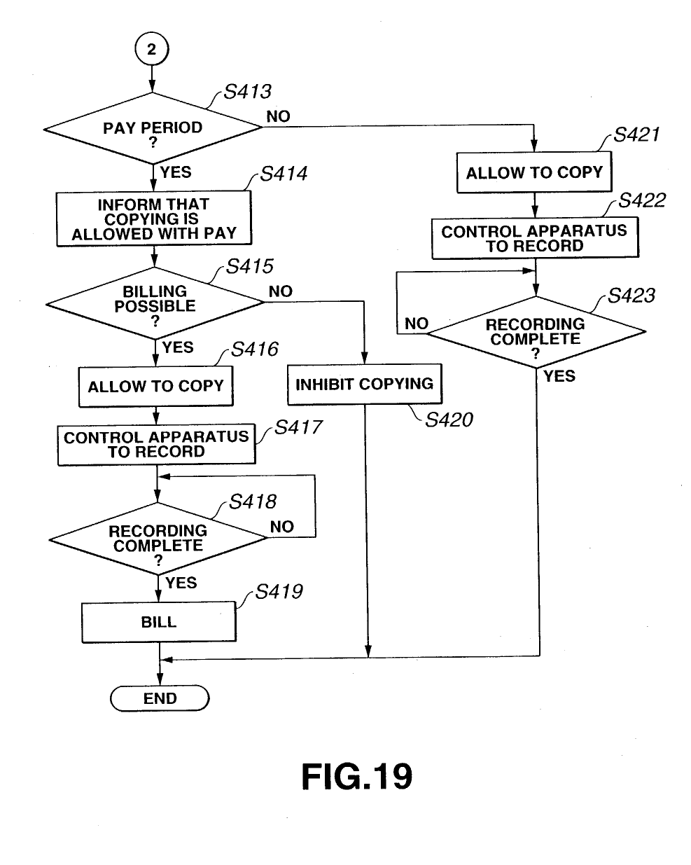

FIGS. 18 and 19 show together a flow of operations made in recording in the recorder 600 in the fourth embodiment of the present invention. When a record command is entered by the user operating the key-operated control unit 424 of the recorder 600 and a content data is supplied to the recorder 600 via the input terminal 401, the controller 420 in the recorder 600 will operate as in the flow charts shown in FIGS. 18 and 19.

First in step S401, the controller 420 refers to the copy-limiting information from the additional-information separation circuit 601, that is, copy-inhibited or no-copy period data, pay period data and identification information for the content data. Next in step S402, the controller 420 refers to a current day kept by the time-keeping circuit 421.

In step S403, the controller 420 determines, based on the copy-limiting information having been referred to in step S401 and current day having been referred to in step S402, whether the current day is within the no-copy period. When the current day is determined in step S403 to be within the no-copy period, the controller 420 goes to step S404 where it will determine whether the current day is within the pay period, with reference to the copy-limiting information having been referred to in step S401 and current day having been referred to in step S402.

When the current day is determined in step S404 to be within the pay period, the controller 420 will determine that the current day is within the period in which the no-copy period and pay period overlap each other (overlap period), and goes to step S405 where it will inform the user that copying is allowed only once with payment of an appropriate charge, by controlling the display unit 423 to display a corresponding message.

In step S406, the controller 420 checks the remainder of prepaid money in the memory card 660 inserted in the card reader 604 and the identification information having been referred to in step S401 and concerning the content data to be copied. When it is determined in step S406 that billing is possible and the content data to be copied is a one having not yet been copied in the recorder 600, the controller 420 goes to step S407 where it will control each component of the recorder 600 such as the recording control circuit 403 and the like, allow to record the supplied content data, and then goes to step S408 where it will cause the recorder 600 to record the content data to the optical disc 650.

The controller 420 will wait in step S409 until the recording of the content data to the optical disc 650 is complete. When it is determined in step S409 that the recording is complete, the controller 420 goes to step S410 where it will subtract a charge amount from the memory card 660 inserted in the card reader 604 and additionally write, to the copy count memory 422, the identification information as to the content data having thus been copied and information indicating that copying has just been made once. Then the controller 420 will exit the procedure shown in FIGS. 18 and 19.

When it is determined in step S406 that the billing is impossible or the content data to be copied is a one having already been copied in the recorder 600, the controller 420 goes to step S411 where it will inform the user, by displaying a message on the display unit 423, for example, that the remainder of his prepaid money or that the copy count is exceeded. Then the controller 420 exits the procedure in FIGS. 18 and 19.

Also, when the current day is determined in step S404 not to be within the pay period, the controller 420 goes to step S412 where it will inform the user, by displaying a message on the display unit 423, for example, that the current day is within the no-copy period alone and copying of the content is impossible even with payment of an appropriate money, and then exit the procedure shown in FIGS. 18 and 19.

When the current day is determined in step S403 not to be within he copy-inhibited or no-copy period, the controller 420 goes to step S413 in FIG. 19, where it will determine whether the current day is within the pay period. When it is determined in step S413 that the current day is within the pay period, the controller 420 goes to step S414 where it will inform the user, by displaying a message on the display unit 423, for example, that copying of the content data is allowed only with payment of an appropriate charge.

In step S415, the controller 420 reads the remainder of the prepaid money in the memory card 660 inserted in the card reader 604 and determines whether billing is possible. When it is determined in step S415 that the billing is possible, the controller 420 goes to step S416 where it will allow to copy the content data and controls various circuits including the recording control circuit 403 etc. for recording the content data, and then goes to step S417 where it will cause the recorder 600 to record the content data to the optical disc 650.

In step S418, the controller 420 will wait until the recoding of the content data to the optical disc 650 is complete. When the controller 420 determines that the recording is complete, it goes to step S419 where it will subtract the charged money from the memory card 660 inserted in the card reader 604, increment the copy count for the content data thus recorded, and additionally record the content data identification information and data indicating that the content data has just been copied once in correlation with each other to the copy count memory 422 when there is no information as to the content data in the memory 422. Then the controller 420 exits the procedure shown in FIGS. 18 and 19.

When it is determined in step S415 that the billing is impossible, the controller 420 goes to step S420 where it will inform the user, by controlling the display unit 423 to display a message, that the content data cannot be copied since the billing is not possible. Then the controller 420 exits the procedure in FIGS. 18 and 19.

When the current day is determined in step S413 not to be within he pay period, the controller 420 will control the copy limitation according to a predetermined copy-limitation type. However in this fourth embodiment, the controller 420 will go to step S421 where it will allow to copy the content data and control various circuits such as the recording control circuit 403 to record the content data to the optical disc 650, and then go to step S422 where it will cause the recorder 600 to record the content data to the optical disc 650.

In step S423, the controller 420 will wait until recording of the content data is complete. When the recording is complete, the controller 420 exits the procedure in FIGS. 18 and 19. After exiting the procedure in FIGS. 18 and 19, the controller 420 will be able to input various commands including a new record command to the recorder 600.

[Play-Limitation Control]

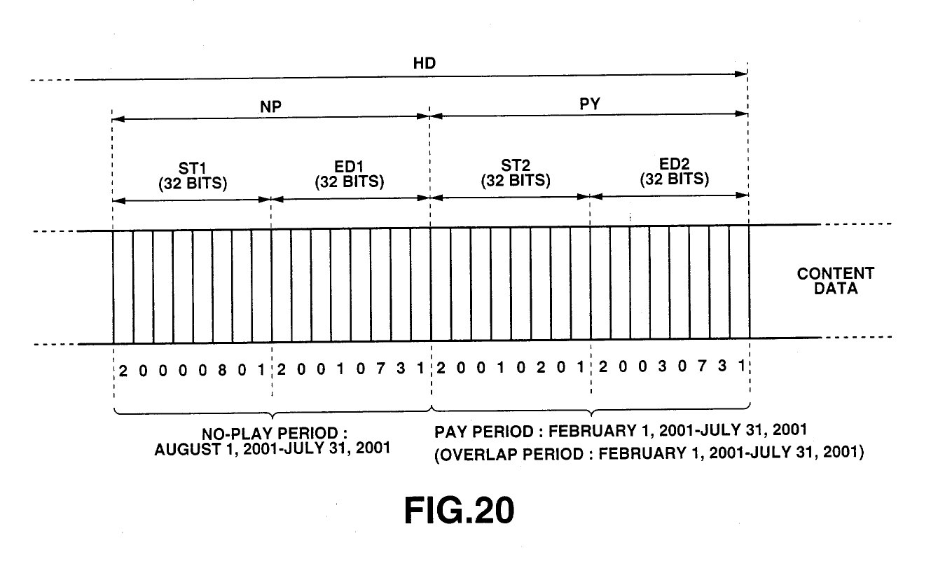

The fourth embodiment of the present invention has been described concerning the copy-limitation control. However, the fourth embodiment can also control the play limitation in a similar manner. Namely, as shown in FIG. 20, there are provided in the header HD of a content data a no-play period area NP and a pay period area PY, in which the content data provider will set predetermined dates, respectively. The content data having thus set thereto a no-play period and pay period is recorded to a recording medium such as an optical disc which will be distributed to the end users.

In the player for a recording medium having recorded therein a content data having added thereto a no-play period and pay period, play limitation and billing limitation can be controlled during playing of the content data as in the recording having been described with reference to FIGS. 18 and 19.

The player should be constructed similarly to the player 700 in the third embodiment having been described with reference to FIG. 16. The additional-information separation circuit 701 extracts the no-play period data, pay period data, content data identification information, etc. and supplies the data to the controller 520. The controller 520 refers to the information from the additional-information separation circuit 701 and current day kept by the time-keeping circuit 521.

When the current day (playing or playing day) is within the no-play period alone, the playing is inhibited. When the current day is within the overlap period between the no-play period and pay period, the content data is allowed to be play ed a predetermined number of times only with payment of an appropriate charge. Also, when the current day is within the pay period alone, the content data is allowed to be play ed only with payment of an appropriate charge. When the current day is after the pay period, playing is limited according to a predetermined play-limitation type.

Thus, a distributed content data having no-play period data and pay period added thereto can be subjected to play-limitation control and billing-limitation control.

Fifth Embodiment:

[Data Transmitting Method and Recording Medium Included in the Fifth Embodiment]

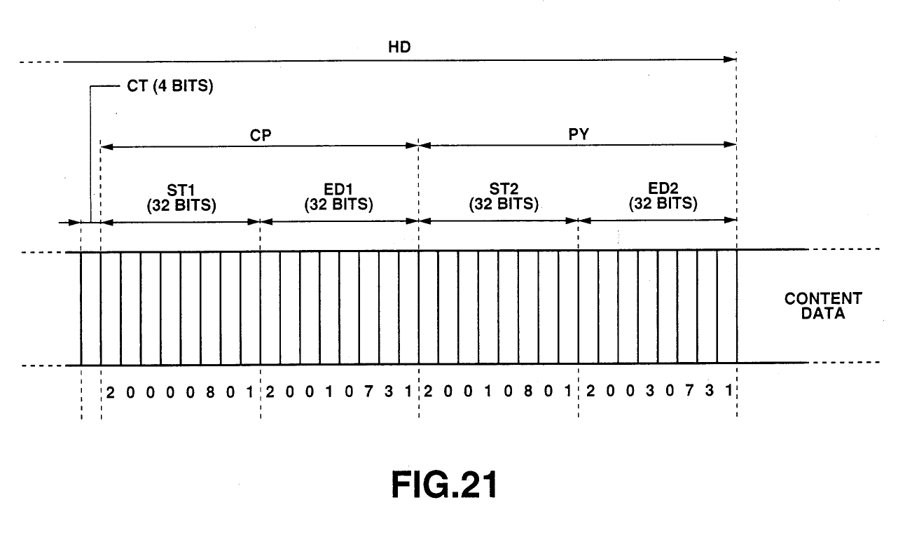

FIG. 21 explains the data transmitting method in the fifth embodiment of the present invention. According to the fifth embodiment of the present invention, data indicating a copy-limitation type, data indicating a period for which the copy-limitation type is applied and data indicating a period for which copying is allowed only with payment of an appropriate charge are added to a content data for distribution by recording it in a recording medium or by transmission via a communication network.

In the aforementioned fourth embodiment, the copy-inhibited or no-copy period and pay period are provided. According to the fifth embodiment, there is not provided any period for which a predetermined copy-limitation type is applied, such as the copy-limited period, but the copy-limitation type can be made different from one content data to be play ed to another. Therefore, in the fifth embodiment, a copy-limited period is a free-of-charge or no-pay period.

Also in the fifth embodiment, a content data is provided in the form of a file, and there are provided in the header HD of the content data a copy-limitation type area CT, copy-limited period area CP and a pay period area PY as shown in FIG. 21.

As shown in FIG. 21, the copy-limitation type area CT is of 4 bits. As in the aforementioned second embodiment, the content data provider will set, in the copy-limitation type area CT, a copy-limitation type indicating how the copying is limited at the recorder side in copying a content data proper following the header HD, such as “no copy (1111)”, “only one copy (1110)”, “up to 5 times of copying (1101)”, “according to SCMS” (1100)”, “copy free (0000)”, etc.

The copy-limited period area CP consists of a start date area ST1 of 32 bits and an end date area ED1 of 32 bits, in which the content data provider will set a start date and end date, respectively, of a period for which a copy-limitation type defined by the data in the copy-limitation type area CT.

As shown in FIG. 21, the pay period area PY consists of a start date ST2 of 32 bits and an end date area ED2 of 32 bits, in which the content data provider will set a start date and end date, respectively, of a pay period for which copying of a content data proper following the header HD is allowed only with payment of an appropriate charge, namely, on a chargeable basis.

In the fifth embodiment, the copy-limited period is one year from Aug. 1, 2000 until Jul. 31, 2001 for example, and the pay period is two years from Aug. 1, 2001 until Jul. 31, 2003 for example. Also in the fifth embodiment, copying to be made after elapse of the pay period is subjected to a predetermined copy-limitation control.

A content data having added to the header HD thereof copy-limitation type data, copy-limited period data and pay period data as shown in FIG. 21 is distributed to many end users by providing a recording medium such as an optical disc in which the content data is recorded or by transmission via a communication network such as the Internet or via a broadcasting media as in the aforementioned first to fourth embodiments.

[Data Recording in the Recorder Included in the Fifth Embodiment]

Next, there will be described a recorder which is supplied with a content data having added thereto copy-limitation type data, copy-limited period data and pay period data as shown in FIG. 21 and records the content data to a recording medium. The recorder in the fifth embodiment is constructed similarly to the recorder 600 in the aforementioned third and fourth embodiments shown in FIG. 14, and the recording in the recorder in the fifth embodiment will be described with reference to FIG. 14 as well.

In the recorder 600 in the fifth embodiment, the additional-information separation circuit 601 extracts the copy-limited period data in the copy-limitation type area CT and copy-limited period area CP in the header HD of a file-form content data, pay period data in the pay period area PY, and the content data identification information as shown in FIG. 21, and supplies the data to the controller 420.

The information extracted by the additional-information separation circuit 601 in the recorder 600 according to the fifth embodiment is different from that extracted by the additional-information separation circuit 601 in the recorders in the third and fourth embodiments, and the controller 420 which receives the information from the additional-information separation circuit 601 operates in a different manner from that in which the controller in the recorders in the third and fourth embodiments operates.

[Data Recording in the Recorder in the Fifth Embodiment]

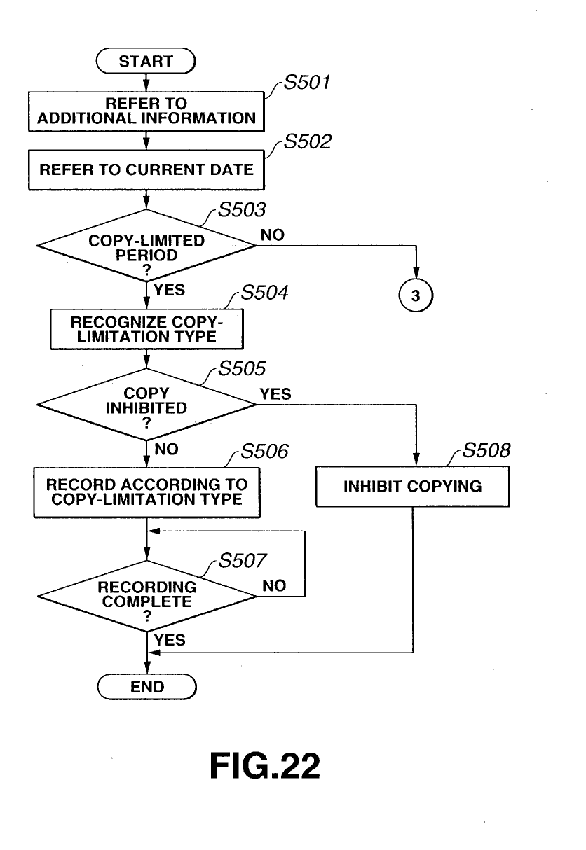

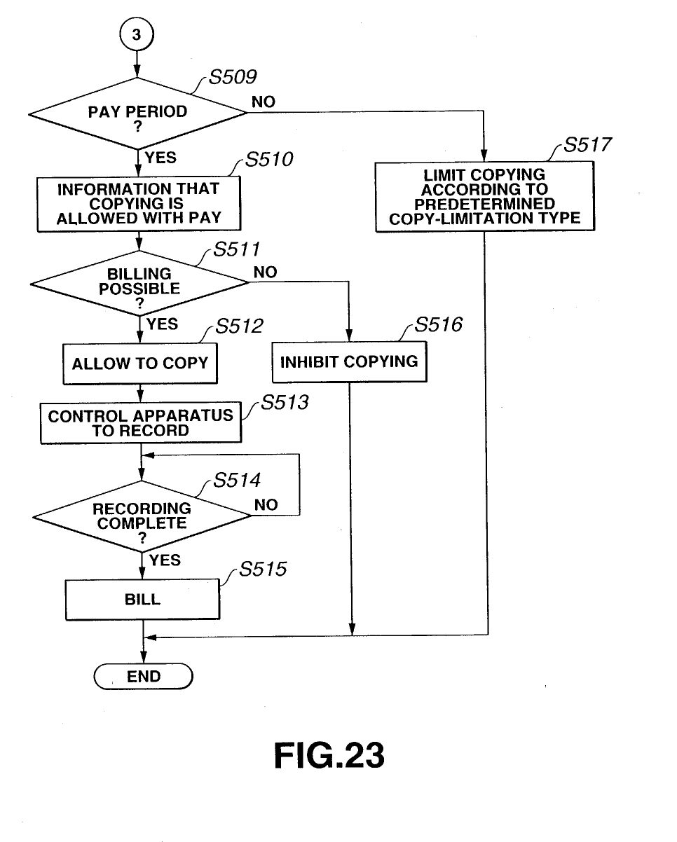

FIGS. 22 and 23 show together a flow of operations made in recording in the recorder 600 in the fifth embodiment of the present invention. When a record command is entered by the user operating the key-operated control unit 424 of the recorder 600 and a content data is supplied to the recorder 600 via the input terminal 401, the controller 420 in the recorder 600 will operate as in the flow charts shown in FIGS. 22 and 23.

First in step S501, the controller 420 refers to information from the additional-information separation circuit 601, that is, copy-limited period data indicating a period for which copying is limited according to data indicating a copy-limitation type, pay period data and content data identification information. Next in step S502, the controller 420 refers to a current day kept by the time-keeping circuit 421.

In step S503, the controller 420 determines, based on the information having been referred to in step S501 and current day having been referred to in step S502, whether the current day is within the copy-limited period. When the current day is determined in step S503 to be within the copy-limited period, the controller 420 goes to step S504 where it will recognize data indicating a copy-limitation type from the additional-information separation circuit 601 and then goes to step S505 where it will determine whether the copy-limitation type data inhibits copying.

When it is determined in step S505 that the copy-limitation type data does not inhibit copying, the controller 420 goes to step S506 where it will control the copy limitation according to the copy-limitation type having been recognized in step S504 and cause the recorder 600 to copy the content data.

Namely, in step S506, the controller 420 will refer to the information in the copy count memory 422 when the copy-limitation type having been recognized in step S504 limits the number of times of copying. When the predetermined number of times is not exceeded, the controller 420 will cause the recorder 600 to copy the content data. When the predetermined number of times is exceeded, the controller 420 will inhibit the content data from being copied. When the copy-limitation type is “copy free”, the controller 420 will allow to copy the content data without any limitations. When the copy-limitation type is “according to SCMS”, the controller 420 will control the copy limitation according to necessary information for the SCMS-based copy-limitation control.

The controller 420 will wait in step S507 until the copying is complete. When the copying is complete, the controller 420 will exit the procedure shown in FIGS. 22 and 23.

When it is determined in step S505 that the copy-limitation type having been recognized in step S504 is “no copy”, the controller 420 goes to step S508 where it will control the recording control circuit 403 etc. to inhibit the supplied content data from being copied. In step S508, the controller 420 will also inform the user, by displaying a message on the display unit 423, for example, that the copying is impossible since the content data is involved in the no-copy period.

When it is determined in step S503 that the current day is not within the copy-limited period, the controller 420 goes to step S509 shown in FIG. 23, where it will determine, with reference to the pay period data having been referred to in step S501 and current day having been referred to in step S502, whether the current day is within the pay period.

When it is determined in step S509 that the current day is within the pay period, the controller 420 goes to step S510 where it will inform the user, by displaying a message on the display unit 423, for example, that the content data is allowed to be copied with payment of an appropriate charge. Then, the controller 420 goes to step S511 where it will check the remainder of the prepaid money in the memory card 660 inserted in the card reader 604 to determine whether billing is possible.

When it is determined in step S511 that the billing is possible, the controller 420 goes to step S512 where it will allow to copy the content data and controls the components of the recorder 600 such as the recording control circuit 403 etc. and then goes to step S513 where it will cause the recorder 600 to record the content to the recording medium. In step S514, the controller 420 will wait until the recording is complete. When the recording is complete, the controller 4210 goes to step S515 where it will bill the user for the copying. Then the controller 420 exits the procedure shown in FIGS. 22 and 23.

In the billing made in step S515, the controller 420 subtracts a predetermined charge from the remainder of the prepaid money in the memory card 660 inserted in the card reader 604. If the memory card is removed from the card reader 604 or it is not correctly inserted in place, no billing is possible. In this case, the controller 420 will not exit the procedure shown in FIGS. 22 and 23 until the billing is successfully complete, holding the copied content data from being used.

When it is determined in step S511 that the billing is not possible, the controller 420 will go to step S516 where it will inhibit the content data from being copied and inform the user that the coping is impossible, by displaying, on the display unit 423, a message like “No billing is possible. Insert specified prepaid card”, and then exits the procedure shown in FIGS. 22 and 23.

When the current day is determined in step S509 not to be within the pay period, namely, that the current day is after the pay period, the controller 420 goes to step S518 where it will make a predetermined copy-limitation control to record the content data, and then exit the procedure shown in FIGS. 22 and 23.

Note that in step S517, when the predetermined copy-limitation type limits the number of times of copying, the controller 420 refers to information in the copy count memory 422. When the predetermined number of times is not exceeded, the controller 420 will cause the recorder 600 to copy the content data. When the predetermined number of times is exceeded, the controller 420 will inhibit the content data from being copied. When the predetermined copy-limitation type is “copy free”, the controller 420 will cause the recorder 600 to copy the content data without any limitations. Also, when the predetermined copy-limitation type is “according to SCMS”, the controller 420 will control the copy limitation according to the necessary information for the SCMS-based copy-limitation control.

[Play-Limitation Control]

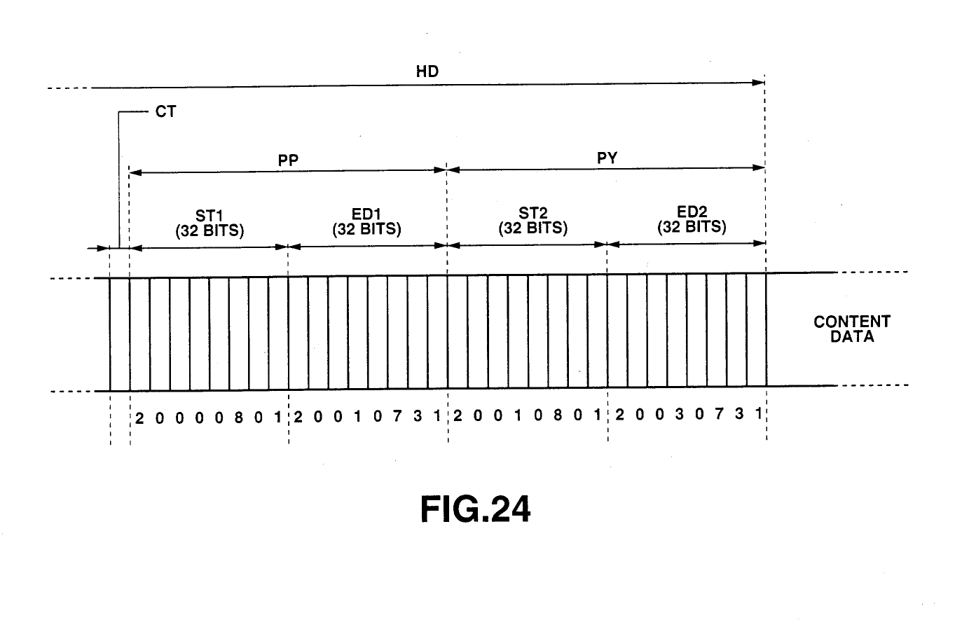

The fifth embodiment of the present invention has been described concerning the copy-limitation control. However, the fifth embodiment can also control the play limitation in a similar manner. Namely, as shown in FIG. 24, there are provided in the header HD of a content data a play-limitation type area CT, play-limited period area PP and a pay period area PY.

The content data provider will set a predetermined play-limitation type in the play-limitation type area CT, a predetermined date in the play-limited period area PP and payer period area PY, and record a content data having added thereto the play-limitation type, play-limited period and pay period to a recording medium such as an optical disc which will be distributed to the end users.

In the player for a recording medium having recorded therein a content data having added thereto a play-limitation type, play-limited period and pay period, play limitation and billing limitation can be controlled during playing of the content data as in the recording having been described with reference to FIGS. 22 and 23.

The player should be constructed similarly to the player 700 in the third and fourth embodiments having been described with reference to FIG. 16. When a play command is entered to the player 700 via the key-operated control unit 524, the additional-information separation circuit 701 extracts the play-limitation type data, pay period data, content data identification information, etc. from the header HD of a content data supplied thereto, and supplies the data to the controller 520. The controller 520 refers to the information from the additional-information separation circuit 701 and current day kept by the time-keeping circuit 521.

When the current day (playing or playing day) is within the play-limited or play-limited period, the play limitation is controlled according to data indicating the play-limitation type set in the play-limitation type area of the header HD. That is, when the data indicating the play-limitation type is “no play”, the controller 520 inhibits playing of the content data and controls the play control circuit 508 etc. not to output the content data from the player 700.

When the play-limitation type data limits the number of times of playing, the controller 520 refers to data in the play count memory 522 with reference to the identification information as to the content data to be play ed. When the predetermined number of times is not exceeded, the controller 520 will allow to play the content data, and control the play control circuit 508 etc to output the content data from the player 700. When the predetermined number of times is exceeded, the controller 520 will inhibit the content data from being played and control the play control circuit 508 etc, not to output the content data from the player 700.

When the play-limitation type data is “play free”, the controller 520 allows to play the content data without any limitations and output the content data from the player 700. Also, when the play-limitation type data specifies that the play limitation should be controlled according to any other method, the controller 520 will control the play limitation according to the other method.

When the current day is not within the play-limited period, the controller 520 determines whether the current day is within the pay period. When it is determined that the current day is within the pay period, the controller 520 checks the remainder of the prepaid money in the memory card 730 inserted in the card reader 703. Only when billing is possible, the controller 520 allows to play the content data and cause the player to play the content data. When the billing is impossible, the controller 520 will inhibit the content data from being played. After the playing is complete, the controller 520 bills the user by subtracting the charge for the play from the remainder of the prepaid money in the memory card 730 in the card reader 703.

When the current day is not within the pay period, the controller 520 will control the play limitation according to a predetermined play-limitation type and cause the player 700 to play the content data.

By adding play-limitation type data, play-limited period data and pay period data to a content data to be distributed, it is possible to make a selected play-limitation control for each content data for example in a play-limited period.

Sixth Embodiment:

[Data Transmitting Method and Recording Medium Included in the Sixth Embodiment]

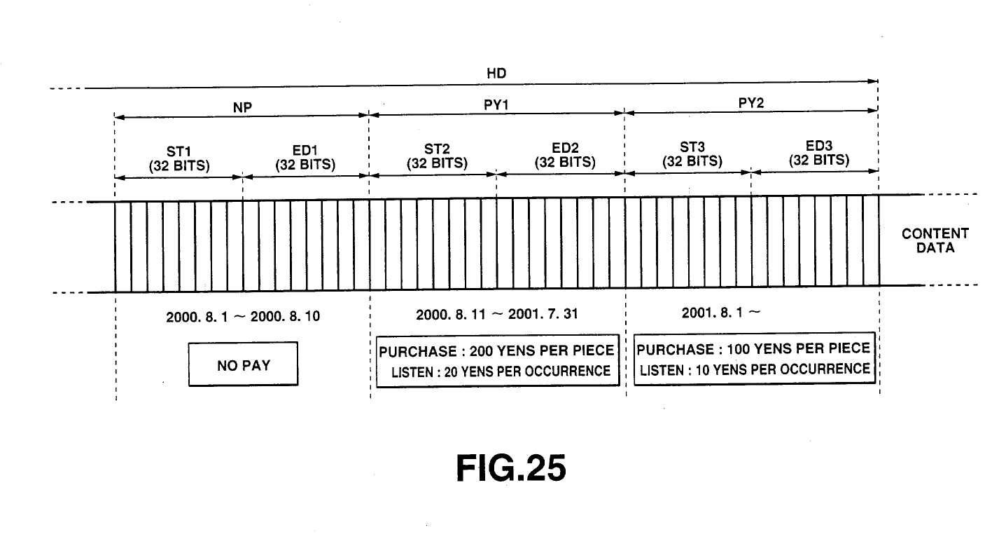

FIG. 25 explains the data transmitting method in the sixth embodiment of the present invention. According to the sixth embodiment, one no-pay period data and a plurality of different pay period data are added to a content data to be distributed to the end users by recording it to recording medium or by transmitting it via a communication network.

Also in the sixth embodiment, a content data is provided in the form of a file, and it has provided in the header HD thereof a no-pay period area NP, pay period-A area PY1 and pay period-B area PY2 as shown in FIG. 25.

The no-pay period area NP consists of a start date area ST1 of 32 bits and an end date area ED1 of 32 bits, in which the content data provider will set a start data and end date, respectively, of a no-pay period for which content data proper following the header HD thereof is allowed to copied free of charge.

The pay period A area PY1 consists of a start date area ST2 of 32 bits and an end data area ED2 of 32 bits, in which the content data provider will set a start date and end date, respectively, of a period A for which content data following the header HD thereof is allowed to be copied with payment of a charge corresponding to billing conditions A.

The pay period B area PY2 consists of a start date area ST3 of 32 bits and an end data area ED3 of 32 bits, in which the content data provider will set a start date and end date, respectively, of a period B for which content data following the header HD thereof is allowed to be copied with payment of a charge corresponding to billing conditions B.

In the sixth embodiment, the no-pay period is 10 days from Aug. 1, 2000 until Aug. 10, 2000 for example, for which audio data being a content data is allowed to be copied or played free of charge.

The pay period A is about one year from Aug. 11, 2000 until Jul. 31, 2001 for example. During this period, audio data being one musical piece which is a content data can be copied (purchased) for 200 yens or audio data being one musical piece which is a content data can be played (listened to) for 20 yens.

The pay period B is after Aug. 1, 2001 for example. During this period, audio data being one musical piece which is a content data can be copied (purchased) for 100 yens and audio data being one musical piece which is a content data can be played (listened to) for 10 yens.

As shown in FIG. 25, a content data having added to the header HD thereof copy-limitation type data, copy-limited period data and pay period data is recorded to a recording medium such as an optical disc for distribution (sold) to the end users or it is distributed to many end users by transmission via a communication network such as the Internet or via broadcasting media as in the aforementioned first, second, third, fourth and fifth embodiments.

By providing a no-pay period and two pay periods different in billing conditions (prices) from each other, it is possible to promote spreading of the content data during the no-pay period, increase the sales of the content data during the pay period A, and continue further the sale of the content data by reducing the charge when the content data has spread to some extent.

Therefore, the content data can be sold in new manners and is available to the users at different prices depending upon when it is acquired, which will distribute such content data at more reasonable prices. Conventionally, such a content is always available at the same price after released.

[Recorder in Which Copy Limitation and Billing Limitation are Controlled]

Next, there will be described a recorder which is supplied with a content data having added thereto no-pay period data, pay period-A data and pay period-B data as shown in FIG. 25, and records it to a recording medium. The recorder in the sixth embodiment is constructed similarly to the recorder 600 in the third, fourth and fifth embodiments shown in FIG. 14, and so the recording in the recorder in the sixth embodiment will be described below with reference to FIG. 14 as well.

In the recorder 600 according to the sixth embodiment, the additional-information separation circuit 601 extracts the no-pay period data in the no-pay period area NP, pay period-A data in the pay period-A area PY1 and pay period-B data in the pay period-B area PY2, and content data identification information, etc. from the header HD of a content data supplied in the form of a file as shown in FIG. 25, and supplies the data to the controller 420.

The information extracted by the additional-information separation circuit 601 in the recorder 600 according to the sixth embodiment is different from that extracted by the additional-information separation circuit 601 in the recorders in the aforementioned third, fourth and fifth embodiments, and the controller 420 supplied with the information from the additional-information separation circuit 601 operates in a different manner from that in the recorders in the third, fourth and fifth embodiments.

[Data Recording in the Recorder Included in the Sixth Embodiment]

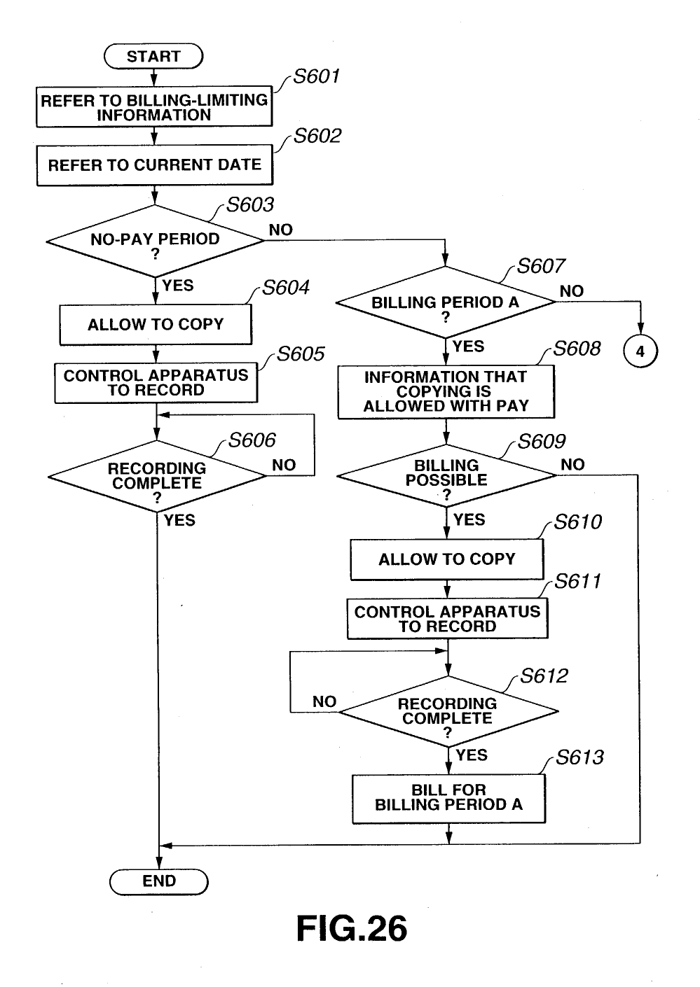

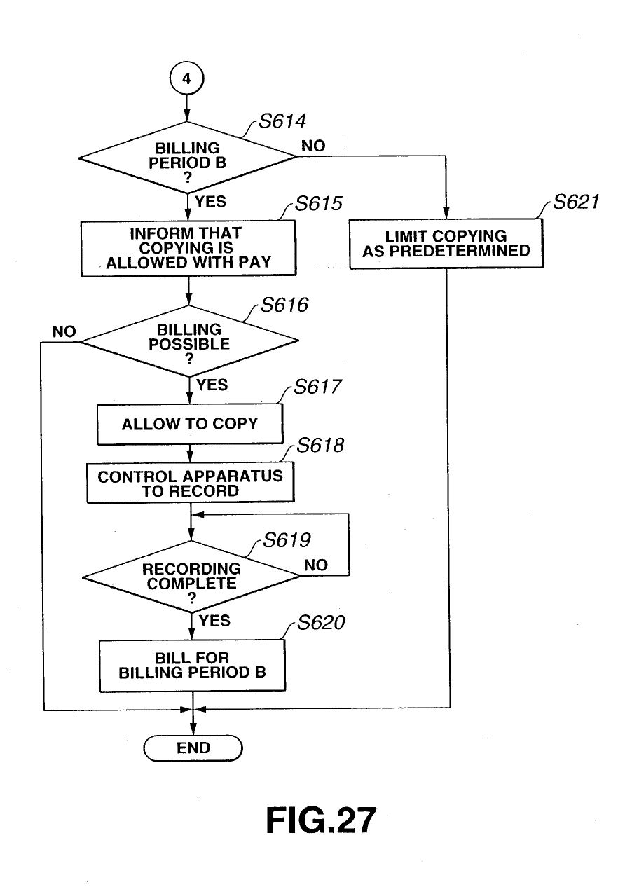

FIGS. 26 and 27 show together a flow of operations made in recording in the recorder 600 in the sixth embodiment of the present invention. When a record command is entered by the user operating a key-operated control unit (not shown) of the recorder 600 and a content data is supplied to the recorder 600 via the input terminal 401, the controller 420 in the recorder 600 will operate as in the flow chart shown in FIGS. 26 and 27.

Fist in step S601, the controller 420 refers to information from the additional-information separation circuit 601, that is, the no-pay period data, pay period-A data, pay period-B data and content date identification information, and then in step S602, the controller 420 refers to a current day kept by the time-keeping circuit 421.

In step S603, the controller 420 determines, based on the no-pay period data having been referred to in step S601 and current day having been referred to in step S602, whether the current day is within the no-pay period. When the current day is determined in step S603 to be within the no-pay period, the controller 420 goes to step S604 where it will allow to copy the content data, and goes to step S605 where it will control various components such as the recording control circuit 403 to cause the recorder 600 to record the content data to a recording medium.

In step S606, the controller will wait until the recording of the content data is complete. When the recording is complete, the controller 420 will exit the procedure shown in FIGS. 26 and 27.

When the current day is determined in step S603 not to be within the no-pay period, the controller 420 goes to step S607 where it will determine whether the current day is within the pay period A, based on the pay period-A data having been referred to in step S601 and current day having been referred to in step S602.

When the current day is determined in step S607 to be within the pay period A, the controller 640 goes to step S608 where it will inform the user, by display a message on the display unit 423, that copying of the content data is allowed only with payment of a charge (200 yens in this example). In step S609, the controller 420 checks the remainder of the prepaid money in the memory card 660 in the card reader 604 to determine whether billing is possible.

When it is determined in step S609 that the billing is possible, the controller 420 goes to step S610 where it will allow to copy the content data, and then goes to step S611 where it will control the various components such as the recording control circuit 403 to cause the recorder 600 to record the content data to a recording medium. In step S612, the controller 420 will wait until the recording is complete. When the recording is complete, the controller 420 goes to step S613 where it will bill the user for the content data recording in the pay period A.

In the billing in step S613, the controller 420 subtracts a predetermined charge from the remainder of the prepaid money in the memory card 660 in the card reader 604. If no billing can be done because the memory card is removed from or not set in the card reader 604, the controller 420 will not exit the procedure in FIGS. 26 and 27 until the billing is successfully be done. In this case, the copied content data cannot be used. After the billing in step S613, the controller 420 will exit the procedure in FIGS. 26 and 27.

When it is determined in step S607 that the current day is not within the pay period A, the controller 420 goes to step S614 shown in FIG. 27 where it will determined wether the current day is within the pay period B, with reference to the pay period-B data having been referred to in step S601 and current date having been referred to in step S602.

When the current day is determined in step S614 to be within the pay period B, the controller 420 goes to step S615 where it will inform the user, by displaying a message on the display unit 423, for example, that copying of the content data is allowed with payment of a charge (100 yens in this example). Then, the controller 420 goes to step S616 where it will check the remainder of the prepaid money in the memory card 660 in the card reader 604 to determine whether billing is possible.

When it is determined in step S616 that the billing is possible, the controller 420 goes to step S617 where it will allow to copy the content data, and goes to step S618 where it will control various components such as the recording control circuit 403 to cause the recorder 600 to record the content data to a recording medium. In step S619, the controller 420 will wait until the recording is complete. When the recording is complete, the controller 420 goes to step S620 where it will bill the user for the copying for the pay period B. The billing in step S620 is the same as in step S613 except for the price. After the billing in step S620, the controller 420 will exit the procedure in FIGS. 26 and 27.

When it is determine din step S614 that the current day is not within the pay period B, namely, when the current day is after the pay period B, the controller goes to step S621 where it will make a predetermined copy-limitation control to record the content data to a recording medium. Thereafter, the controller 420 exits the procedure in FIGS. 26 and 27.

Note that in step S621, when the predetermined copy-limitation type is “no copy”, the controller 420 will inhibit copying of the content data. When the predetermined copy-limitation type limits the number of times of copying, the controller 420 will refer to information in the copy count memory 422. When the predetermined number of times (copy count) is not exceeded, the controller 420 will cause the recorder 600 to record the content data to the recording medium. On the other hand, when the predetermined copy count is exceeded, the controller 420 will inhibit copying of the content data.

When the predetermined copy-limitation type is “copy free”, the controller 420 causes the recorder 600 to copy the content data without any limitations. Also, when the predetermined copy-limitation is “according to SCMS”, the controller 420 controls the copy limitation according the necessary information for the SCMS-based copy-limitation control.

[Play-Limitation Control]

Also in the sixth embodiment, play-limitation can be controlled as in the copy-limitation control. Namely, the control of the play limitation will be described concerning the playing of a content data having added to the header HD thereof the no-pay period data in the no-pay period area NP, pay period-A data in the pay period-A area PY1 and pay period-B data in the pay period-B area PY2 as shown in FIG. 25.

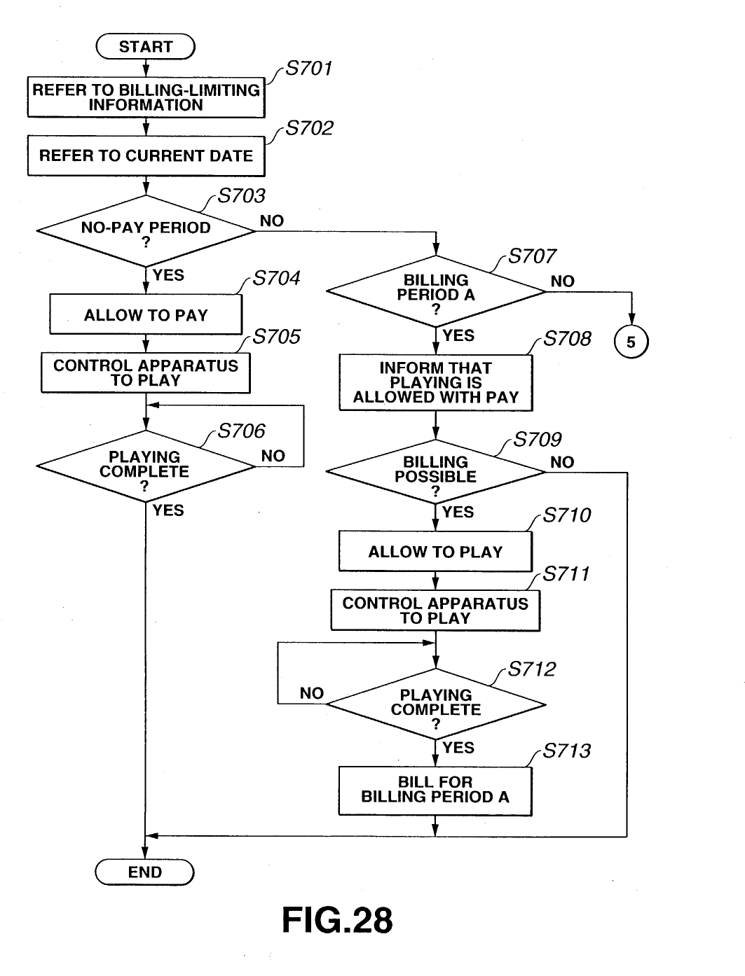

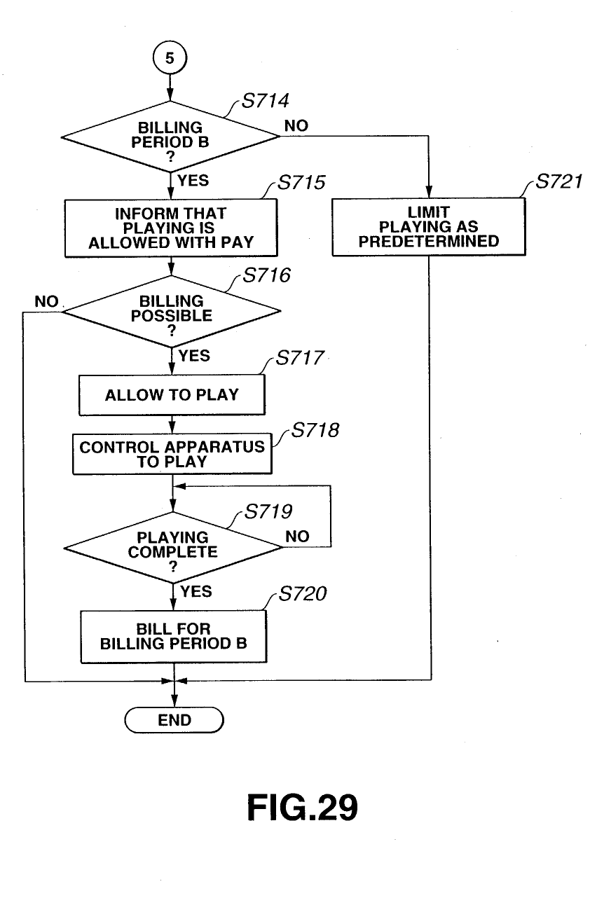

FIGS. 28 and 29 show together a flow of operations made in the player 700 to read, from a recording medium, a content data having added thereto data indicating no-pay period, pay period A and pay period B, respectively. The player to operate as in the flow chart shown in FIGS. 28 and 29 should be constructed similarly to the players 700 in the third, fourth and fifth embodiments shown in FIG. 16.

When a play command is entered to the player 700 from the user operating the key-operated control unit 524, the additional-information separation circuit 701 extracts, from the header HD of a content supplied thereto, play-limitation type data, play-limited period data, pay period data, content data identification information, etc. and supplies the data to the controller 520.

Fist in step S701, the controller 520 refers to the information from the additional-information separation circuit 701, that is, the no-pay period data, pay period-A data, pay period-B data and content data identification information, and next in step S702, the controller 520 refers to a current day kept by the time-keeping circuit 521.

In step S703, the controller 520 determines whether the current day is within the no-pay period, with reference to the no-pay period data having referred to in step S701 and current day having referred to in step S702. When it is determined in step S703 that the current day is within the no-pay period, the controller 520 goes to step S704 where it will allow to play the content data, and goes to step S705 where it will control various circuits such as the play control circuit 508 to cause the recorder 700 to play the content data.

In step S706, the controller 520 will wait until the playing or playing of the content data is complete. When the playing is complete, the controller 520 exits the procedure shown in FIGS. 28 and 29.

When it is determined in step S703 that the current day is not within the no-pay period, the controller 520 goes to step S707 where it will determine whether the current is within the pay period A, based on the pay period data-A data having been referred to in step S701 and current day having been referred to in step S702.

When the current day is determined in step S707 to be within the pay period A, the controller 520 goes to step S708 where it will inform the user, by displaying a message on the display unit 423, for example, that the playing of the content data is allowed with payment of an appropriate charge (20 yens in this example). In step S709, the controller 520 checks the remainder of the prepaid money in the memory card 730 in the card reader 703 to determine whether billing is possible.

When it is determined in step S709 that the billing is possible, the controller 520 goes to step S710 where it will allow to play the content data, and goes to step S711 where it will control the circuits such as the play control circuit 508 to play the content data. In step S712, the controller 520 will wait until he playing is complete. When the playing is complete, the controller 520 goes to step S713 where it will bill the user for the playing in the pay period A.

In step S713, the controller 520 subtracts a predetermined money (20 yens in this case) from the remainder of the prepaid money in the memory card 730 in the card reader 703. When no billing can be made since the memory card is removed from the card reader 703 or not correctly set in place in the latter, the controller 520 will not exit the procedure shown in FIGS. 28 and 29 until billing is successfully complete. In this case, the copied content data cannot be used. After the billing in step S713, the controller 520 exits the procedure shown in FIGS. 28 and 29.

When it is determined in step S707 that the current day is not within the pay period A, the controller 520 goes to step S714 shown in FIG. 29 where it will determine whether the current day is within the pay period B, based on the pay period-B data having been referred to in step S701 and current day having referred to in step S702.

When the current day is determined in step S714 to be within the pay period B, the controller 520 goes to step S715 where it will inform the user, by displaying a message on the display unit 423, for example, that the playing of the content data is allowed with payment of an appropriate charge (10 yens in this case). In step S716, the controller 520 checks the remainder of the prepaid money in the memory card 730 in the card reader 703 to determine whether billing is possible.

When it is determined in step S716 that the billing is possible, the controller 520 goes to step S717 where it will allow to play the content data, and goes to step S718 where it will control the circuits such as the play control circuit 508 to cause the player 700 to play the content data. In step S719, the controller 520 will wait until the playing is complete. When the playing is complete, the controller 520 goes to step S720 where it will bill the user for the playing in the pay period B. The billing in step S720 is similar to that in step S713 except for the charged amount. After completion of the billing in step S720, the controller 520 exits the procedure shown in FIGS. 28 and 29.

When it is determined in step S714 that the current day is not within the pay period B, that is, when the current day is after the pay period B, the controller 520 goes to step S721 where it will make a predetermined play-limitation control to play the content data. Thereafter, the controller 520 will exit the procedure in FIGS. 28 and 29.

When the play-limitation type is “play free”, the controller 520 causes the player to play the content data without any limitations. When the play-limitation type specifies any other play-limitation control, the controller 520 will make a play-limitation control according to the necessary information for the other play-limitation control.

When the play-limitation type is “copy free”, the controller 520 causes the player 700 to play the content data without any limitations. When the play-limitation type specifies to follow any other play-limitation method, the controller 520 will make a play-limitation control according the necessary information for the play-limitation control.

In the sixth embodiment, a plurality of pay periods is provided for one content data, and charges can be made different from one copy or play to another.

In the sixth embodiment, the no-pay period is provided for the purpose of promoting to spread a released content data. However, the no-pay period may not always be provided but only a plurality of pay periods may be provided. Thus, since charges can be made different from one pay period to another, a content data providing method, not proposed heretofore, can be implemented. For example, the charge for copying or playing of a content data is reduced as the time elapses after the content data is released.

In the sixth embodiment, the charge for copying or playing in each of the pay periods is predetermined. However, the present invention is not limited to such a price setting. For example, data indicating a charge for copying or playing in each of pay periods may be added to a content data to be distributed to the end users. Since each of the recorder and player has a communications interface, data indicating a charge for copying or playing for each of pay periods may of course be distributed to each recorder or player via a communication network such as the Internet.

The pay period data added to a content data may not be limited to two types as in the foregoing. Of course, one pay period data will do and also a plurality of pay periods (more than two) may be provided.

Note that as will be seen from the foregoing description of the first to sixth embodiments of the present invention, providing more than one period for which a copy-limitation type is applied permits the content data provider to make a desired copy-limitation control in a selected one of such periods.

There may be predetermined or assigned a copy-limitation type for a copy-limitation type-applied period data according to a position where it is added to a content data or there may be added data indicating a plurality of copy-limitation types. Also, there may be provided both a period for which a copy-limitation type is assigned according to its added position and a period to which data indicating the copy-limitation type is added.

Similarly, providing more one billing-limitation type-applied period for a content permits the content data provider to make a desired billing-limitation control in a selected one of such periods.

There may be predetermined or assigned a billing-limitation type such as a one for allowing to record or copy a content data when the user can pay a charge for the recording or copying or there may be added data indicating a billing-limitation type. Also, there may be provided both a period for which a billing-limitation type is assigned according to its added position and a period to which data indicating the billing-limitation type is added.

Each of a copy-limitation type-applied period and billing-limitation type-applied period may be added to more than one content data. Also in this case, there may be assigned a copy-limitation type and billing-limitation type to data as to periods for which the copy-limitation type and billing-limitation type are applied, respectively, according to their added positions, or there may be added data indicating the copy-limitation type and billing-limitation type, respectively. Also, there may be provided both a period for which a copy-limitation type and billing-limitation type are assigned according to their added position and a period to which data indicating the copy-limitation type and billing-limitation type, respectively, are added.

Two or more no-pay periods or two or more pay periods may be set for a content data. For example, a plurality of no-pay periods may be discretely added to a content data or a plurality of pay periods be discretely added to a content data. Also, these no-pay and pay periods may be added to a content data.

In the aforementioned embodiments of the present invention, in case a plurality of copy- or billing-limitation types is added to a content data, each of these periods is continuous to a preceding and following period. The present invention is not limited to such an arrangement. For example, each of the periods may be set as a discrete one.

Predetermining a copy-limitation type and billing-limitation type for other than each copy- or billing-limitation type-applied period or adding, to a content data, data indicating a copy-limitation type for such other period and data indicating a billing-limitation type for the other period, makes it possible to limit the copying or billing for use of the content data in such other periods.

By combining a copy-limitation type-applied period, billing-limitation type-applied period, no-pay period and pay period in various forms, assigning the copy-limitation type and billing-limitation type for each of such periods according to their added positions or by adding data indicating a copy-limitation type and data indicating a billing-limitation type to each of the periods, as above, it is made possible to control the copying, or billing for the copying, of a content data according to the intention of the user of the content data.

Since it is not necessary to rewrite each limitation type-applied period data added to a content data, it is not essential for the recorder or player to have a communication function. However, in case the recorder or player has such a communication function, the function may be used to communicate with the billing center for billing the user for copying or playing. Also in this case, the limitation type-applied period data have not to be rewritten as mentioned above.

In the aforementioned embodiments of the present invention, a content data is transmitted in the form of a file. However, the present invention is not limited to this form of content data. For example, when a content data is distributed via a recording medium, limitation type-applied period data, copy-limitation type data, billing-limitation type data, etc. may be written to the lead-in area and sub-code of a CD for addition to a content data.

Information newly added to a content data, such as limitation type-applied period data, copy-limitation type data, billing-limitation type data, etc. may be used as encrypt key to encrypt the content data, which will effectively prevent the content date from illegally being used and allow the information added to the content data to limit copying and billing as intended by the content data provider.

The content data identification information is not limited to the aforementioned ISRC. Any information which allows to identify each content data may be used.

The aforementioned time-keeping circuit is not limited to any radio-wave clock. The end users may use any one of various time-keeping circuits in which any time kept thereby cannot be changed from outside.

In the aforementioned embodiments of the present invention, the recording medium is an optical disc such as a CD. However, the present invention is not limited to any optical disc.

Namely, any of various recording media such as a magneto-optical recording medium, magnetic recording medium or semiconductor memory may be used. Therefore, the present invention can be applied to all recorders and players in which such a recording medium is used.

### INDUSTRIAL APPLICABILITY

As having been described in the foregoing, the present invention provides a new copy-limitation control and billing-limitation control of a content data. The present invention permits the user of a content data to make legal use of the content data and be charged for use of the content data more positively and simply.

Also, the present invention permits to inhibit copying of a content data just released in order to keep the originality of the data and lessen the limited copying of the content data after elapse of a predetermined period after the release of the content data, thereby protecting the due profits of the content data provider and also improving the benefit of the users. That is, the present invention improves the benefits of both the content data provider and users.

Further, copying of a content data just released is inhibited and allowed on a chargeable basis after elapse of a predetermined period from the release. Namely, the present invention provides a new way of content data distribution.

Furthermore, according to the present invention, the content data provider can preset a copy limitation and billing limitation, which vary depending upon an elapse time from the release of a content data.

1. A recording medium having recorded therein a content data and additional data added to the content data and including data about conditions of copying or playing the content data.

2. The recording medium as set forth in claim 1, wherein the additional data includes data which limits the content data copying.

3. The recording medium as set forth in claim 2, wherein the copy-limiting data includes at least data indicating a period for which the content data copying is inhibited.

4. The recording medium as set forth in claim 3, wherein the data as to the no-copy period includes data as to a start day of the no-copy period and data as to an end day of the no-copy period.

5. The recording medium as set forth in claim 3, wherein the copy-limiting data includes data as to further limited copying of the content data after elapse of the no-copy period.

6. The recording medium as set forth in claim 5, wherein the data as to further limited copying includes at least data about conditions of further copying the content data after elapse of the no-copy period.

7. The recording medium as set forth in claim 6, wherein the data as to further limited copying includes data as to an end day of the further copy inhibition.

8. The recording medium as set forth in claim 1, wherein the additional data includes a plurality of copy-limiting data.

9. The recording medium as set forth in claim 8, wherein each of the plurality of copy-limiting data includes data as to the no-copy period and data about copying conditions.

10. The recording medium as set forth in claim 8, wherein the additional data includes data limiting further copying of the content data after elapse of each no-copy period included in each of the plurality of copy-limiting data.

11. The recording medium as set forth in claim 1, wherein the additional data includes data which limits the content data playing.

12. The recording medium as set forth in claim 11, wherein the play-limiting data includes at least data indicating a period for which the content data playing is inhibited.

13. The recording medium as set forth in claim 12, wherein the data as to the no-play period includes data as to a start day of the no-play period and data as to an end day of the no-play period.

14. The recording medium as set forth in claim 12, wherein the play-limiting data includes data as to further limited playing of the content data after elapse of the no-play period.

15. The recording medium as set forth in claim 14, wherein the data as to further limited playing includes at least data about conditions of further playing the content data after elapse of the no-play period.

16. The recording medium as set forth in claim 15, wherein the data as to further limited playing includes data as to an end day of the further copy inhibition.

17. The recording medium as set forth in claim 1, wherein the additional data includes a plurality of data which limits the content data playing.

18. The recording medium as set forth in claim 17, wherein each of the plurality of play-limiting data includes data as to the no-play period and data about playing conditions.

19. The recording medium as set forth in claim 17, wherein the additional data includes data which limits further playing of the content data after elapse of each no-play period included in each of the plurality of play-limiting data.

20. The recording medium as set forth in claim 1, wherein the additional data includes data as to a period for which conditions of copying or playing the content data are set.

21. The recording medium as set forth in claim 20, wherein the period data includes at least data as to a no-pay period for which the content data can be copied or played free of charge.

22. The recording medium as set forth in claim 21, wherein the no-pay period include data as to a start day, and an end day, of the period during which the content data can be copied or played free of charge.

23. The recording medium as set forth in claim 21, wherein the period data includes at least one data as to a period for which the content data can be copied or played on a chargeable basis.

24. The recording medium as set forth in claim 23, wherein the chargeable period includes data as to a start day, and an end day, of the period for which the content data can be copied or played on a chargeable basis.

25. The recording medium as set forth in claim 23, wherein the chargeable period defined based on the chargeable-period data partially overlaps a period defined based on the no-pay period.

26. The recording medium as set forth in claim 20, wherein the additional data further includes data which limits the content data copying or playing.

27. A recording method comprising steps of:
adding, to a supplied content data, an additional data including data as to limited recording of the content data and data as to a period for which conditions of recording the content data are set;
coding the content data having the additional data added thereto; and
recording the coded data to a recording medium.

28. A recorder comprising:
means for adding, to a supplied content data, an additional data including data as to limited recording of the content data and data as to a period for which conditions of recording the content data are set;
means for coding an output data from the adding means; and
means for recording an output data from the encoding means to a recording medium.

29. A content data copying or playing method comprising steps of:
extracting, from a supplied content data, an additional data added to the content data and including data as to limited copying or playing of the content data and data as to a period for which conditions of copying or playing the content data are set;
comparing a period set based on the period data in the extracted additional data with a date at which the content data is going to be copied or played; and
controlling, when the result of comparison shows that the date at which the content data is going to be copied or played is within a period set based on the period data in the extracted additional data, the content data copying or playing based on the copy- or play-limiting data in the additional data.

30. The method as set forth in claim 29, further comprising a step of terminating the content data copying or playing when the copy- or play-limiting data inhibits the content data copying or playing.

31. The method as set forth in claim 30, further comprising a step of informing the user that the content data copying or playing is inhibited, when the copy-or play-limiting data inhibits the content data copying or playing.

32. The method as set forth in claim 29, further comprising steps of:
determining the copy- or play-limiting data when the result of comparison shows that the date at which the content data is going to be copied or played is out of a period set based on the period data; and
controlling the content data copying or playing based on the result of copy- or play-limiting data discrimination.

33. The method as set forth in claim 32, further comprising steps of:
copying the content data when the copy- or play-limiting data is determined to allow the content data copying, while rewriting the copy- or play-limiting data to inhibit the content data copying or playing; and
adding the thus rewritten data to the copied content data.

34. The method as set forth in claim 32, further comprising steps of:
determining whether a number of times the content data is allowed to be copied or played is a one defined by the copy- or play-limiting data when the copy- or play-limiting data is determined to allow the content data copying or playing; and
copying or playing the content data when the number of times of copying or playing is within the one defined by the copy-limiting or play-limiting data.

35. The method as set forth in claim 32, further comprising a step of informing the user that the content data copying or playing is inhibited, when the copy- or play-limiting data inhibits the content data copying or playing.

36. A content data copying or playing method comprising steps of:
extracting, from a supplied content data, an additional data added to the content data and including data as to limited copying or playing of the content data, data as to a first period during which the content data can be copied or played free of charge and data as to a second period during which the content data can be copied or played on a chargeable basis;
comparing a date at which the content data is going to be copied or played with data as to the first and second periods, respectively; and
inhibiting the content data copying or playing when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

37. The method as set forth in claim 36, further comprising steps of:
copying or playing the content data when the billing is determined to be possible; and
billing the user for the content data copying or playing.

38. The method as set forth in claim 37, further comprising a step of terminating the content data copying or playing when the billing is determined to be impossible.

39. The method as set forth in claim 36, further comprising a step of determining, when the date at which the content data is going to be copied or played is determined to be out of the period set based on the data as to the first period, whether the date is within the period ser based on the data as to the second period.

40. The method as set forth in claim 39, wherein when the date at which the content data is going to be copied or played is determined to be out of the period set based on the data as to the second period, the content data copying or playing is inhibited.

41. The method as set forth in claim 36, further comprising a step of informing the user that the content data can be copied or played only on a chargeable basis, when the date at which the content data is going to be copied or played is determined to be within the period set based on the data as to the second period.

42. A content data copying or playing method comprising steps of:
extracting, from a supplied content data, an additional data added to the content data and including data as to limited copying or playing of the content data, data as to a first period during which copying or playing of the content data is inhibited and data as to a second period during which the content data can be copied or played on a chargeable basis;
comparing a date at which the content data is going to be copied or played with data as to the first and second periods, respectively; and
inhibiting the content data copying or playing when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

43. The method as set forth in claim 42, further comprising steps of:
copying or playing the content data when the billing is determined to be possible; and
billing the user for the content data copying or playing.

44. The method as set forth in claim 43, further comprising a step of terminating the content data copying or playing when the billing is determined to be impossible.

45. The method as set forth in claim 42, further comprising a step of determining, when the date at which the content data is going to be copied or played is determined to be out of the period set based on the data as to the first period, whether the date is within the period ser based on the data as to the second period.

46. The method as set forth in claim 45, wherein when the date at which the content data is going to be copied or played is determined to be out of the period set based on the data as to the second period, the content data copying or playing is inhibited.

47. The method as set forth in claim 42, further comprising a step of informing the user that the content data can be copied or played only on a chargeable basis, when the date at which the content data is going to be copied or played is determined to be within the period set based on the data as to the first period and also within the period set based on the data as to the second period.

48. The method as set forth in claim 47, further comprising steps of:
determining, after the information to the user, whether the billing is possible;
copying or playing the content data when the billing is determined to be possible; and
billing the user for the content data copying or playing.

49. The method as set forth in claim 42, further comprising a step of informing the user that the content data can be copied or played only on a chargeable basis, when the date at which the content data is going to be copied or played is determined to be within the period set based on the data as to the second period.

50. A content data copying or playing method including comprising steps of:
extracting, from a supplied content data, an additional data added to the content data and including data as to limited copying or playing of the content data, data as to a first period during which the content data copying or playing is inhibited and data as to a second period during which the content data can be copied or played on a chargeable basis and which partially overlaps the period set based on the data as to the first period;
comparing a date at which the content data is going to be copied or played with data as to the first and second periods, respectively; and
inhibiting copying or playing of the content data when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second period, whether billing can be made for the content data copying or playing.

51. The method as set forth in claim 50, further comprising a step of determining, when the date at which the content data is going to be copied or played is determined to be out of the period set based on the data as to the first period, whether the date is within the period ser based on the data as to the second period.

52. The method as set forth in claim 51, wherein when the date at which the content data is going to be copied or played is determined to be out of the period set based on the data as to the second period, the content data copying or playing is inhibited.

53. The method as set forth in claim 50, further comprising a step of informing the user that the content data can be copied or played only on a chargeable basis, when the date at which the content data is going to be copied or played is determined to be within a part of the period set based on the data as to the second period, overlapping the period set based on the data as to the first period.

54. The method as set forth in claim 53, further comprising steps of:
determining, after the information to the user, whether the billing is possible;
copying or playing the content data when the billing is determined to be possible; and
billing the user for the copying or playing.

55. The method as set forth in claim 50, further comprising a step of informing the user that the content data can be copied or played only on a chargeable basis, when the date at which the content data is going to be copied or played is determined to be within the period set based on the data as to the second period.

56. The method as set forth in claim 50, further comprising steps of:
copying or playing the content data when the billing is determined to be possible; and
billing the user for the copying or playing of the content data.

57. The method as set forth in claim 50, further comprising a step of terminating the content data copying or playing when the billing is determined to be impossible.

58. A content data copying or playing method comprising steps of:
extracting, from a supplied content data, an additional data added to the content data and including data as to limited copying or playing of the content data, data as to a first period during which the content data can be copied or played free of charge, data as to a second period during which the content data can be copied or played on a chargeable basis and data as to a third period during which the content data can be copied or played on a chargeable basis;
comparing a date at which the content data is going to be copied or played with data as to the first, second and third periods, respectively; and
copying or playing the content data when the result of comparison shows that the date at which the content data is going to be copied or played is within a period set based on the data as to the first period, while copying or playing the content data after determining, when the result of comparison shows that the date at which the content data is going to be copied or played is within a period set based on the data as to the second or third period, whether billing can be made for the content data copying or playing.

59. The method as set forth in claim 58, further comprising steps of:
determining whether the date at which the content data is going to be copied or played is a one set based on the data as to the second period;
copying or playing the content data when that the date at which the content data is going to be copied or played is determined to be within the period set based on the data as to the second period; and
billing the user for the content data copying or playing under the billing conditions for a period set based on the data as to the second period.

60. The method as set forth in claim 59, further comprising steps of:
determining whether the date at which the content data is going to be copied or played is a one set based on the data as to the third period, when the date at which the content data is going to be copied or played is determined to be output the period set based on the data as to the second period;
copying or playing the content data when the date at which the content data is going to be copied or played is determined to be within the period set based on the data as to the second period; and
billing the user for the content data copying or playing under the billing conditions for a period set based on the data as to the second period.

61. The method as set forth in claim 60, wherein when the date at which the content data is going to be copied or played is determined to be out of the period set based on the data as to the third period, the content data copying or playing is inhibited.

62. The method as set forth in claim 58, further comprising a step of terminating the content data copying or playing when the billing is determined to be impossible.

63. The method as set forth in claim 58, further comprising a step of informing the user that the content data can be copied or played only on a chargeable basis when the date at which the content data is going to be copied or played is determined to be within the period set based on the data as to the second or third period.

64. A content data copying method comprising steps of:
extracting, from a supplied content data, an additional data added to the content data and including data as to limited copying of the content data and data as to a period for which conditions of copying the content data are set;
comparing a date at which the content data is going to be copied with a period set based on the period data in the extracted additional data; and
inhibiting the content data copying when the result of comparison shows that the date at which the content data is going to be copied is within a period set based on the data as to the period.

65. The method as set forth in claim 64, wherein when the date at which the content data is going to be copied is determined to be out of the period set based on the data as to the period, the content data copying is controlled based on the data as to the copy limitation.

66. The method as set forth in claim 65, further comprising a step of copying the content data when the copy-limiting data allows the content data copying.

67. The method as set forth in claim 66, further comprising a step of rewriting the copy-limiting data included in the additional data added to the content data to be copied.

68. The method as set forth in claim 65, further comprising steps of:
determining, when the copy-limiting data allows the content data copying, whether the number of times the content data is allowed to be copied is smaller than a one defined by the copy-limiting data; and
copying the content data when the number of times of copying is smaller than the one defined by the data as to the limited copying.

69. The method as set forth in claim 68, further comprising a step of terminating the content data copying when the number of times of copying exceeds the one defined by the data as to the limited copying.

70. The method as set forth in claim 64, wherein:
the data as to the period includes a first and second period data; and
the data as to the limited copying includes a first copy-limiting data as to limited copying of the content data in a period set based on the first period data and a second copy-limiting data as to limited copying of the content data in a period set based on the second period data;
the method further comprising steps of:
determining whether the date at which the content data is going to be copied is within the period set based on the first period data; and
controlling the copying of the content data based on the first copy-limiting data when the date at which the content data is going to be copied is determined to be within the period set based on the first period data.

71. The method as set forth in claim 70, further comprising steps of:
determining, when the date at which the content data is going to be copied is determined to be out of the period set based on the first period data, whether the date at which the content data is going to be copied is within the period set based on the second period data; and
controlling the copying of the content data based on the second copy-limiting data when the date at which the content data is going to be copied is determined to be within the period set based on the second period data.

72. The method as set forth in claim 70, wherein:
the content data copying is inhibited for the period set based on the first period data; and
the content data copying is allowed only on a chargeable basis for the period set based on the second period data;
the method further comprising a step of informing the user that the content data can be copied on a chargeable basis when the date at which the content data is going to be copied is determined to be within the period set based on the first period data and also within the period set based on the second period data.

73. The method as set forth in claim 72, further comprising steps of:
determining, after the information to the user, whether the billing for the content data copying is possible;
copying the content data when the billing is determined to be possible; and
billing the user for the content data copying.

74. The method as set forth in claim 64, wherein the data as to the period includes a first period data as to a period for which the content data can be copied free of charge, and a second period data as to a period for which the content data can be copied only on a chargeable basis;
the method further comprising steps of:
determining whether the date at which the content data is going to be copied is within a period set based on the first period data; and
copying the content data free of charge when the date at which the content data is going to be copied is determined to be within the period set based on the first period data.

75. The method as set forth in claim 74, further comprising steps of:
determining, when the date at which the content data is going to be copied is determined to be out of the period set based on the first period data, whether the date at which the content data is going to be copied is within the period set based on the second period data; and
copying the content data on a chargeable basis when the date at which the content data is going to be copied is determined to be within the period set based on the second period data.

76. The method as set forth in claim 75, further comprising a step of informing the user that the content data can only be copied with payment of an appropriate data.

77. The method as set forth in claim 75, further comprising steps of:
determining whether the billing for the content data copying is possible;
copying the content data when the billing is determined to be possible; and
billing the user for the content data copying.

78. The method as set forth in claim 77, further comprising a step of terminating the copying of the content data when the billing is determined to be impossible.

79. A content data recorder comprising:
means for extracting, from a supplied content data, an additional data added to the content data and including data as to limited recording of the content data and data as to a period for which conditions of recording the content data are set;
means for coding the supplied content data;
means for recording an output from the encoding means; and
means including a time-keeping circuit and destined for comparing a period set based on the period data in the additional data extracted by the extracting means with a date supplied from the time-keeping circuit and at which the content data is going to be recorded, and controlling, when the result of comparison shows that the data at which the content data is going to be recorded is within a period set based on the period data in the additional data, the content data recording based on the limited-recording data in the additional data.

80. The apparatus as set forth in claim 79, wherein when the result of comparison shows that the date at which the content data is going to be recorded is within the period set based on the period data in the additional data, the controlling means inhibits the apparatus from recording the content data.

81. The apparatus as set forth in claim 80, wherein when the result of comparison shows that the date at which the content data is going to be recorded is out of the period set based on the period data, the controlling means controls the content data recording based on the limited-recording data in the additional data.

82. The apparatus as set forth in claim 81, wherein when the limited-recording data allows the content data recording, the controlling means causes the apparatus to record the content data.

83. The apparatus as set forth in claim 82, further comprising means for generating data as to the limited recording;
the controlling means adding new additional data generated by the generating means to the content data to be recorded.

84. The apparatus as set forth in claim 81, wherein:
the controlling means further includes a memory for storing a number of times the content data is allowed to be recorded;
the controlling means determines, when the limited-recording data allows the content data recording, whether the number of times the content data is allowed to be recorded is smaller than a one defined by the limited-recording data, based on data read from the memory, and causes the apparatus to record the content data when the number of times of recording is smaller than the one defined by the limited-recording data.

85. The apparatus as set forth in claim 84, wherein the controlling means causes the apparatus to terminate the content data recording when having determined that the number of times of recording exceeds the one defined by the limited-recording data.

86. The apparatus as set forth in claim 79, wherein:
the period data includes a first and second period data;
the limited-recording data includes a first limited-recording data as to limited recording of the content data in a period set based on the first period data and a second limited-recording data as to limited recording of the content data in a period set based on the second period data;
the controlling means operates to:
determine whether the date at which the content data is going to be recorded is within the period set based on the first period data; and
control the content data recording based on the first limited-recording data having determined that the date at which the content data is going to be recorded is within the period set based on the first period data.

87. The apparatus as set forth in claim 86, wherein the controlling means operates to:
determine, when having determined that the date at which the content data is going to be copied is out of the period set based on the first period data, whether the date at which the content data is going to be copied is within the period set based on the second period data; and
control the content data recording based on the second limited-recording data when having determined that the date at which the content data is going to be copied is within the period set based on the second period data.

88. The apparatus as set forth in claim 86, wherein:
the content data recording is inhibited for the period set based on the first period data;
the content data recording is allowed only on a chargeable basis for the period set based on the second period data; and
the controlling means informs the user that the content data can be recorded on a chargeable basis when having determined that the date at which the content data is going to be copied is within the period set based on the first period data and also within the period set based on the second period data.

89. The apparatus as set forth in claim 88, further comprising means for displaying that the content data can be recorded only on a chargeable basis.

90. The apparatus as set forth in claim 88, wherein the controlling means operates to:
determine, after the information to the user, whether the billing for the content data recording is possible;
cause the apparatus to record the content data when having determined that the billing is possible; and
bill the user for the content data recording.

91. The apparatus as set forth in claim 79, wherein:
the period data includes a first period data as to a period for which the content data can be recorded free of charge, and a second period data as to a period for which the content data can be recorded only on a chargeable basis; and
the controlling means operates to:
determine whether the date at which the content data is going to be recorded is within a period set based on the first period data; and
cause the apparatus to record the content data free of charge when having determined that the date at which the content data is going to be recorded is be within the period set based on the first period data.

92. The apparatus as set forth in claim 91, wherein the controlling means operates to:
determine, when having determined that the date at which the content data is going to be recorded is out of the period set based on the first period data, whether the date at which the content data is going to be recorded is within the period set based on the second period data; and
cause the apparatus to record the content data on a chargeable basis when having determined that the date at which the content data is going to be recorded is within the period set based on the second period data.

93. The apparatus as set forth in claim 92, wherein the controlling means informs the user that the content data can be recorded only on a chargeable basis.

94. The apparatus as set forth in claim 93, further comprising means for displaying that the content data can be recorded only on a chargeable basis.

95. The apparatus as set forth in claim 92, wherein the controlling means operates to:
determine whether the billing for the content data recording is possible;
cause the apparatus to record the content data when having determined that the billing is possible; and
bill the user for the content data recording.

96. The apparatus as set forth in claim 93, wherein the controlling means causes the apparatus to terminate the content data recording when having determined that the billing is impossible.

97. A content data player comprising:
means for extracting, from a supplied content data, an additional data added to the content data and including data as to limited playing of the content data and data as to a period for which conditions of playing the content data are set;
means for decoding the supplied content data;
means for playing an output from the decoding means; and
means including a time-keeping circuit and destined for comparing a period set based on the period data in the additional data extracted by the extracting means with a date supplied from the time-keeping circuit and at which the content data is going to be played, and controlling, when the result of comparison shows that the data at which the content data is going to be played is within a period set based on the period data in the additional data, the content data playing based on the play-limiting data in the additional data.

98. The apparatus as set forth in claim 97, wherein when the result of comparison shows that the date at which the content data is going to be played is within the period set based on the period data in the additional data, the controlling means inhibits the apparatus from playing the content data.

99. The apparatus as set forth in claim 98, wherein when the result of comparison shows that the date at which the content data is going to be played is out of the period set based on the period data, the controlling means controls the content data playing based on the play-limiting data in the additional data.

100. The apparatus as set forth in claim 99, wherein when the play-limiting data allows the content data playing, the controlling means causes the apparatus to play the content data.

101. The apparatus as set forth in claim 99, wherein:
the controlling means further includes a memory for storing a number of times the content data has been played;
the controlling means determines, when the play-limiting data allows the content data playing, whether the number of times the content data is allowed to be played is smaller than a one defined by the play-limiting data, based on data read from the memory, and causes the apparatus to play the content data when the number of times of playing is smaller than the one defined by the play-limiting data.

102. The apparatus as set forth in claim 10, wherein the controlling means causes the apparatus to terminate the content data playing when having determined that the number of times of playing exceeds the one defined by the play-limiting data.

103. The apparatus as set forth in claim 97, wherein:
the period data includes a first and second period data;
the play-limiting data includes a first play-limiting data as to limited playing of the content data in a period set based on the first period data and a second play-limiting data as to limited playing of the content data in a period set based on the second period data;
the controlling means operates to:
determine whether the date at which the content data is going to be played is within the period set based on the first period data; and
control the content data playing based on the first play-limiting data when having determined that the date at which the content data is going to be played is within the period set based on the first period data.

104. The apparatus as set forth in claim 103, wherein the controlling means operates to:
determine, when having determined that the date at which the content data is going to be copied is out of the period set based on the first period data, whether the date at which the content data is going to be copied is within the period set based on the second period data; and
control the content data playing based on the second play-limiting data when having determined that the date at which the content data is going to be played is within the period set based on the second period data.

105. The apparatus as set forth in claim 103, wherein:
the content data recording is inhibited for the period set based on the first period data;
the content data recording is allowed only on a chargeable basis for the period set based on the second period data; and
the controlling means informs the user that the content data can be played on a chargeable basis when having determined that the date at which the content data is going to be copied is within the period set based on the first period data and also within the period set based on the second period data.

106. The apparatus as set forth in claim 97, further comprising means for displaying that the content data can be played only on a chargeable basis.

107. The apparatus as set forth in claim 105, wherein the controlling means operates to:
determine, after the information to the user, whether the billing for the content data playing is possible;
cause the apparatus to play the content data when having determined that the billing is possible; and
bill the user for the content data playing.

108. The apparatus as set forth in claim 97, wherein:
the period data includes a first period data as to a period for which the content data can be played free of charge, and a second period data as to a period for which the content data can be played only on a chargeable basis; and
the controlling means operates to:
determine whether the date at which the content data is going to be played is within a period set based on the first period data; and
cause the apparatus to play the content data free of charge when having determined that the date at which the content data is going to be played is within the period set based on the first period data.

109. The apparatus as set forth in claim 108, wherein the controlling means operates to:
determine, when having determined that the date at which the content data is going to be played is out of the period set based on the first period data, whether the date at which the content data is going to be played is within the period set based on the second period data; and
cause the apparatus to play the content data on a chargeable basis when having determined that the date at which the content data is going to be played is within the period set based on the second period data.

110. The apparatus as set forth in claim 109, wherein the controlling means informs the user that the content data can be played only on a chargeable basis.

111. The apparatus as set forth in claim 110, further comprising means for displaying that the content data can be played only on a chargeable basis.

112. The apparatus as set forth in claim 109, wherein the controlling means operates to:
determine whether the billing for the content data playing is possible;
cause the apparatus to play the content data when having determined that the billing is possible; and
bill the user for the content data playing.

113. The apparatus as set forth in claim 110, wherein the controlling means causes the apparatus to terminate the content data playing when having determined that the billing is impossible.

114. A content data including:
a content data proper; and
additional data added to the content data and including data about conditions of copying or playing the content data.

115. The content data as set forth in claim 114, wherein the additional data includes data which limits the content data copying.

116. The content data as set forth in claim 115, wherein the copy-limiting data includes at least data indicating a period for which the content data copying is inhibited.

117. The content data as set forth in claim 116, wherein the data as to the no-copy period includes data as to a start day of the no-copy period and data as to an end day of the no-copy period.

118. The content data as set forth in claim 116, wherein the copy-limiting data includes data as to further limited copying of the content data after elapse of the no-copy period.

119. The content data as set forth in claim 118, wherein the data as to further limited copying includes at least data about conditions of further copying the content data after elapse of the no-copy period.

120. The content data as set forth in claim 119, wherein the data as to further limited copying includes data as to an end day of the further copy inhibition.

121. The content data as set forth in claim 114, wherein the additional data includes a plurality of copy-limiting data.

122. The content data as set forth in claim 121, wherein each of the plurality of copy-limiting data includes data as to the no-copy period and data about copying conditions.

123. The content data as set forth in claim 121, wherein the additional data includes data limiting further copying of the content data after elapse of each no-copy period included in each of the plurality of copy-limiting data.

124. The content data as set forth in claim 114, wherein the additional data includes data which limits the content data playing.

125. The content data as set forth in claim 124, wherein the play-limiting data includes at least data indicating a period for which the content data playing is inhibited.

126. The content data as set forth in claim 125, wherein the data as to the no-play period includes data as to a start day of the no-play period and data as to an end day of the no-play period.

127. The content data as set forth in claim 125, wherein the play-limiting data includes data as to further limited playing of the content data after elapse of the no-play period.

128. The content data as set forth in claim 127, wherein the data as to further limited playing includes at least data about conditions of further playing the content data after elapse of the no-play period.

129. The content data as set forth in claim 128, wherein the data as to further limited playing includes data as to an end day of the further copy inhibition.

130. The content data as set forth in claim 114, wherein the additional data includes a plurality of data which limits the content data playing.

131. The content data as set forth in claim 130, wherein each of the plurality of play-limiting data includes data as to the no-play period and data about playing conditions.

132. The content data as set forth in claim 130, wherein the additional data includes data which limits further playing of the content data after elapse of each no-play period included in each of the plurality of play-limiting data.

133. The content data as set forth in claim 114, wherein the additional data includes data as to a period for which conditions of copying or playing the content data are set.

134. The content data as set forth in claim 133, wherein the period data includes at least data as to a no-pay period for which the content data can be copied or played free of charge.

135. The content data as set forth in claim 134, wherein the no-pay period include data as to a start day, and an end day, of the period during which the content data can be copied or played free of charge.

136. The content data as set forth in claim 134, wherein the period data includes at least one data as to a period for which the content data can be copied or played on a chargeable basis.

137. The content data as set forth in claim 136, wherein the chargeable period includes data as to a start day, and an end day, of the period for which the content data can be copied or played on a chargeable basis.

138. The content data as set forth in claim 136, wherein the chargeable period defined based on the chargeable-period data partially overlaps a period defined based on the no-pay period.

139. The content data as set forth in claim 133, wherein the additional data further includes data which limits the content data copying or playing.

140. A content data outputting method comprising steps of:
adding, to a supplied content data, an additional data added to the content data and including data as to limited copying or playing of the content data and data as to a period for which conditions of copying or playing the content data are set; and
outputting the content data having the additional data added thereto.
